(19) United States
(12) Patent Application Publication
(10) Pub. No.: US 2019/0253734 A1
(43) Pub. Date: Aug. 15, 2019

(54) METHOD FOR TRANSMITTING 360 VIDEO, METHOD FOR RECEIVING 360 VIDEO, 360 VIDEO TRANSMITTING DEVICE, AND 360 VIDEO RECEIVING DEVICE

(71) Applicant: LG ELECTRONICS INC., Seoul (KR)

(72) Inventors: Jangwon LEE, Seoul (KR); Sejin OH, Seoul (KR)

(73) Assignee: LG ELECTRONICS INC., Seoul (KR)

(21) Appl. No.: 16/343,730

(22) PCT Filed: Jan. 3, 2018
(86) PCT No.: PCT/KR2018/000104

§ 371 Date: Apr. 19, 2019

Related U.S. Application Data
(60) Provisional application No. 62/474,029, filed on Mar. 20, 2017.
(60) Provisional application No. 62/478,513, filed on Mar. 29, 2017.
(60) Provisional application No. 62/512,062, filed on May 28, 2017.

(51) Int. Cl. H04N 19/597; H04N 13/204; H04N 5/232; H04L 29/06; H04L 29/08

(52) U.S. Cl. CPC H04N 19/597; H04N 13/204; H04L 65/608; H04L 65/601; H04L 67/02; H04N 5/23238

(57) ABSTRACT

The present invention can relate to a method for transmitting 360 video. The method for transmitting 360 video, according to the present invention, can comprise the steps of: processing 360 video data captured by at least one camera; encoding a picture; generating signaling information on the 360 video data; encapsulating the encoded picture and the signaling information as a file; and transmitting the file.

### TECHNICAL FIELD

The present invention relates to a 360-degree video transmission method, a 360-degree video reception method, a 360-degree video transmission apparatus, and a 360-degree video reception apparatus.

### BACKGROUND ART

A virtual reality (VR) system provides a user with sensory experiences through which the user may feel as if he/she were in an electronically projected environment. A system for providing VR may be further improved in order to provide higher-quality images and spatial sound. Such a VR system may enable the user to interactively enjoy VR content.

### DISCLOSURE

### Technical Problem

VR systems need to be improved in order to more efficiently provide a user with a VR environment. To this end, it is necessary to propose plans for data transmission efficiency for transmitting a large amount of data such as VR content, robustness between transmission and reception networks, network flexibility considering a mobile reception apparatus, and efficient reproduction and signaling.

Since general Timed Text Markup Language (TTML) based subtitles or bitmap based subtitles are not created in consideration of 360-degree video, it is necessary to extend subtitle related features and subtitle related signaling information to be adapted to use cases of a VR service in order to provide subtitles suitable for 360-degree video.

### Technical Solution

In accordance with an object of the present invention, the present invention proposes a 360-degree video transmission method, a 360-degree video reception method, a 360-degree video transmission apparatus, and a 360-degree video reception apparatus.

The 360-degree video transmission method according to one aspect of the present invention comprises the steps of processing 360 video data captured by at least one camera, the processing step includes stitching the 360-degree video data and projecting the stitched 360-degree video data on a picture; encoding the picture; generating signaling information on the 360 video data, the signaling information including coverage information indicating a region reserved by a sup-picture of the picture on a 3D space; encapsulating the encoded picture and the signaling information in a file; and transmitting the file.

Preferably, the coverage information may include information indicating a yaw value and a pitch value of a center point of the region on the 3D space, and the coverage information may include information indicating a width value and a height value of the region on the 3D space.

Preferably, the coverage information may further include information indicating whether the region is a shape specified by 4 great circles on 4 spherical surfaces in the 3D space or a shape specified by 2 yaw circles and 2 pitch circles.

Preferably, the coverage information may further include information indicating whether 360-degree video corresponding to the region is 2D video, a left image of 3D video, a right image of the 3D video or includes both a left image and a right image of the 3D video.

Preferably, the coverage information may be generated in the form of a DASH (Dynamic Adaptive Streaming over HTTP) descriptor and included in MPD (Media Presentation Description), and thus transmitted through a separate path different from that of the file.

Preferably, the 360-degree video transmission method may further comprise the step of receiving feedback information indicating a viewport of a current user from a reception side.

Preferably, the subpicture may be a subpicture corresponding to the viewport indicated by the feedback information, and the coverage information may be coverage information on the subpicture corresponding to the viewport indicated by the feedback information.

A 360-degree video transmission apparatus according to another aspect of the present invention comprises a video processor for processing 360 video data captured by at least one camera, the video processor stitching the 360-degree video data and projecting the stitched 360-degree video data on a picture; a data encoder for encoding the picture; a metadata processor for generating signaling information on the 360 video data, the signaling information including coverage information indicating a region reserved by a sup-picture of the picture on a 3D space; an encapsulation processor for encapsulating the encoded picture and the signaling information in a file; and a transmission unit for transmitting the file.

Preferably, the coverage information may include information indicating a yaw value and a pitch value of a center point of the region on the 3D space, and the coverage information includes information indicating a width value and a height value of the region on the 3D space.

Preferably, the coverage information may further include information indicating whether the region is a shape specified by 4 great circles on 4 spherical surfaces in the 3D space or a shape specified by 2 yaw circles and 2 pitch circles.

Preferably, the coverage information may further include information indicating whether 360-degree video corresponding to the region is 2D video, a left image of 3D video, a right image of the 3D video or includes both a left image and a right image of the 3D video.

Preferably, the coverage information may be generated in the form of a DASH (Dynamic Adaptive Streaming over HTTP) descriptor and included in MPD (Media Presentation Description), and thus transmitted through a separate path different from that of the file.

Preferably, the 360-degree video transmission apparatus of claim 8 may further comprise a feedback processor for receiving feedback information indicating a viewport of a current user from a reception side.

Preferably, the subpicture may be a subpicture corresponding to the viewport indicated by the feedback information, and the coverage information may be coverage information on the subpicture corresponding to the viewport indicated by the feedback information.

### Advantageous Effects

According to the present invention, 360-degree contents can efficiently be transmitted in an environment in which next-generation hybrid broadcasting using terrestrial broadcast networks and Internet networks is supported.

According to the present invention, a method for providing interactive experience can be proposed in user's consumption of 360-degree contents.

According to the present invention, a signaling method for correctly reflecting the intention of a 360-degree contents producer can be proposed in user's consumption of 360-degree contents.

According to the present invention, a method for efficiently increasing transmission capacity and delivering necessary information can be proposed in delivery of 360-degree contents.

### BRIEF DESCRIPTION OF THE DRAWINGS

FIG. 1 is a view showing the entire architecture for providing a 360-degree video according to the present invention.

FIG. 2 is a view showing a 360-degree video transmission apparatus according to an aspect of the present invention.

FIG. 3 is a view showing a 360-degree video reception apparatus according to another aspect of the present invention.

FIG. 4 is a view showing a 360-degree video transmission apparatus/360-degree video reception apparatus according to another embodiment of the present invention.

FIG. 5 is a view showing the concept of principal aircraft axes for describing 3D space in connection with the present invention.

FIG. 6 is a view showing projection schemes according to an embodiment of the present invention.

FIG. 7 is a view showing a tile according to an embodiment of the present invention.

FIG. 8 is a view showing 360-degree-video-related metadata according to an embodiment of the present invention.

FIG. 9 is a view showing a structure of a media file according to an embodiment of the present invention.

FIG. 10 is a view showing a hierarchical structure of boxes in ISOBMFF according to one embodiment of the present invention.

FIG. 11 illustrates an overall operation of a DASH based adaptive streaming model according to one embodiment of the present invention.

FIG. 12 is a view showing a configuration of a data encoder according to the present invention.

FIG. 13 is a view showing a configuration of a data decoder according to the present invention.

FIG. 14 illustrates a hierarchical structure of coded data.

FIG. 15 illustrates a motion constraint tile set (MCTS) extraction and delivery process which is an example of region based independent processing.

FIG. 16 illustrates an example of an image frame for supporting region based independent processing.

FIG. 17 illustrates an example of a bitstream configuration for supporting region based independent processing.

FIG. 18 illustrates a track configuration of a file according to the present invention.

FIG. 19 illustrates RegionOriginalCoordninateBox according to one embodiment of the present invention.

FIG. 20 exemplarily illustrates a region indicated by corresponding information within an original picture.

FIG. 21 illustrates RegionToTrackBox according to one embodiment of the present invention.

FIG. 22 illustrates SEI message according to one embodiment of the present invention.

FIG. 23 illustrates mcts_sub_bitstream_region_in_original_picture_coordinate_info according to one embodiment of the present invention.

FIG. 24 illustrates MCTS region related information within a file which includes a plurality of MCTS bitstreams according to one embodiment of the present invention.

FIG. 25 illustrates view port dependent processing according to one embodiment of the present invention.

FIG. 26 illustrates coverage information according to one embodiment of the present invention.

FIG. 27 illustrates subpicture composition according to one embodiment of the present invention.

FIG. 28 illustrates overlapped subpictures according to one embodiment of the present invention.

FIG. 29 illustrates a syntax of SubpictureCompositionBox.

FIG. 30 illustrates a hierarchical structure of RegionWisePackingBox.

FIG. 31 briefly illustrates a procedure of transmitting or receiving 360-degree video using subpicture composition according to the present invention.

FIG. 32 exemplarily illustrates subpicture composition according to the present invention.

FIG. 33 briefly illustrates a method for processing 360-degree video by a 360-degree video transmission apparatus according to the present invention.

FIG. 34 briefly illustrates a method for processing 360-degree video by a 360-degree video reception apparatus according to the present invention.

FIG. 35 is a view showing a 360-degree video transmission apparatus according to one aspect of the present invention.

FIG. 36 is a view showing a 360-degree video reception apparatus according to another aspect of the present invention.

FIG. 37 is a view showing an embodiment of coverage information according to the present invention.

FIG. 38 is a view showing another embodiment of coverage information according to the present invention.

FIG. 39 is a view showing still another embodiment of coverage information according to the present invention.

FIG. 40 is a view showing further still another embodiment of coverage information according to the present invention.

FIG. 41 is a view showing further still another embodiment of coverage information according to the present invention.

FIG. 42 is a view illustrating one embodiment of a 360-degree video transmission method, which can be performed by a 360-degree video transmission apparatus according to the present invention.

### BEST MODE FOR CARRYING OUT THE INVENTION

Reference will now be made in detail to the preferred embodiments of the present invention with reference to the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

Although most terms used in the present invention have been selected from general ones widely used in the art, some terms have been arbitrarily selected by the applicant and their meanings are explained in detail in the following description as needed. Thus, the present invention should be understood according to the intended meanings of the terms rather than their simple names or meanings.

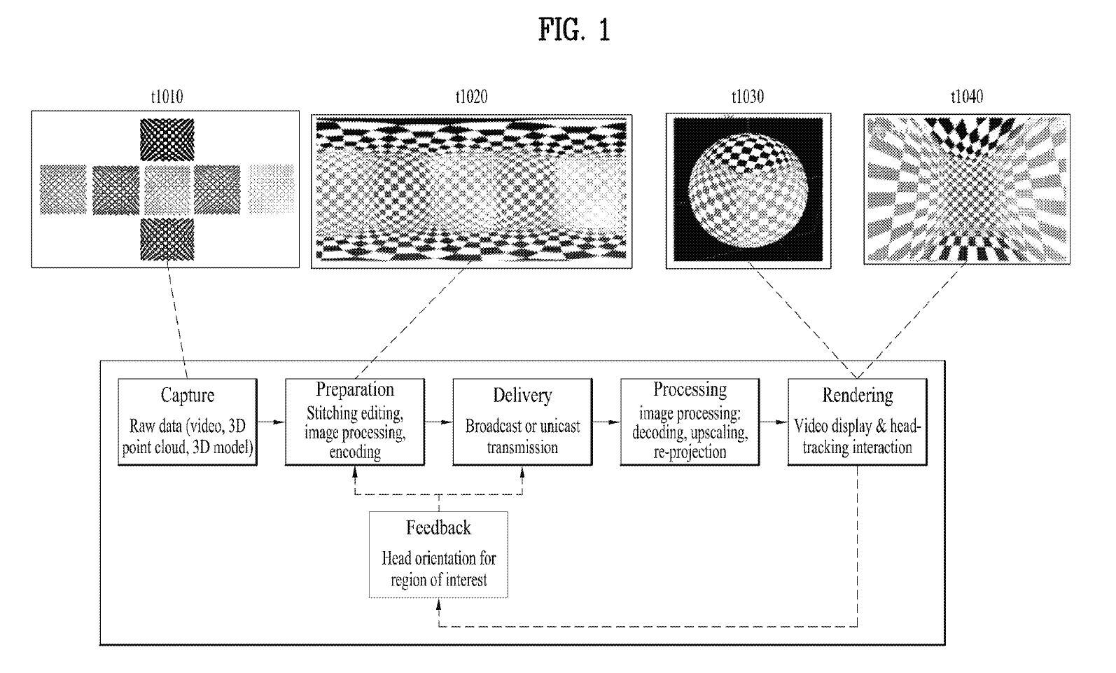

FIG. 1 is a view showing the entire architecture for providing 360-degree video according to the present invention.

The present invention proposes a scheme for 360-degree content provision in order to provide a user with virtual reality (VR). VR may mean technology or an environment for replicating an actual or virtual environment. VR artificially provides a user with sensual experiences through which the user may feel as if he/she were in an electronically projected environment.

360-degree content means all content for realizing and providing VR, and may include 360-degree video and/or 360-degree audio. The term “360-degree video” may mean video or image content that is captured or reproduced in all directions (360 degrees) at the same time, which is necessary to provide VR. Such 360-degree video may be a video or an image that appears in various kinds of 3D spaces depending on 3D models. For example, the 360-degree video may appear on a spherical surface. The term “360-degree audio”, which is audio content for providing VR, may mean spatial audio content in which the origin of a sound is recognized as being located in a specific 3D space. The 360-degree content may be generated, processed, and transmitted to users, who may enjoy a VR experience using the 360-degree content.

The present invention proposes a method of effectively providing 360-degree video in particular. In order to provide 360-degree video, the 360-degree video may be captured using at least one camera. The captured 360-degree video may be transmitted through a series of processes, and a reception side may process and render the received data into the original 360-degree video. As a result, the 360-degree video may be provided to a user.

Specifically, the overall processes of providing the 360-degree video may include a capturing process, a preparation process, a delivery process, a processing process, a rendering process, and/or a feedback process.

The capturing process may be a process of capturing an image or a video at each of a plurality of viewpoints using at least one camera. At the capturing process, image/video data may be generated, as shown (t1010). Each plane that is shown (t1010) may mean an image/video at each viewpoint. A plurality of captured images/videos may be raw data. At the capturing process, capturing-related metadata may be generated.

A special camera for VR may be used for capturing. In some embodiments, in the case in which 360-degree video for a virtual space generated by a computer is provided, capturing may not be performed using an actual camera. In this case, a process of simply generating related data may replace the capturing process.

The preparation process may be a process of processing the captured images/videos and the metadata generated at the capturing process. At the preparation process, the captured images/videos may undergo a stitching process, a projection process, a region-wise packing process, and/or an encoding process.

First, each image/video may undergo the stitching process. The stitching process may be a process of connecting the captured images/videos to generate a panoramic image/video or a spherical image/video.

Subsequently, the stitched image/video may undergo the projection process. At the projection process, the stitched image/video may be projected on a 2D image. Depending on the context, the 2D image may be called a 2D image frame. 2D image projection may be expressed as 2D image mapping. The projected image/video data may have the form of a 2D image, as shown (t1020).

The video data projected on the 2D image may undergo the region-wise packing process in order to improve video coding efficiency. The region-wise packing process may be a process of individually processing the video data projected on the 2D image for each region. Here, the term “regions” may indicate divided parts of the 2D image on which the video data are projected. In some embodiments, regions may be partitioned by uniformly or arbitrarily dividing the 2D image. Also, in some embodiments, regions may be partitioned depending on a projection scheme. The region-wise packing process is optional, and thus may be omitted from the preparation process.

In some embodiments, this process may include a process of rotating each region or rearranging the regions on the 2D image in order to improve video coding efficiency. For example, the regions may be rotated such that specific sides of the regions are located so as to be adjacent to each other, whereby coding efficiency may be improved.

In some embodiments, this process may include a process of increasing or decreasing the resolution of a specific region in order to change the resolution for regions on the 360-degree video. For example, regions corresponding to relatively important regions in the 360-degree video may have higher resolution than other regions. The video data projected on the 2D image or the region-wise packed video data may undergo the encoding process via a video codec.

In some embodiments, the preparation process may further include an editing process. At the editing process, image/video data before and after projection may be edited. At the preparation process, metadata related to stitching/projection/encoding/editing may be generated in the same manner In addition, metadata related to the initial viewpoint of the video data projected on the 2D image or a region of interest (ROI) may be generated.

The delivery process may be a process of processing and delivering the image/video data that have undergone the preparation process and the metadata. Processing may be performed based on an arbitrary transport protocol for delivery. The data that have been processed for delivery may be delivered through a broadcast network and/or a broadband connection. The data may be delivered to the reception side in an on-demand manner The reception side may receive the data through various paths.

The processing process may be a process of decoding the received data and re-projecting the projected image/video data on a 3D model. In this process, the image/video data projected on the 2D image may be re-projected in a 3D space. Depending on the context, this process may be called mapping or projection. At this time, the mapped 3D space may have different forms depending on the 3D model. For example, the 3D model may be a sphere, a cube, a cylinder, or a pyramid.

In some embodiments, the processing process may further include an editing process and an up-scaling process. At the editing process, the image/video data before and after re-projection may be edited. In the case in which the image/video data are down-scaled, the size of the image/video data may be increased through up-scaling at the up-scaling process. As needed, the size of the image/video data may be decreased through down-scaling.

The rendering process may be a process of rendering and displaying the image/video data re-projected in the 3D space. Depending on the context, a combination of re-projection and rendering may be expressed as rendering on the 3D model. The image/video re-projected on the 3D model (or rendered on the 3D model) may have the form that is shown (t1030). The image/video is re-projected on a spherical 3D model, as shown (t1030). The user may view a portion of the rendered image/video through a VR display. At this time, the portion of the image/video that is viewed by the user may have the form that is shown (t1040).

The feedback process may be a process of transmitting various kinds of feedback information that may be acquired at a display process to a transmission side. Interactivity may be provided in enjoying the 360-degree video through the feedback process. In some embodiments, head orientation information, information about a viewport, which indicates the region that is being viewed by the user, etc. may be transmitted to the transmission side at the feedback process. In some embodiments, the user may interact with what is realized in the VR environment. In this case, information related to the interactivity may be provided to the transmission side or to a service provider side at the feedback process. In some embodiments, the feedback process may not be performed.

The head orientation information may be information about the position, angle, and movement of the head of the user. Information about the region that is being viewed by the user in the 360-degree video, i.e. the viewport information, may be calculated based on this information.

The viewport information may be information about the region that is being viewed by the user in the 360-degree video. Gaze analysis may be performed therethrough, and therefore it is possible to check the manner in which the user enjoys the 360-degree video, the region of the 360-degree video at which the user gazes, and the amount of time during which the user gazes at the 360-degree video. The gaze analysis may be performed at the reception side and may be delivered to the transmission side through a feedback channel. An apparatus, such as a VR display, may extract a viewport region based on the position/orientation of the head of the user, a vertical or horizontal FOV that is supported by the apparatus, etc.

In some embodiments, the feedback information may not only be delivered to the transmission side, but may also be used at the reception side. That is, the decoding, re-projection, and rendering processes may be performed at the reception side using the feedback information. For example, only the portion of the 360-degree video that is being viewed by the user may be decoded and rendered first using the head orientation information and/or the viewport information.

Here, the viewport or the viewport region may be the portion of the 360-degree video that is being viewed by the user. The viewpoint, which is the point in the 360-degree video that is being viewed by the user, may be the very center of the viewport region. That is, the viewport is a region based on the viewpoint. The size or shape of the region may be set by a field of view (FOY), a description of which will follow.

In the entire architecture for 360-degree video provision, the image/video data that undergo a series of capturing/projection/encoding/delivery/decoding/re-projection/rendering processes may be called 360-degree video data. The term “360-degree video data” may be used to conceptually include metadata or signaling information related to the image/video data.

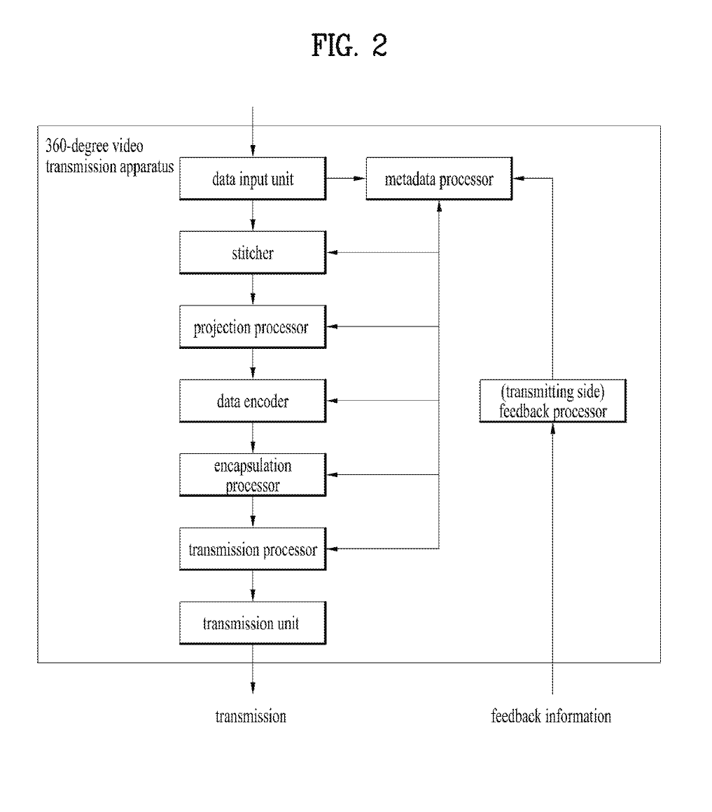

FIG. 2 is a view showing a 360-degree video transmission apparatus according to an aspect of the present invention.

According to an aspect of the present invention, the present invention may be related to a 360-degree video transmission apparatus. The 360-degree video transmission apparatus according to the present invention may perform operations related to the preparation process and the delivery process. The 360-degree video transmission apparatus according to the present invention may include a data input unit, a stitcher, a projection-processing unit, a region-wise packing processing unit (not shown), a metadata-processing unit, a (transmission-side) feedback-processing unit, a data encoder, an encapsulation-processing unit, a transmission-processing unit, and/or a transmission unit as internal/external elements.

The data input unit may allow captured viewpoint-wise images/videos to be input. The viewpoint-wise image/videos may be images/videos captured using at least one camera. In addition, the data input unit may allow metadata generated at the capturing process to be input. The data input unit may deliver the input viewpoint-wise images/videos to the stitcher, and may deliver the metadata generated at the capturing process to a signaling processing unit.

The stitcher may stitch the captured viewpoint-wise images/videos. The stitcher may deliver the stitched 360-degree video data to the projection-processing unit. As needed, the stitcher may receive necessary metadata from the metadata-processing unit in order to use the received metadata at the stitching process. The stitcher may deliver metadata generated at the stitching process to the metadata-proces sing unit. The metadata generated at the stitching process may include information about whether stitching has been performed and the stitching type.

The projection-processing unit may project the stitched 360-degree video data on a 2D image. The projection-processing unit may perform projection according to various schemes, which will be described below. The projection-processing unit may perform mapping in consideration of the depth of the viewpoint-wise 360-degree video data. As needed, the projection-processing unit may receive metadata necessary for projection from the metadata-processing unit in order to use the received metadata for projection. The projection-processing unit may deliver metadata generated at the projection process to the metadata-processing unit. The metadata of the projection-processing unit may include information about the kind of projection scheme.

The region-wise packing processing unit (not shown) may perform the region-wise packing process. That is, the region-wise packing processing unit may divide the projected 360-degree video data into regions, and may rotate or re-arrange each region, or may change the resolution of each region. As previously described, the region-wise packing process is optional. In the case in which the region-wise packing process is not performed, the region-wise packing processing unit may be omitted. As needed, the region-wise packing processing unit may receive metadata necessary for region-wise packing from the metadata-processing unit in order to use the received metadata for region-wise packing. The region-wise packing processing unit may deliver metadata generated at the region-wise packing process to the metadata-processing unit. The metadata of the region-wise packing processing unit may include the extent of rotation and the size of each region.

In some embodiments, the stitcher, the projection-processing unit, and/or the region-wise packing processing unit may be incorporated into a single hardware component.

The metadata-processing unit may process metadata that may be generated at the capturing process, the stitching process, the projection process, the region-wise packing process, the encoding process, the encapsulation process, and/or the processing process for delivery. The metadata-processing unit may generate 360-degree-video-related metadata using the above-mentioned metadata. In some embodiments, the metadata-processing unit may generate the 360-degree-video-related metadata in the form of a signaling tab le. Depending on the context of signaling, the 360-degree-video-related metadata may be called metadata or signaling information related to the 360-degree video. In addition, the metadata-processing unit may deliver the acquired or generated metadata to the internal elements of the 360-degree video transmission apparatus, as needed. The metadata-processing unit may deliver the 360-degree-video-related metadata to the data encoder, the encapsulation-processing unit, and/or the transmission-processing unit such that the 360-degree-video-related metadata can be transmitted to the reception side.

The data encoder may encode the 360-degree video data projected on the 2D image and/or the region-wise packed 360-degree video data. The 360-degree video data may be encoded in various formats.

The encapsulation-processing unit may encapsulate the encoded 360-degree video data and/or the 360-degree-video-related metadata in the form of a file. Here, the 360-degree-video-related metadata may be metadata received from the metadata-processing unit. The encapsulation-processing unit may encapsulate the data in a file format of ISOBMFF or CFF, or may process the data in the form of a DASH segment. In some embodiments, the encapsulation-processing unit may include the 360-degree-video-related metadata on the file format. For example, the 360-degree-video-related metadata may be included in various levels of boxes in the ISOBMFF file format, or may be included as data in a separate track within the file. In some embodiments, the encapsulation-processing unit may encapsulate the 360-degree-video-related metadata itself as a file.

The transmission-processing unit may perform processing for transmission on the encapsulated 360-degree video data according to the file format. The transmission-processing unit may process the 360-degree video data according to an arbitrary transport protocol. Processing for transmission may include processing for delivery through a broadcast network and processing for delivery through a broadband connection. In some embodiments, the transmission-processing unit may receive 360-degree-video-related metadata from the metadata-processing unit, in addition to the 360-degree video data, and may perform processing for transmission thereon.

The transmission unit may transmit the transmission-processed 360-degree video data and/or the 360-degree-video-related metadata through the broadcast network and/or the broadband connection. The transmission unit may include an element for transmission through the broadcast network and/or an element for transmission through the broadband connection.

In an embodiment of the 360-degree video transmission apparatus according to the present invention, the 360-degree video transmission apparatus may further include a data storage unit (not shown) as an internal/external element. The data storage unit may store the encoded 360-degree video data and/or the 360-degree-video-related metadata before delivery to the transmission-processing unit. The data may be stored in a file format of ISOBMFF. In the case in which the 360-degree video is transmitted in real time, no data storage unit is needed. In the case in which the 360-degree video is transmitted on demand, in non-real time (NRT), or through a broadband connection, however, the encapsulated 360-degree data may be transmitted after being stored in the data storage unit for a predetermined period of time.

In another embodiment of the 360-degree video transmission apparatus according to the present invention, the 360-degree video transmission apparatus may further include a (transmission-side) feedback-processing unit and/or a network interface (not shown) as an internal/external element. The network interface may receive feedback information from a 360-degree video reception apparatus according to the present invention, and may deliver the received feedback information to the transmission-side feedback-processing unit. The transmission-side feedback-processing unit may deliver the feedback information to the stitcher, the projection-processing unit, the region-wise packing processing unit, the data encoder, the encapsulation-processing unit, the metadata-processing unit, and/or the transmission-processing unit. In some embodiments, the feedback information may be delivered to the metadata-proces sing unit, and may then be delivered to the respective internal elements. After receiving the feedback information, the internal elements may reflect the feedback information when subsequently processing the 360-degree video data.

In another embodiment of the 360-degree video transmission apparatus according to the present invention, the region-wise packing processing unit may rotate each region, and may map the rotated region on the 2D image. At this time, the regions may be rotated in different directions and at different angles, and may be mapped on the 2D image. The rotation of the regions may be performed in consideration of the portions of the 360-degree video data that were adjacent to each other on the spherical surface before projection and the stitched portions thereof. Information about the rotation of the regions, i.e. the rotational direction and the rotational angle, may be signaled by the 360-degree-video-related metadata. In another embodiment of the 360-degree video transmission apparatus according to the present invention, the data encoder may differently encode the regions. The data encoder may encode some regions at high quality, and may encode some regions at low quality. The transmission-side feedback-processing unit may deliver the feedback information, received from the 360-degree video reception apparatus, to the data encoder, which may differently encode the regions. For example, the transmission-side feedback-processing unit may deliver the viewport information, received from the reception side, to the data encoder. The data encoder may encode regions including the regions indicated by the viewport information at higher quality (UHD, etc.) than other regions.

In a further embodiment of the 360-degree video transmission apparatus according to the present invention, the transmission-processing unit may differently perform processing for transmission on the regions. The transmission-processing unit may apply different transport parameters (modulation order, code rate, etc.) to the regions such that robustness of data delivered for each region is changed.

At this time, the transmission-side feedback-processing unit may deliver the feedback information, received from the 360-degree video reception apparatus, to the transmission-processing unit, which may differently perform transmission processing for the regions. For example, the transmission-side feedback-processing unit may deliver the viewport information, received from the reception side, to the transmission-processing unit. The transmission-processing unit may perform transmission processing on regions including the regions indicated by the viewport information so as to have higher robustness than other regions.

The internal/external elements of the 360-degree video transmission apparatus according to the present invention may be hardware elements that are realized as hardware. In some embodiments, however, the internal/external elements may be changed, omitted, replaced, or incorporated. In some embodiments, additional elements may be added to the 360-degree video transmission apparatus.

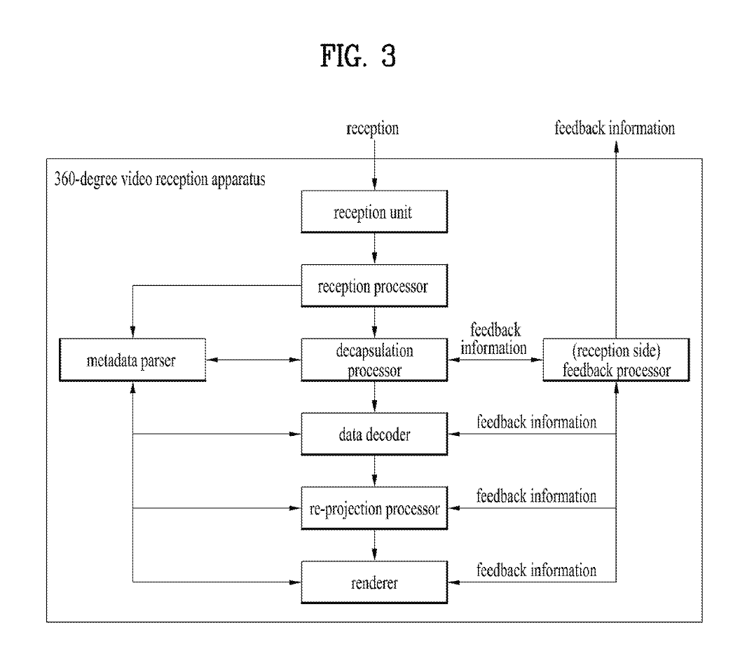

FIG. 3 is a view showing a 360-degree video reception apparatus according to another aspect of the present invention.

According to another aspect of the present invention, the present invention may be related to a 360-degree video reception apparatus. The 360-degree video reception apparatus according to the present invention may perform operations related to the processing process and/or the rendering process. The 360-degree video reception apparatus according to the present invention may include a reception unit, a reception-processing unit, a decapsulation-processing unit, a data decoder, a metadata parser, a (reception-side) feedback-processing unit, a re-projection processing unit, and/or a renderer as internal/external elements.

The reception unit may receive 360-degree video data transmitted by the 360-degree video transmission apparatus. Depending on the channel through which the 360-degree video data are transmitted, the reception unit may receive the 360-degree video data through a broadcast network, or may receive the 360-degree video data through a broadband connection.

The reception-processing unit may process the received 360-degree video data according to a transport protocol. In order to correspond to processing for transmission at the transmission side, the reception-processing unit may perform the reverse process of the transmission-processing unit. The reception-processing unit may deliver the acquired 360-degree video data to the decapsulation-processing unit, and may deliver the acquired 360-degree-video-related metadata to the metadata parser. The 360-degree-video-related metadata, acquired by the reception-processing unit, may have the form of a signaling table.

The decapsulation-processing unit may decapsulate the 360-degree video data, received in file form from the reception-processing unit. The decapsulation-processing unit may decapsulate the files based on ISOBMFF, etc. to acquire 360-degree video data and 360-degree-video-related metadata. The acquired 360-degree video data may be delivered to the data decoder, and the acquired 360-degree-video-related metadata may be delivered to the metadata parser. The 360-degree-video-related metadata, acquired by the decapsulation-processing unit, may have the form of a box or a track in a file format. As needed, the decapsulation-processing unit may receive metadata necessary for decapsulation from the metadata parser.

The data decoder may decode the 360-degree video data. The data decoder may receive metadata necessary for decoding from the metadata parser. The 360-degree-video-related metadata, acquired at the data decoding process, may be delivered to the metadata parser.

The metadata parser may parse/decode the 360-degree-video-related metadata. The metadata parser may deliver the acquired metadata to the decapsulation-processing unit, the data decoder, the re-projection processing unit, and/or the renderer.

The re-projection processing unit may re-project the decoded 360-degree video data. The re-projection processing unit may re-project the 360-degree video data in a 3D space.

The 3D space may have different forms depending on the 3D models that are used. The re-projection processing unit may receive metadata for re-projection from the metadata parser. For example, the re-projection processing unit may receive information about the type of 3D model that is used and the details thereof from the metadata parser. In some embodiments, the re-projection processing unit may re-project, in the 3D space, only the portion of 360-degree video data that corresponds to a specific region in the 3D space using the metadata for re-projection.

The renderer may render the re-projected 360-degree video data. As previously described, the 360-degree video data may be expressed as being rendered in the 3D space. In the case in which two processes are performed simultaneously, the re-projection processing unit and the renderer may be incorporated such that the renderer can perform these processes. In some embodiments, the renderer may render only the portion that is being viewed by a user according to user's viewpoint information.

The user may view a portion of the rendered 360-degree video through a VR display. The VR display, which is a device that reproduces the 360-degree video, may be included in the 360-degree video reception apparatus (tethered), or may be connected to the 360-degree video reception apparatus (untethered).

In an embodiment of the 360-degree video reception apparatus according to the present invention, the 360-degree video reception apparatus may further include a (reception-side) feedback-processing unit and/or a network interface (not shown) as an internal/external element. The reception-side feedback-processing unit may acquire and process feedback information from the renderer, the re-projection processing unit, the data decoder, the decapsulation-processing unit, and/or the VR display. The feedback information may include viewport information, head orientation information, and gaze information. The network interface may receive the feedback information from the reception-side feedback-processing unit, and may transmit the same to the 360-degree video transmission apparatus.

As previously described, the feedback information may not only be delivered to the transmission side but may also be used at the reception side. The reception-side feedback-processing unit may deliver the acquired feedback information to the internal elements of the 360-degree video reception apparatus so as to be reflected at the rendering process. The reception-side feedback-processing unit may deliver the feedback information to the renderer, the re-projection processing unit, the data decoder, and/or the decapsulation-processing unit. For example, the renderer may first render the region that is being viewed by the user using the feedback information. In addition, the decapsulation-processing unit and the data decoder may first decapsulate and decode the region that is being viewed by the user or the region that will be viewed by the user.

The internal/external elements of the 360-degree video reception apparatus according to the present invention described above may be hardware elements that are realized as hardware. In some embodiments, the internal/external elements may be changed, omitted, replaced, or incorporated. In some embodiments, additional elements may be added to the 360-degree video reception apparatus.

According to another aspect of the present invention, the present invention may be related to a 360-degree video transmission method and a 360-degree video reception method. The 360-degree video transmission/reception method according to the present invention may be performed by the 360-degree video transmission/reception apparatus according to the present invention described above or embodiments of the apparatus.

Embodiments of the 360-degree video transmission/reception apparatus and transmission/reception method according to the present invention and embodiments of the internal/external elements thereof may be combined. For example, embodiments of the projection-processing unit and embodiments of the data encoder may be combined in order to provide a number of possible embodiments of the 360-degree video transmission apparatus. Such combined embodiments also fall within the scope of the present invention.

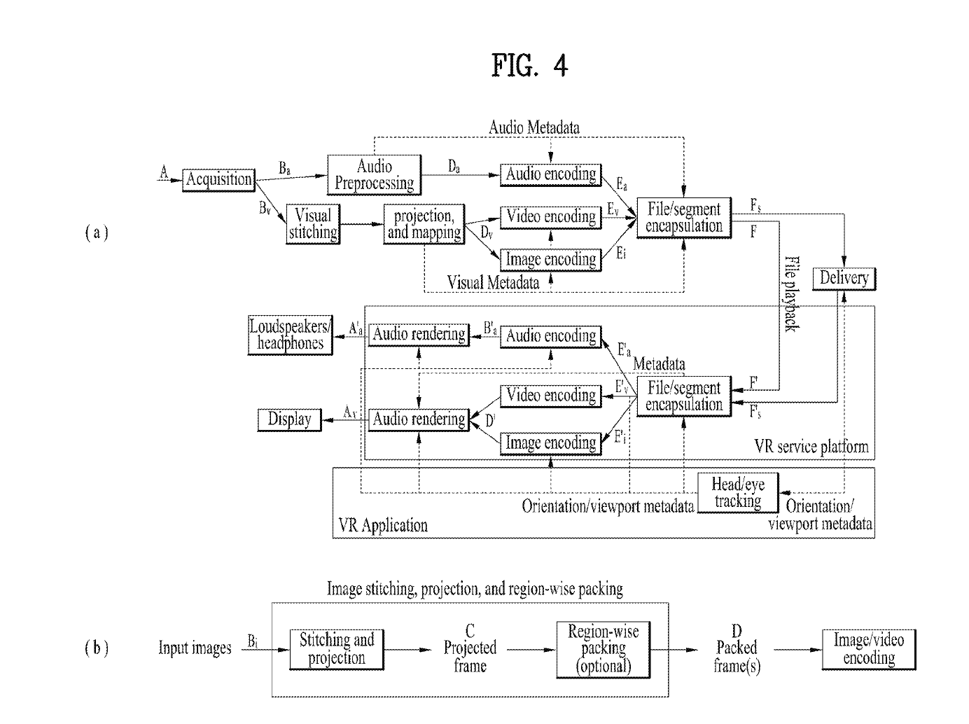

FIG. 4 is a view showing a 360-degree video transmission apparatus/360-degree video reception apparatus according to another embodiment of the present invention.

As previously described, 360-degree content may be provided through the architecture shown in FIG. 4(a). The 360-degree content may be provided in the form of a file, or may be provided in the form of segment-based download or streaming service, such as DASH. Here, the 360-degree content may be called VR content.

As previously described, 360-degree video data and/or 360-degree audio data may be acquired (Acquisition).

The 360-degree audio data may undergo an audio preprocessing process and an audio encoding process. In these processes, audio-related metadata may be generated. The encoded audio and the audio-related metadata may undergo processing for transmission (file/segment encapsulation).

The 360-degree video data may undergo the same processes as previously described. The stitcher of the 360-degree video transmission apparatus may perform stitching on the 360-degree video data (Visual stitching). In some embodiments, this process may be omitted, and may be performed at the reception side. The projection-processing unit of the 360-degree video transmission apparatus may project the 360-degree video data on a 2D image (Projection and mapping (packing)).

The stitching and projection processes are shown in detail in FIG. 4(b). As shown in FIG. 4(b), when the 360-degree video data (input image) is received, stitching and projection may be performed. Specifically, at the projection process, the stitched 360-degree video data may be projected in a 3D space, and the projected 360-degree video data may be arranged on the 2D image. In this specification, this process may be expressed as projecting the 360-degree video data on the 2D image. Here, the 3D space may be a sphere or a cube. The 3D space may be the same as the 3D space used for re-projection at the reception side.

The 2D image may be called a projected frame C. Region-wise packing may be selectively performed on the 2D image. When region-wise packing is performed, the position, shape, and size of each region may be indicated such that the regions on the 2D image can be mapped on a packed frame D. When region-wise packing is not performed, the projected frame may be the same as the packed frame. The regions will be described below. The projection process and the region-wise packing process may be expressed as projecting the regions of the 360-degree video data on the 2D image. Depending on the design, the 360-degree video data may be directly converted into the packed frame without undergoing intermediate processes.

As shown in FIG. 4(a), the projected 360-degree video data may be image-encoded or video-encoded. Since even the same content may have different viewpoints, the same content may be encoded in different bitstreams. The encoded 360-degree video data may be processed in a file format of ISOBMFF by the encapsulation-processing unit. Alternatively, the encapsulation-processing unit may process the encoded 360-degree video data into segments. The segments may be included in individual tracks for transmission based on DASH.

When the 360-degree video data are processed, 360-degree-video-related metadata may be generated, as previously described. The metadata may be delivered while being included in a video stream or a file format. The metadata may also be used at the encoding process, file format encapsulation, or processing for transmission.

The 360-degree audio/video data may undergo processing for transmission according to the transport protocol, and may then be transmitted. The 360-degree video reception apparatus may receive the same through a broadcast network or a broadband connection.

In FIG. 4(a), a VR service platform may correspond to one embodiment of the 360-degree video reception apparatus. In FIG. 4(a), Loudspeaker/headphone, display, and head/eye tracking components are shown as being performed by an external device of the 360-degree video reception apparatus or VR application. In some embodiments, the 360-degree video reception apparatus may include these components. In some embodiments, the head/eye tracking component may correspond to the reception-side feedback-processing unit.

The 360-degree video reception apparatus may perform file/segment decapsulation for reception on the 360-degree audio/video data. The 360-degree audio data may undergo audio decoding and audio rendering, and may then be provided to a user through the loudspeaker/headphone component.

The 360-degree video data may undergo image decoding or video decoding and visual rendering, and may then be provided to the user through the display component. Here, the display component may be a display that supports VR or a general display.

As previously described, specifically, the rendering process may be expressed as re-projecting the 360-degree video data in the 3D space and rendering the re-projected 360-degree video data. This may also be expressed as rendering the 360-degree video data in the 3D space.

The head/eye tracking component may acquire and process head orientation information, gaze information, and viewport information of the user, which have been described previously.

A VR application that communicates with the reception-side processes may be provided at the reception side.

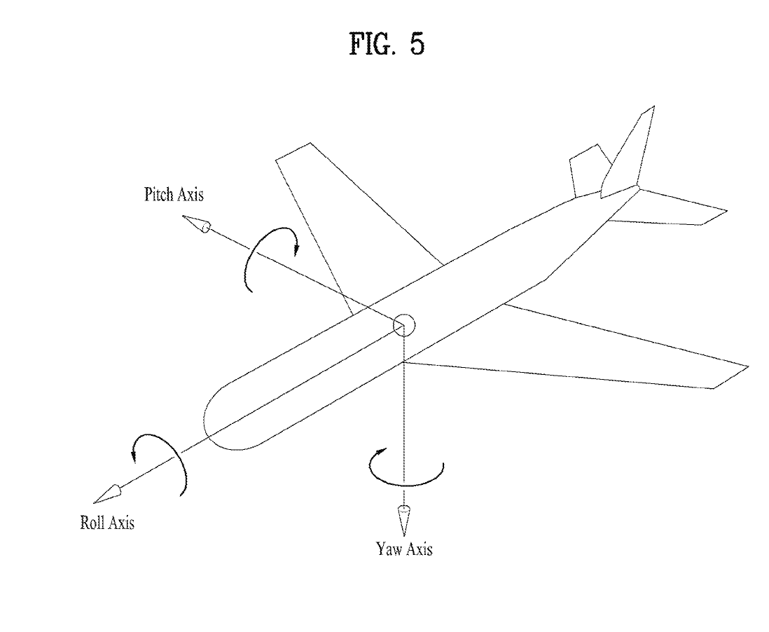

FIG. 5 is a view showing the concept of principal aircraft axes for describing 3D space in connection with the present invention.

In the present invention, the concept of principal aircraft axes may be used in order to express a specific point, position, direction, distance, region, etc. in the 3D space.

That is, in the present invention, the 3D space before projection or after re-projection may be described, and the concept of principal aircraft axes may be used in order to perform signaling thereon. In some embodiments, a method of using X, Y, and Z-axis concepts or a spherical coordinate system may be used.

An aircraft may freely rotate in three dimensions. Axes constituting the three dimensions are referred to as a pitch axis, a yaw axis, and a roll axis. In this specification, these terms may also be expressed either as pitch, yaw, and roll or as a pitch direction, a yaw direction, and a roll direction.

The pitch axis may be an axis about which the forward portion of the aircraft is rotated upwards/downwards. In the shown concept of principal aircraft axes, the pitch axis may be an axis extending from one wing to another wing of the aircraft.

The yaw axis may be an axis about which the forward portion of the aircraft is rotated leftwards/rightwards. In the shown concept of principal aircraft axes, the yaw axis may be an axis extending from the top to the bottom of the aircraft.

In the shown concept of principal aircraft axes, the roll axis may be an axis extending from the forward portion to the tail of the aircraft. Rotation in the roll direction may be rotation performed about the roll axis.

As previously described, the 3D space in the present invention may be described using the pitch, yaw, and roll concept.

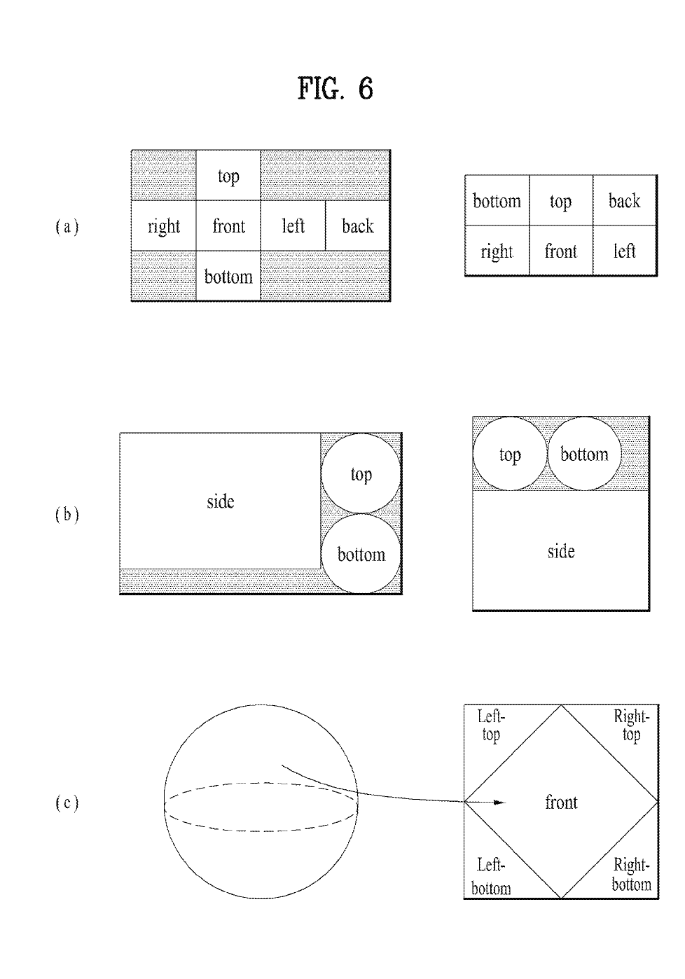

FIG. 6 is a view showing projection schemes according to an embodiment of the present invention.

As previously described, the projection-processing unit of the 360-degree video transmission apparatus according to the present invention may project the stitched 360-degree video data on the 2D image. In this process, various projection schemes may be used.

In another embodiment of the 360-degree video transmission apparatus according to the present invention, the projection-processing unit may perform projection using a cubic projection scheme. For example, the stitched 360-degree video data may appear on a spherical surface. The projection-processing unit may project the 360-degree video data on the 2D image in the form of a cube. The 360-degree video data on the spherical surface may correspond to respective surfaces of the cube. As a result, the 360-degree video data may be projected on the 2D image, as shown at the left side or the right side of FIG. 6(a).

In another embodiment of the 360-degree video transmission apparatus according to the present invention, the projection-processing unit may perform projection using a cylindrical projection scheme. In the same manner, on the assumption that the stitched 360-degree video data appear on a spherical surface, the projection-processing unit may project the 360-degree video data on the 2D image in the form of a cylinder. The 360-degree video data on the spherical surface may correspond to the side, the top, and the bottom of the cylinder. As a result, the 360-degree video data may be projected on the 2D image, as shown at the left side or the right side of FIG. 6(b).

In a further embodiment of the 360-degree video transmission apparatus according to the present invention, the projection-processing unit may perform projection using a pyramidal projection scheme. In the same manner, on the assumption that the stitched 360-degree video data appears on a spherical surface, the projection-processing unit may project the 360-degree video data on the 2D image in the form of a pyramid. The 360-degree video data on the spherical surface may correspond to the front, the left top, the left bottom, the right top, and the right bottom of the pyramid. As a result, the 360-degree video data may be projected on the 2D image, as shown at the left side or the right side of FIG. 6(c).

In some embodiments, the projection-processing unit may perform projection using an equirectangular projection scheme or a panoramic projection scheme, in addition to the above-mentioned schemes.

As previously described, the regions may be divided parts of the 2D image on which the 360-degree video data are projected. The regions do not necessarily coincide with respective surfaces on the 2D image projected according to the projection scheme. In some embodiments, however, the regions may be partitioned so as to correspond to the projected surfaces on the 2D image such that region-wise packing can be performed. In some embodiments, a plurality of surfaces may correspond to a single region, and a single surface corresponds to a plurality of regions. In this case, the regions may be changed depending on the projection scheme. For example, in FIG. 6(a), the respective surfaces (top, bottom, front, left, right, and back) of the cube may be respective regions. In FIG. 6(b), the side, the top, and the bottom of the cylinder may be respective regions. In FIG. 6(c), the front and the four-directional lateral surfaces (left top, left bottom, right top, and right bottom) of the pyramid may be respective regions.

FIG. 7 is a view showing a tile according to an embodiment of the present invention.

The 360-degree video data projected on the 2D image or the 360-degree video data that have undergone region-wise packing may be partitioned into one or more tiles. FIG. 7(a) shows a 2D image divided into 16 tiles. Here, the 2D image may be the projected frame or the packed frame. In another embodiment of the 360-degree video transmission apparatus according to the present invention, the data encoder may independently encode the tiles.

Region-wise packing and tiling may be different from each other. Region-wise packing may be processing each region of the 360-degree video data projected on the 2D image in order to improve coding efficiency or to adjust resolution. Tiling may be the data encoder dividing the projected frame or the packed frame into tiles and independently encoding the tiles. When the 360-degree video data are provided, the user does not simultaneously enjoy all parts of the 360-degree video data. Tiling may enable the user to enjoy or transmit only tiles corresponding to an important part or a predetermined part, such as the viewport that is being viewed by the user, to the reception side within a limited bandwidth. The limited bandwidth may be more efficiently utilized through tiling, and calculation load may be reduced because the reception side does not process the entire 360-degree video data at once.

Since the regions and the tiles are different from each other, the two regions are not necessarily the same. In some embodiments, however, the regions and the tiles may indicate the same regions. In some embodiments, region-wise packing may be performed based on the tiles, whereby the regions and the tiles may become the same. Also, in some embodiments, in the case in which the surfaces according to the projection scheme and the regions are the same, the surface according to the projection scheme, the regions, and the tiles may indicate the same regions. Depending on the context, the regions may be called VR regions, and the tiles may be called tile regions.

A region of interest (ROI) may be a region in which users are interested, proposed by a 360-degree content provider. The 360-degree content provider may produce a 360-degree video in consideration of the region of the 360-degree video in which users are interested. In some embodiments, the ROI may correspond to a region of the 360-degree video in which an important portion of the 360-degree video is shown.

In another embodiment of the 360-degree video transmission/reception apparatus according to the present invention, the reception-side feedback-processing unit may extract and collect viewport information, and may deliver the same to the transmission-side feedback-processing unit. At this process, the viewport information may be delivered using the network interfaces of both sides. FIG. 7(a) shows a viewport t6010 displayed on the 2D image. Here, the viewport may be located over 9 tiles on the 2D image.

In this case, the 360-degree video transmission apparatus may further include a tiling system. In some embodiments, the tiling system may be disposed after the data encoder (see FIG. 7(b)), may be included in the data encoder or the transmission-processing unit, or may be included in the 360-degree video transmission apparatus as a separate internal/external element.

The tiling system may receive the viewport information from the transmission-side feedback-processing unit. The tiling system may select and transmit only tiles including the viewport region. In the FIG. 7(a), 9 tiles including the viewport region t6010, among a total of 16 tiles of the 2D image, may be transmitted. Here, the tiling system may transmit the tiles in a unicast manner over a broadband connection. The reason for this is that the viewport region may be changed for respective people.

Also, in this case, the transmission-side feedback-processing unit may deliver the viewport information to the data encoder. The data encoder may encode the tiles including the viewport region at higher quality than other tiles.

Also, in this case, the transmission-side feedback-processing unit may deliver the viewport information to the metadata-processing unit. The metadata-processing unit may deliver metadata related to the viewport region to the internal elements of the 360-degree video transmission apparatus, or may include the same in the 360-degree-video-related metadata.

By using this tiling system, it is possible to save transmission bandwidth and to differently perform processing for each tile, whereby efficient data processing/transmission is possible.

Embodiments related to the viewport region may be similarly applied to specific regions other than the viewport region. For example, processing performed on the viewport region may be equally performed on a region in which users are determined to be interested through the gaze analysis, ROI, and a region that is reproduced first when a user views the 360-degree video through the VR display (initial viewpoint).

In another embodiment of the 360-degree video transmission apparatus according to the present invention, the transmission-processing unit may perform transmission processing differently for respective tiles. The transmission-processing unit may apply different transport parameters (modulation order, code rate, etc.) to the tiles such that robustness of data delivered for each region is changed.

At this time, the transmission-side feedback-processing unit may deliver the feedback information, received from the 360-degree video reception apparatus, to the transmission-processing unit, which may perform transmission processing differently for respective tiles. For example, the transmission-side feedback-processing unit may deliver the viewport information, received from the reception side, to the transmission-processing unit. The transmission-processing unit may perform transmission processing on tiles including the viewport region so as to have higher robustness than for the other tiles.

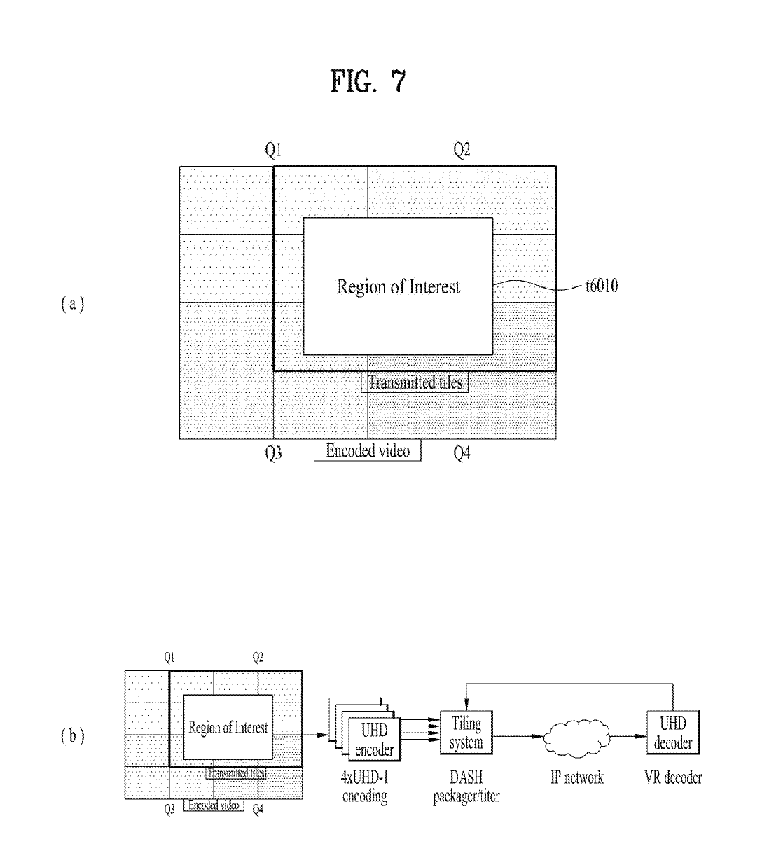

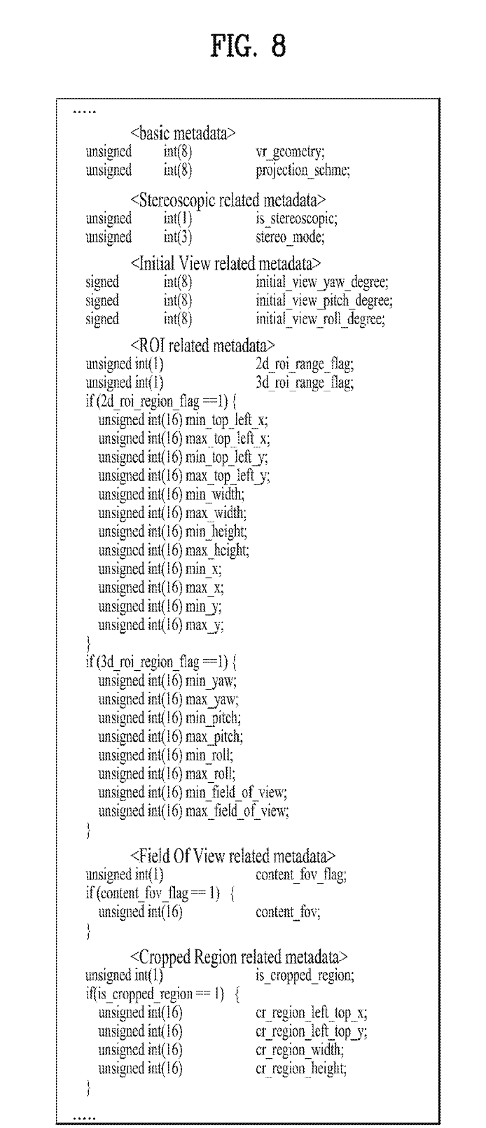

FIG. 8 is a view showing 360-degree-video-related metadata according to an embodiment of the present invention.

The 360-degree-video-related metadata may include various metadata for the 360-degree video. Depending on the context, the 360-degree-video-related metadata may be called 360-degree-video-related signaling information. The 360-degree-video-related metadata may be transmitted while being included in a separate signaling table, or may be transmitted while being included in DASH MPD, or may be transmitted while being included in the form of a box in a file format of ISOBMFF. In the case in which the 360-degree-video-related metadata are included in the form of a box, the metadata may be included in a variety of levels, such as a file, a fragment, a track, a sample entry, and a sample, and may include metadata related to data of a corresponding level.

In some embodiments, a portion of the metadata, a description of which will follow, may be transmitted while being configured in the form of a signaling table, and the remaining portion of the metadata may be included in the form of a box or a track in a file format.

In an embodiment of the 360-degree-video-related metadata according to the present invention, the 360-degree-video-related metadata may include basic metadata about projection schemes, stereoscopy-related metadata, initial-view/initial-viewpoint-related metadata, ROI-related metadata, field-of-view (FOV)-related metadata, and/or cropped-region-related metadata. In some embodiments, the 360-degree-video-related metadata may further include metadata other than the above metadata.

Embodiments of the 360-degree-video-related metadata according to the present invention may include at least one of the basic metadata, the stereoscopy-related metadata, the initial-view-related metadata, the ROI-related metadata, the FOV-related metadata, the cropped-region-related metadata, and/or additional possible metadata. Embodiments of the 360-degree-video-related metadata according to the present invention may be variously configured depending on possible number of metadata included therein. In some embodiments, the 360-degree-video-related metadata may further include additional information.

The basic metadata may include 3D-model-related information and projection-scheme-related information. The basic metadata may include a vr_geometry field and a projection_scheme field. In some embodiments, the basic metadata may include additional information.

The vr_geometry field may indicate the type of 3D model supported by the 360-degree video data. In the case in which the 360-degree video data is re-projected in a 3D space, as previously described, the 3D space may have a form based on the 3D model indicated by the vr_geometry field. In some embodiments, a 3D model used for rendering may be different from a 3D model used for re-projection indicated by the vr_geometry field. In this case, the basic metadata may further include a field indicating the 3D model used for rendering.

In the case in which the field has a value of 0, 1, 2, or 3, the 3D space may follow a 3D model of a sphere, a cube, a cylinder, or a pyramid. In the case in which the field has additional values, the values may be reserved for future use. In some embodiments, the 360-degree-video-related metadata may further include detailed information about the 3D model indicated by the field. Here, the detailed information about the 3D model may be radius information of the sphere or the height information of the cylinder. This field may be omitted.

The projection_scheme field may indicate the projection scheme used when the 360-degree video data is projected on a 2D image. In the case in which the field has a value of 0, 1, 2, 3, 4, or 5, this may indicate that an equirectangular projection scheme, a cubic projection scheme, a cylindrical projection scheme, a tile-based projection scheme, a pyramidal projection scheme, or a panoramic projection scheme has been used. In the case in which the field has a value of 6, this may indicate that the 360-degree video data has been projected on a 2D image without stitching. In the case in which the field has additional values, the values may be reserved for future use. In some embodiments, the 360-degree-video-related metadata may further include detailed information about regions generated by the projection scheme specified by the field. Here, the detailed information about the regions may be rotation of the regions or radius information of the top region of the cylinder.

The stereoscopy-related metadata may include information about 3D-related attributes of the 360-degree video data. The stereoscopy-related metadata may include an is_stereoscopic field and/or a stereo_mode field. In some embodiments, the stereoscopy-related metadata may further include additional information.

The is_stereoscopic field may indicate whether the 360-degree video data support 3D. When the field is 1, this may mean 3D support. When the field is 0, this may mean 3D non-support. This field may be omitted.

The stereo_mode field may indicate a 3D layout supported by the 360-degree video. It is possible to indicate whether the 360-degree video supports 3D using only this field. In this case, the is_stereoscopic field may be omitted. When the field has a value of 0, the 360-degree video may have a mono mode. That is, the 2D image, on which the 360-degree video is projected, may include only one mono view. In this case, the 360-degree video may not support 3D.

When the field has a value of 1 or 2, the 360-degree video may follow a left-right layout or a top-bottom layout. The left-right layout and the top-bottom layout may be called a side-by-side format and a top-bottom format, respectively. In the left-right layout, 2D images on which a left image/a right image are projected may be located at the left/right side on an image frame. In the top-bottom layout, 2D images on which a left image/a right image are projected may be located at the top/bottom side on the image frame. In the case in which the field has additional values, the values may be reserved for future use.

The initial-view-related metadata may include information about the time at which a user views the 360-degree video when the 360-degree video is reproduced first (an initial viewpoint). The initial-view-related metadata may include an initial_view_yaw_degree field, an initial_view_pitch_degree field, and/or an initial_view_roll_degree field. In some embodiments, the initial-view-related metadata may further include additional information.

The initial_view_yaw_degree field, the initial_view_pitch_degree field, and the initial_view_roll_degree field may indicate an initial viewpoint when the 360-degree video is reproduced. That is, the very center point of the viewport that is viewed first at the time of reproduction may be indicated by these three fields. The fields may indicate the position of the right center point as the rotational direction (symbol) and the extent of rotation (angle) about the yaw, pitch, and roll axes. At this time, the viewport that is viewed when the video is reproduced first according to the FOV may be determined. The horizontal length and the vertical length (width and height) of an initial viewport based on the indicated initial viewpoint through the FOV may be determined. That is, the 360-degree video reception apparatus may provide a user with a predetermined region of the 360-degree video as an initial viewport using these three fields and the FOV information.

In some embodiments, the initial viewpoint indicated by the initial-view-related metadata may be changed for each scene. That is, the scenes of the 360-degree video may be changed over time. An initial viewpoint or an initial viewport at which the user views the video first may be changed for every scene of the 360-degree video. In this case, the initial-view-related metadata may indicate the initial viewport for each scene. To this end, the initial-view-related metadata may further include a scene identifier identifying the scene to which the initial viewport is applied. In addition, the FOV may be changed for each scene. The initial-view-related metadata may further include scene-wise FOV information indicating the FOV corresponding to the scene.

The ROI-related metadata may include information related to the ROI. The ROI-related metadata may a 2d_roi_range_flag field and/or a 3d_roi_range_flag field. Each of the two fields may indicate whether the ROI-related metadata includes fields expressing the ROI based on the 2D image or whether the ROI-related metadata includes fields expressing the ROI based on the 3D space. In some embodiments, the ROI-related metadata may further include additional information, such as differential encoding information based on the ROI and differential transmission processing information based on the ROI.

In the case in which the ROI-related metadata includes fields expressing the ROI based on the 2D image, the ROI-related metadata may include a min_top_left_x field, a max_top_left_x field, a min_top_left_y field, a max_top_left_y field, a min_width field, a max_width field, a min_height field, a max_height field, a min_x field, a max_x field, a min_y field, and/or a max_y field.

The min_top_left_x field, the max_top_left_x field, the min_top_left_y field, and the max_top_left_y field may indicate the minimum/maximum values of the coordinates of the left top end of the ROI. These fields may indicate the minimum x coordinate, the maximum x coordinate, the minimum y coordinate, and the maximum y coordinate of the left top end, respectively.

The min_width field, the max_width field, the min_height field, and the max_height field may indicate the minimum/maximum values of the horizontal size (width) and the vertical size (height) of the ROI. These fields may indicate the minimum value of the horizontal size, the maximum value of the horizontal size, the minimum value of the vertical size, and the maximum value of the vertical size, respectively.

The min_x field, the max_x field, the min_y field, and the max_y field may indicate the minimum/maximum values of the coordinates in the ROI. These fields may indicate the minimum x coordinate, the maximum x coordinate, the minimum y coordinate, and the maximum y coordinate of the coordinates in the ROI, respectively. These fields may be omitted.

In the case in which the ROI-related metadata includes fields expressing the ROI based on the coordinates in the 3D rendering space, the ROI-related metadata may include a min_yaw field, a max_yaw field, a min_pitch field, a max_pitch field, a min_roll field, a max_roll field, a min_field_of_view field, and/or a max_field_of_view field.

The min_yaw field, the max_yaw field, the min_pitch field, the max_pitch field, the min_roll field, and the max_roll field may indicate the region that the ROI occupies in 3D space as the minimum/maximum values of yaw, pitch, and roll. These fields may indicate the minimum value of the amount of rotation about the yaw axis, the maximum value of the amount of rotation about the yaw axis, the minimum value of the amount of rotation about the pitch axis, the maximum value of the amount of rotation about the pitch axis, the minimum value of the amount of rotation about the roll axis, and the maximum value of the amount of rotation about the roll axis, respectively.

The min_field_of_view field and the max_field_of view field may indicate the minimum/maximum values of the FOV of the 360-degree video data. The FOV may be a range of vision within which the 360-degree video is displayed at once when the video is reproduced. The min_field_of_view field and the max_field_of view field may indicate the minimum value and the maximum value of the FOV, respectively. These fields may be omitted. These fields may be included in FOV-related metadata, a description of which will follow.

The FOV-related metadata may include the above information related to the FOV. The FOV-related metadata may include a content_fov_flag field and/or a content_fov field. In some embodiments, the FOV-related metadata may further include additional information, such as information related to the minimum/maximum values of the FOV.

The content_fov_flag field may indicate whether information about the FOV of the 360-degree video intended at the time of production exists. When the value of this field is 1, the content_fov field may exist.

The content_fov field may indicate information about the FOV of the 360-degree video intended at the time of production. In some embodiments, the portion of the 360-degree video that is displayed to a user at once may be determined based on the vertical or horizontal FOV of the 360-degree video reception apparatus. Alternatively, in some embodiments, the portion of the 360-degree video that is displayed to the user at once may be determined in consideration of the FOV information of this field.

The cropped-region-related metadata may include information about the region of an image frame that includes actual 360-degree video data. The image frame may include an active video region, in which actual 360-degree video data is projected, and an inactive video region. Here, the active video region may be called a cropped region or a default display region. The active video region is a region that is seen as the 360-degree video in an actual VR display. The 360-degree video reception apparatus or the VR display may process/display only the active video region. For example, in the case in which the aspect ratio of the image frame is 4:3, only the remaining region of the image frame, excluding a portion of the upper part and a portion of the lower part of the image frame, may include the 360-degree video data. The remaining region of the image frame may be the active video region.

The cropped-region-related metadata may include an is_cropped_region field, a cr_region_left_top_x field, a cr_region_left_top_y field, a cr_region_width field, and/or a cr_region_height field. In some embodiments, the cropped-region-related metadata may further include additional information.

The is_cropped_region field may be a flag indicating whether the entire region of the image frame is used by the 360-degree video reception apparatus or the VR display. That is, this field may indicate whether the entire image frame is the active video region. In the case in which only a portion of the image frame is the active video region, the following four fields may be further included.

The cr_region_left_top_x field, the cr_region_left_top_y field, the cr_region_width field, and the cr_region_height field may indicate the active video region in the image frame. These fields may indicate the x coordinate of the left top of the active video region, the y coordinate of the left top of the active video region, the horizontal length (width) of the active video region, and the vertical length (height) of the active video region, respectively. The horizontal length and the vertical length may be expressed using pixels.

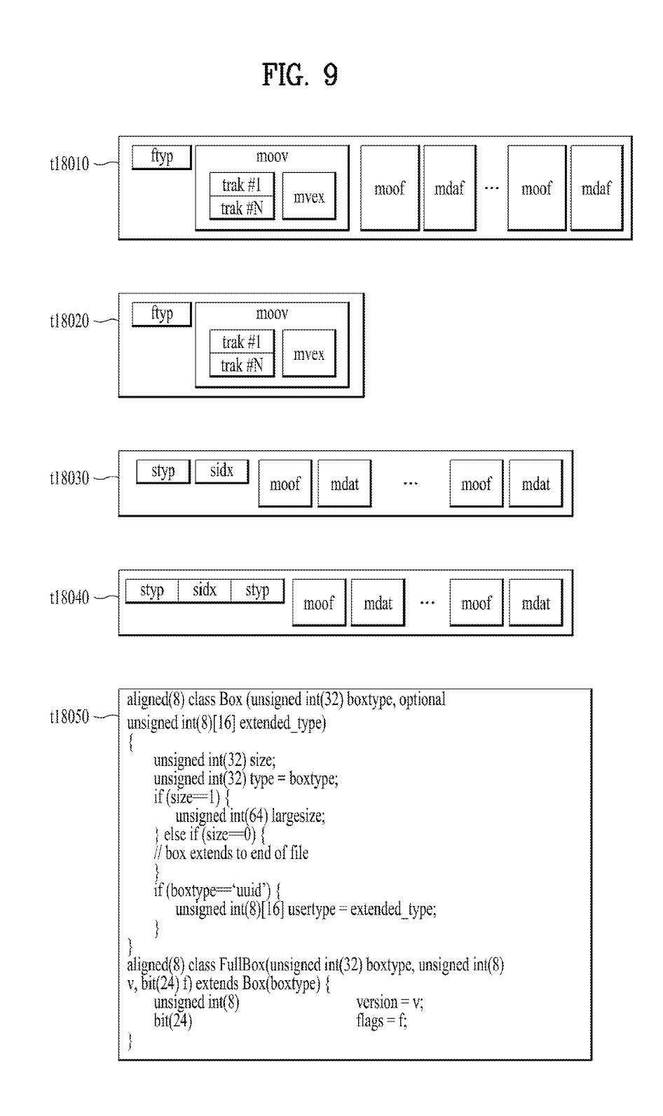

FIG. 9 is a view showing a structure of a media file according to an embodiment of the present invention.

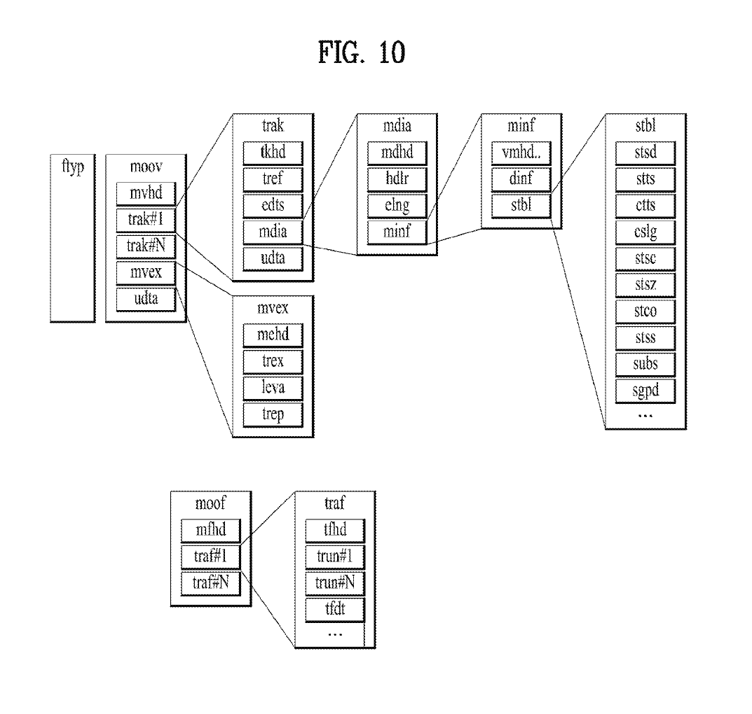

FIG. 10 is a view showing a hierarchical structure of boxes in ISOBMFF according to an embodiment of the present invention.

A standardized media file format may be defined to store and transmit media data, such as audio or video. In some embodiments, the media file may have a file format based on ISO base media file format (ISO BMFF).

The media file according to the present invention may include at least one box. Here, the term “box” may be a data block or object including media data or metadata related to the media data. Boxes may have a hierarchical structure, based on which data are sorted such that the media file has a form suitable for storing and/or transmitting large-capacity media data. In addition, the media file may have a structure enabling a user to easily access media information, e.g. enabling the user to move to a specific point in media content.

The media file according to the present invention may include an ftyp box, an moov box, and/or an mdat box.

The ftyp box (file type box) may provide the file type of the media file or information related to the compatibility thereof. The ftyp box may include configuration version information about media data of the media file. A decoder may sort the media file with reference to the ftyp box.

The moov box (movie box) may be a box including metadata about media data of the media file. The moov box may serve as a container for all metadata. The moov box may be the uppermost-level one of the metadata-related boxes. In some embodiments, only one moov box may exist in the media file.

The mdat box (media data box) may be a box containing actual media data of the media file. The media data may include audio samples and/or video samples. The mdat box may serve as a container containing such media samples.

In some embodiments, the moov box may further include an mvhd box, a trak box, and/or an mvex box as lower boxes.

The mvhd box (movie header box) may include information related to media presentation of media data included in the media file. That is, the mvhd box may include information, such as a media production time, change time, time standard, and period of the media presentation.

The trak box (track box) may provide information related to a track of the media data. The trak box may include information, such as stream-related information, presentation-related information, and access-related information about an audio track or a video track. A plurality of trak boxes may exist depending on the number of tracks.

In some embodiments, the trak box may further include a tkhd box (track heater box) as a lower box. The tkhd box may include information about the track indicated by the trak box. The tkhd box may include information, such as production time, change time, and identifier of the track.

The mvex box (move extended box) may indicate that a moof box, a description of which will follow, may be included in the media file. moof boxes may be scanned in order to know all media samples of a specific track.

In some embodiments, the media file according to the present invention may be divided into a plurality of fragments (t18010). As a result, the media file may be stored or transmitted in the state of being divided. Media data (mdat box) of the media file may be divided into a plurality of fragments, and each fragment may include one moof box and one divided part of the mdat box. In some embodiments, information of the ftyp box and/or the moov box may be needed in order to utilize the fragments.

The moof box (movie fragment box) may provide metadata about media data of the fragment. The moof box may be the uppermost-level one of the metadata-related boxes of the fragment.

The mdat box (media data box) may include actual media data, as previously described. The mdat box may include media samples of the media data corresponding to the fragment.

In some embodiments, the moof box may further include an mfhd box and/or a traf box as lower boxes.

The mfhd box (movie fragment header box) may include information related to correlation between the divided fragments. The mfhd box may indicate the sequence number of the media data of the fragment. In addition, it is possible to check whether there are omitted parts of the divided data using the mfhd box.

The traf box (track fragment box) may include information about the track fragment. The traf box may provide metadata related to the divided track fragment included in the fragment. The traf box may provide metadata in order to decode/reproduce media samples in the track fragment. A plurality of traf boxes may exist depending on the number of track fragments.

In some embodiments, the traf box may further include a tfhd box and/or a trun box as lower boxes.

The tfhd box (track fragment header box) may include header information of the track fragment. The tfhd box may provide information, such as a basic sample size, period, offset, and identifier, for media samples of the track fragment indicated by the traf box.

The trun box (track fragment run box) may include information related to the track fragment. The trun box may include information, such as a period, size, and reproduction start time for each media sample.

The media file or the fragments of the media file may be processed and transmitted as segments. The segments may include an initialization segment and/or a media segment.

The file of the embodiment shown (t18020) may be a file including information related to initialization of a media decoder, excluding a media file. For example, this file may correspond to the initialization segment. The initialization segment may include the ftyp box and/or the moov box.

The file of the embodiment shown (t18030) may be a file including the fragment. For example, this file may correspond to the media segment. The media segment may include the moof box and/or the mdat box. In addition, the media segment may further include an styp box and/or an sidx box.

The styp box (segment type box) may provide information for identifying media data of the divided fragment. The styp box may perform the same function as the ftyp box for the divided fragment. In some embodiments, the styp box may have the same format as the ftyp box.

The sidx box (segment index box) may provide information indicating the index for the divided fragment, through which it is possible to indicate the sequence number of the divided fragment.

In some embodiments (t18040), an ssix box may be further included. In the case in which the segment is divided into sub-segments, the ssix box (sub-segment index box) may provide information indicating the index of the sub-segment.

The boxes in the media file may include further extended information based on the form of a box shown in the embodiment (t18050) or FullBox. In this embodiment, a size field and a largesize field may indicate the length of the box in byte units. A version field may indicate the version of the box format. A type field may indicate the type or identifier of the box. A flags field may indicate a flag related to the box.

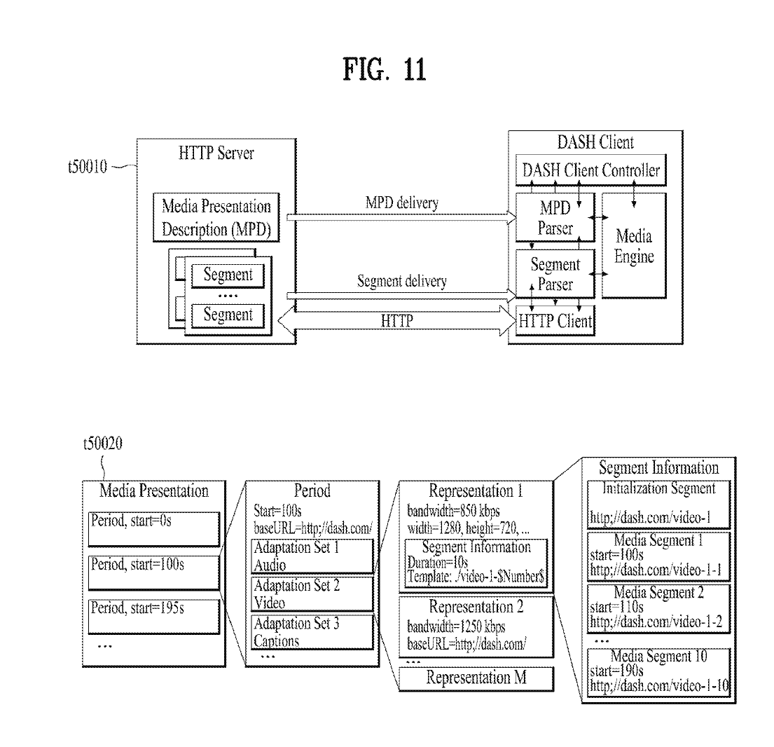

FIG. 11 is a view showing the overall operation of a DASH-based adaptive streaming model according to an embodiment of the present invention.

A DASH-based adaptive streaming model according to the embodiment shown (t50010) describes the operation between an HTTP server and a DASH client. In this case, Dynamic Adaptive Streaming over HTTP (HTTP), which is a protocol for supporting HTTP-based adaptive streaming, may dynamically support streaming depending on network conditions. As a result, AV content may be reproduced without interruption.

First, the DASH client may acquire MPD. The MPD may be delivered from a service provider such as an HTTP server. The DASH client may request a segment described in the MPD from the server using information about access to the segment. Here, this request may be performed in consideration of network conditions.

After acquiring the segment, the DASH client may process the segment using a media engine, and may display the segment on a screen. The DASH client may request and acquire a necessary segment in real-time consideration of reproduction time and/or network conditions (Adaptive Streaming). As a result, content may be reproduced without interruption.

Media Presentation Description (MPD) is a file including detailed information enabling the DASH client to dynamically acquire a segment, and may be expressed in the form of XML.

A DASH client controller may generate a command for requesting MPD and/or a segment in consideration of network conditions. In addition, this controller may perform control such that the acquired information can be used in an internal block such as the media engine.

An MPD parser may parse the acquired MPD in real time. As a result, the DASH client controller may generate a command for acquiring a necessary segment.

A segment parser may parse the acquired segment in real time. The internal block such as the media engine may perform a specific operation depending on information included in the segment.

An HTTP client may request necessary MPD and/or a necessary segment from the HTTP server. In addition, the HTTP client may deliver the MPD and/or segment acquired from the server to the MPD parser or the segment parser.

The media engine may display content using media data included in the segment. At this time, information of the MPD may be used.

A DASH data model may have a hierarchical structure (t50020). Media presentation may be described by the MPD. The MPD may describe the temporal sequence of a plurality of periods making media presentation. One period may indicate one section of the media content.

In one period, data may be included in an adaptation set. The adaptation set may be a set of media content components that can be exchanged with each other. Adaptation may include a set of representations. One representation may correspond to a media content component. In one representation, content may be temporarily divided into a plurality of segments. This may be for appropriate access and delivery. A URL of each segment may be provided in order to access each segment.

The MPD may provide information related to media presentation. A period element, an adaptation set element, and a representation element may describe a corresponding period, adaptation set, and representation, respectively. One representation may be divided into sub-representations. A sub-representation element may describe a corresponding sub-representation.

In this case, common attributes/elements may be defined. These may be applied to (included in) the adaptation set, the representation, and the sub-representation. EssentialProperty and/or SupplementalProperty may be included in the common attributes/elements.

EssentialProperty may be information including elements considered to be essential to process data related to the media presentation. SupplementalProperty may be information including elements that may be used to process data related to the media presentation. In some embodiments, in the case in which descriptors, a description of which will follow, are delivered through the MPD, the descriptors may be delivered while being defined in EssentialProperty and/or SupplementalProperty.

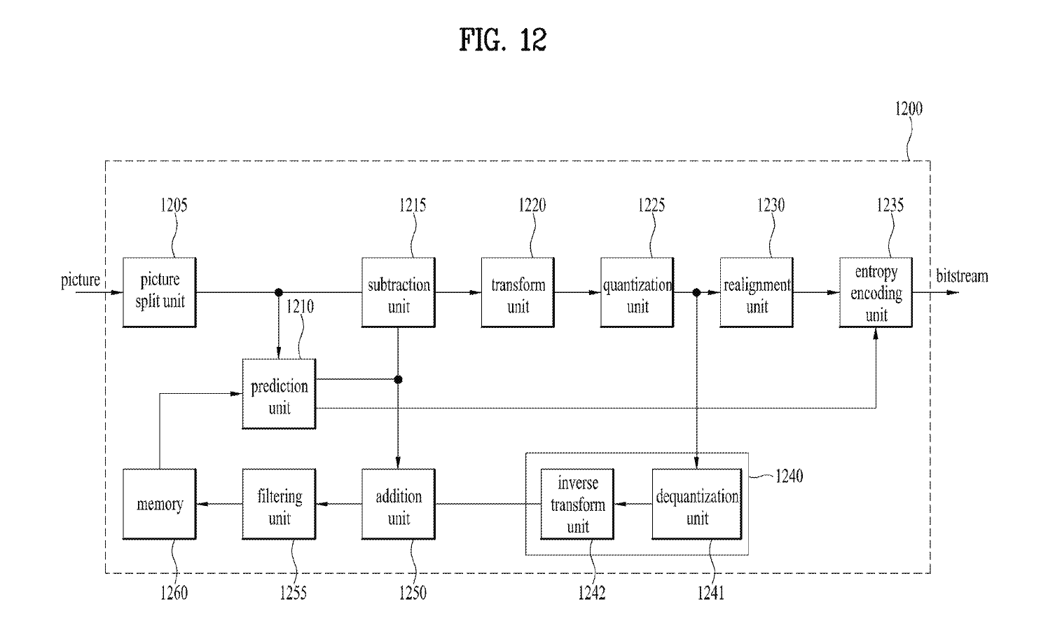

FIG. 12 is a view showing a configuration of a data encoder according to the present invention. The encoder according to the present invention may perform various encoding schemes including video/image encoding schemes according to HEVC(high efficiency video codec).

Referring to FIG. 12, a data decoder 700 may include a picture split unit 705, a prediction unit 710, a subtraction unit 715, a conversion unit 720, a quantization unit 725, a realignment unit 730, an entropy encoding unit 735, a residual processing unit 740, an addition unit 750, a filtering unit 755, and a memory 760. The residual processing unit 740 may include a dequantization unit 741 and an inverse transform unit 742.

The picture split unit 705 may split an input image to at least one processing unit. The unit may include at least one of information related to a specific region and information related to a corresponding region. As the case may be, the unit may be used together with terminology such as block or region. In general case, M×Nblocks may indicate a set of samples comprised of M columns and N rows or transform coefficients.

For example, the processing unit may called a coding unit (CU). In this case, the coding unit may recursively be split from the largest coding unit (LCU) in accordance with a Quad-tree binary-tree (QTBT) structure. For example, one coding unit may be split into a plurality of coding units of a deeper depth based on a quad tree structure and/or binary tree structure. In this case, for example, the quad tree structure may first be applied, and then the binary tree structure may be applied. Alternatively, the binary tree structure may first be applied. The coding process according to the present invention may be performed based on a final coding unit which is not split any more. In this case, the largest coding unit may be used as the final coding unit based on coding efficiency according to image properties, or the coding unit may recursively be split into coding units of a deeper depth if necessary, whereby a coding unit of an optimal size may be used as the final coding unit. In this case, the coding process may include processes such as prediction, transform, and reconstruction, which will be described later.

For another example, the processing unit may include a coding unit (CU), a prediction unit (PU), or a transform unit (TU). The coding unit may be split into coding units of a deeper depth from the largest coding unit (LCU) in accordance with the quad tree structure. In this case, the largest coding unit may be used as the final coding unit based on coding efficiency according to image properties, or the coding unit may recursively be split into coding units of a deeper depth if necessary, whereby a coding unit of an optimal size may be used as the final coding unit. If the smallest coding unit (SCU) is set, the coding unit cannot be split into coding units smaller than the smallest coding unit. In this case, the final coding unit means a basic coding unit partitioned or split into a prediction unit or a transform unit. The prediction unit is a unit partitioned from the coding unit, and may be a unit of sample prediction. At this time, the prediction unit may be split into sub blocks. The transform unit may be split from the coding unit in accordance with the quad tree structure, and may be a unit which derives transform coefficients and/or a unit which derives a residual signal from the transform coefficients. Hereinafter, the coding unit may be called a coding block (CB), the prediction unit may be called a prediction block (PB), and the transform unit may be called a transform block (TB). The prediction block or the prediction unit may mean a specific region in the form of block within a picture, and may include an array of a prediction sample. Also, the transform block or the transform unit may mean a specific region in the form of block within a picture, and may include an array of a residual sample or transform coefficients.

The prediction unit 710 may perform prediction for a processing target block (hereinafter, referred to as a current block), and may generate a predicted block which includes prediction samples for the current block. A unit of prediction performed by the prediction unit 710 may be a coding block, a transform block, or a prediction block.

The prediction unit 710 may determine whether intra-prediction or inter-prediction is applied to the current block. For example, the prediction unit 710 may determine whether intra-prediction or inter-prediction is applied, in a unit of CU.

In case of intra-prediction, the prediction unit 710 may derive a prediction sample for the current block based on a reference sample outside the current block in a picture (hereinafter, referred to as current picture) to which the current block belongs. At this time, the prediction unit 710 may derive the prediction sample based on (i) average or interpolation of neighboring reference samples of the current block and (ii) a reference sample existing a specific (prediction) direction with respect to the prediction sample of the neighboring reference samples of the current block. The case (i) may be called a non-directional mode or non-angular mode, and the case (ii) may be called a directional mode or an angular mode. In intra-prediction, a prediction mode may have, for example, 33 or more directional prediction modes and at least two or more non-directional modes. The non-directional mode may include a DC prediction mode and a planar mode. The prediction unit 710 may determine a prediction mode applied to the current block by using a prediction mode applied to a neighboring block.

In case of inter-prediction, the prediction unit 710 may derive the prediction sample for the current block based on a sample specified by a motion vector on a reference picture. The prediction unit 710 may derive the prediction sample for the current block by applying any one of a skip mode, a merge mode, and a motion vector prediction (MVP) mode.

In case of the skip mode and the merge mode, the prediction unit 710 may use motion information of the neighboring block as motion information of the current block. In case of the skip mode, unlike the merge mode, a difference (residual) between the prediction sample and the original sample is not transmitted. In case of the MVP mode, a motion vector of the current block may be derived using a motion vector of the neighboring block as a motion vector predictor of the current block.

In case of inter-prediction, the neighboring block may include a spatial neighboring block existing in a current picture and a temporal neighboring block existing in a reference picture. The reference picture which includes the temporal neighboring block may called a collocated picture (colPic). Motion information may include a motion vector and a reference picture index. The information such as prediction mode information and motion information may be (entropy) encoded and then output in the form of bitstream.

If motion information of the temporal neighboring block is used in the skip mode and the merge mode, the highest picture on a reference picture list may be used as the reference picture. Reference pictures included in a picture order count (POC) may be aligned based on POC difference between the current picture and the corresponding reference picture. The POC may correspond to a display order of pictures, and may be identified from a coding order.

The subtraction unit 715 generates a residual sample which is a difference between the original sample and the prediction sample. If the skip mode is applied, the subtraction unit 715 may not generate the residual sample as described above.

The transform unit 720 transforms the residual sample in a unit of block and generates transform coefficients. The transform unit 720 may perform transform in accordance with a size of a corresponding transform block and a prediction mode applied to the prediction block or the coding block spatially overlapped with the corresponding transform block. For example, intra-prediction is applied to the prediction block or the coding block overlapped with the transform block, and if the transform block is a 4x4 residual array, the residual sample may be transformed using a Discrete Sine Transform (DST) kernel. In the other case, the residual sample may be transformed using a Discrete Cosine Transform (DCT) kernel.

The quantization unit 725 may quantize transform coefficient and generate the quantized transform coefficients.

The realignment unit 730 realigns the quantized transform coefficients. The realignment unit 730 may realign the quantized transform coefficients of a block type in the form of one-dimensional vector through a scanning method of coefficients. Although the realignment unit 130 has been described as a separate configuration, the realignment unit 130 may be a part of the quantization unit 725.

The entropy encoding unit 735 may perform entropy encoding for the quantized transform coefficients. Entropy encoding may include an encoding method such as exponential Golomb, context-adaptive variable length coding (CAVLC), and context-adaptive binary arithmetic coding (CABAC). The entropy encoding unit 735 may together or separately encode information (for example, value of syntax element, etc.) required for video reconstruction in addition to the quantized transform coefficients. The entropy encoded information may be transmitted or stored in a network abstraction layer (NAL) unit in the form of bitstream.

The dequantization unit 741 dequantizes the values (quantized transform coefficients) quantized by the quantization unit 725, and the inverse transform unit 742 inverse-transforms the values dequantized by the dequantization unit 741 to generate a residual sample.

The addition unit 750 reconstructs a picture by adding the residual sample to the prediction sample. The residual sample and the prediction sample may be added to each other in a unit of block, whereby a reconstruction block may be generated. Although the addition unit 750 has been described as a separate configuration, the addition unit 750 may be a part of the prediction unit 710. The addition unit 750 may be called a reconstruction unit or a reconstruction block generation unit.

The filtering unit 755 may apply a deblocking filtering and/or sample adaptive offset to the reconstructed picture. An artifact at a block boundary within the reconstructed picture or distortion in the quantizing process may be corrected through deblocking filtering and/or sample adaptive offset. The sample adaptive offset may be applied in a unit of sample, and may be applied after a process of deblocking filtering is completed. The filtering unit 755 may apply an Adaptive Loop Filter (ALF) to the reconstructed picture. The ALF may be applied to the reconstructed picture after deblocking filtering and/or sample adaptive offset is applied.

The memory 760 may store information required for reconstructed picture (decoded picture) or encoding/decoding. In this case, the reconstructed picture may be the reconstructed picture for which the filtering process is completed by the filtering unit 755. The reconstructed picture which is stored may be used as a reference picture for (inter-)prediction of another picture. For example, the memory 760 may store (reference) pictures used for inter-prediction. At this time, the pictures used for inter-prediction may be designated by a reference picture set or a reference picture list.

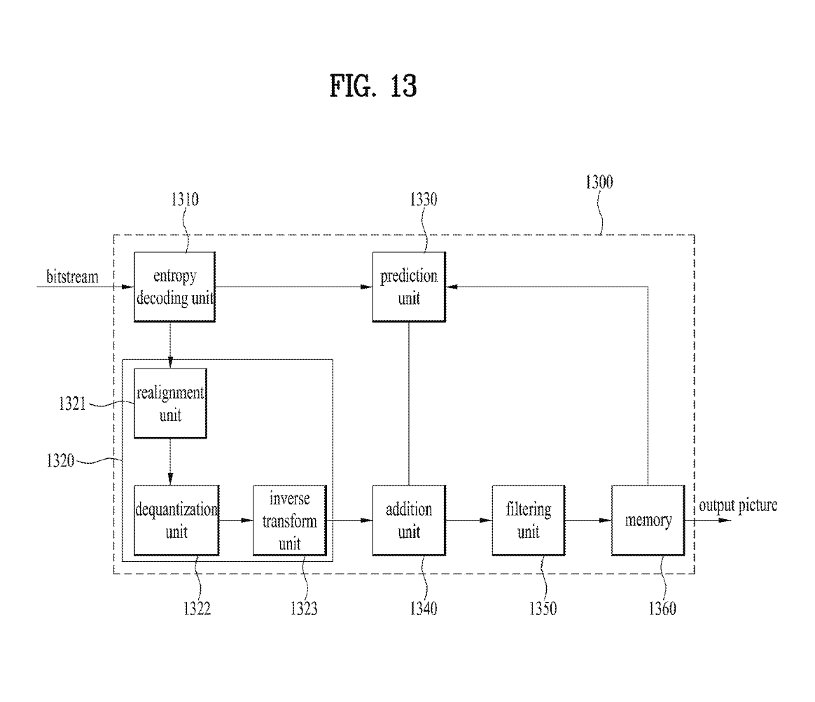

FIG. 13 is a view showing a configuration of a data decoder according to the present invention.

Referring to FIG. 13, a data decoder 800 may include an entropy decoding unit 810, a residual processing unit 820, a prediction unit 830, an addition unit 840, a filtering unit 850, and a memory 860. In this case, the residual processing unit 820 may include a realignment unit 821, a dequantization unit 822, and an inverse transform unit 823.

If a bitstream including video information is input, the video decoder 800 may reconstruct video to correspond to a process, in which video information is processed, from the video encoder.

For example, the video decoder 800 may perform video decoding by using a processing unit applied by the video encoder. Therefore, a processing unit block of video decoding may be a coding unit, for example, and may be a coding unit, a prediction unit, or a transform unit, for another example. The coding unit may be split from the largest coding unit in accordance with a quad tree structure and/or a binary tree structure.

A prediction unit and a transform unit may further be used as the case may be. In this case, a prediction block is a block devised or partitioned from the coding unit, and may be a unit of sample prediction. At this time, the prediction unit may be split into sub blocks. The transform unit may be split from the coding unit in accordance with the quad tree structure, and may be a unit which derives transform coefficients or a unit which derives a residual signal from the transform coefficients.

The entropy decoding unit 810 may output information required for video construction or picture reconstruction by parsing the bitstream. For example, the entropy decoding unit 810 may decode information within the bitstream based on a coding method such as exponential Golomb coding, CAVLC, or CABAC, and may output a value of a syntax element required for video reconstruction and quantized values of the transform coefficients related to residual.

In more detail, CABAC entropy decoding method may receive a bin corresponding to each syntax element from the bitstream, determine a context model by using decoding target syntax element information and decoding information of neighboring and decoding target blocks or information of symbol/bin decoded at a prior step, and perform arithmetic decoding of the bin by predicting the probability of occurrence for the bin in accordance with the determined context model, thereby generating a symbol corresponding to a value of each syntax element. At this time, the CABAC entropy decoding method may update the context model by using information of symbol/bin decoded for a context model of next symbol/bin after determining the context model.

Information on prediction of the information decoded by the entropy decoding unit 810 may be provided to the prediction unit 830, and the residual value for which entropy decoding is performed by the entropy decoding unit 810, that is, the quantized transform coefficients may be input to the realignment unit 821.

The realignment unit 821 may realign the quantized transform coefficients in the form of two-dimensional block. The realignment unit 821 may perform realignment to correspond to coefficient scanning performed by the encoding unit. Although the realignment unit 821 has been described as a separate configuration, the realignment unit 821 may be a part of the dequnatization unit 822.

The dequantization unit 822 may output transform coefficients by dequantizing the quantized transform coefficients based on (de)quantization parameters. At this time, information for deriving the quantization parameters may be signaled from the encoding unit.

The dequantization unit 823 may derive residual samples by inverse transforming the transform coefficients.

The prediction unit 830 may perform prediction for a current block, and may generate a predicted block which includes prediction samples for the current block. A unit of prediction performed by the prediction unit 830 may be a coding block, a transform block or a prediction block.

The prediction unit 830 may determine whether intra-prediction or inter-prediction is applied to the current block, based on information on the prediction. In this case, a unit for determining which one of intra-prediction and inter-prediction may be different from a unit for generating prediction samples. Also, units for generating prediction samples may be different from each other in inter-prediction and intra-prediction. For example, the prediction unit 830 may determine whether intra-prediction or inter-prediction is applied, in a unit of CU. Also, for example, in inter-prediction, the prediction unit 830 may determine a prediction mode and generate a prediction sample in a unit of PU. In intra-prediction, the prediction unit 830 may determine a prediction mode in a unit of PU and generate a prediction sample in a unit of TU.

In case of intra-prediction, the prediction unit 830 may derive a prediction sample for the current block based on neighboring reference samples inside a current picture. The prediction unit 830 may derive the prediction sample for the current block by applying a directional mode or a non-directional mode based on the neighboring reference samples of the current block. At this time, a prediction mode to be applied to the current block may be determined using an intra-prediction mode of a neighboring block.

In case of inter-prediction, the prediction unit 830 may derive the prediction sample for the current block based on a sample specified by a motion vector on a reference picture. The prediction unit 830 may derive the prediction sample for the current block by applying any one of a skip mode, a merge mode, and an MVP mode. At this time, motion information required for inter-prediction of the current block provided by the video encoder, for example, information on a motion vector, reference picture index, etc. may be acquired or derived based on the information on the prediction.

In case of the skip mode and the merge mode, the motion information of the neighboring block may be used as the motion information of the current block. At this time, the neighboring block may include a spatial neighboring block and a temporal neighboring block.

The prediction unit 830 may configure a merge candidate list as motion information of an available neighboring block, and may use information indicated by a merge index on the merge candidate list as a motion vector of the current block. The merge index may be signaled from the encoding unit. The motion information may include the motion vector and the reference picture. If motion information of the temporal neighboring block is used in the skip mode and the merge mode, the highest picture on a reference picture list may be used as the reference picture.

In case of the skip mode, unlike the merge mode, a difference (residual) between the prediction sample and the original sample is not transmitted.

In case of the MVP mode, the motion vector of the current block may be derived using a motion vector of the neighboring block as a motion vector predictor. At this time, the neighboring block may include a spatial neighboring block and a temporal neighboring block.

For example, if the merge mode is applied, a merge candidate list may be generated using a motion vector of a reconstructed spatial neighboring block and/or a motion vector corresponding to Col block which is a temporal neighboring block. In the merge mode, a motion vector of a candidate block selected from the merge candidate list is used as the motion vector of the current block. The information on the prediction may include a merge index indicating a candidate block having an optimal motion vector selected from the candidate blocks included in the merge candidate list. At this time, the prediction unit 830 may devise the motion vector of the current block by using the merge index.

For another example, if the MVP (Motion Vector Prediction) mode is applied, a motion vector predictor candidate list may be generated using the motion vector of the reconstructed spatial neighboring block and/or the motion vector corresponding to Col block which is the temporal neighboring block. That is, the motion vector of the reconstructed spatial neighboring block and/or the motion vector corresponding to Col block which is the temporal neighboring block may be used as a motion vector candidate. The information on the prediction may include a prediction motion vector index indicating an optimal motion vector selected from the motion vector candidate included in the above list. At this time, the prediction unit 830 may select a prediction motion vector of the current block from motion vector candidates included in a motion vector candidate list by using the motion vector index. A prediction unit of the encoding unit may obtain a motion vector difference (MVD) between the motion vector of the current block and the motion vector predictor, encode the MVD and output the encoded result in the form of bitstream. That is, the MVD may be obtained from a value obtained by subtracting the motion vector predictor from the motion vector of the current block. At this time, the prediction unit 830 may acquire the motion vector difference included in the information on the prediction and devise the motion vector of the current block through addition of the motion vector difference and the motion vector predictor. The prediction unit may also acquire or derive a reference picture index indicating a reference picture from the information on the prediction.

The addition unit 840 may reconstruct the current block or the current picture by adding the residual sample to the prediction sample. The addition unit 840 may reconstruct the current picture by adding the residual sample to the prediction sample. Since the residual is not transmitted if the skip mode is applied, the prediction sample may be the reconstructed sample. Although the addition unit 840 has been described as a separate configuration, the addition unit 840 may be a part of the prediction unit 830. The addition unit 840 may be called a reconstruction unit or a reconstruction block generation unit.

The filtering unit 850 may apply a deblocking filtering, sample adaptive offset and/or ALF to the reconstructed picture. At this time, the sample adaptive offset may be applied in a unit of sample, and may be applied after deblocking filtering. The ALF may be applied to the reconstructed picture after deblocking filtering and/or sample adaptive offset.

The memory 860 may store information required for the reconstructed picture (decoded picture) or decoding. In this case, the reconstructed picture may be the reconstructed picture for which the filtering process is completed by the filtering unit 850. For example, the memory 860 may store pictures used for inter-prediction. At this time, the pictures used for inter-prediction may be designated by a reference picture set or a reference picture list. The reconstructed picture may be used as a reference picture for another picture. Also, the memory 860 may output the reconstructed picture in accordance with an output order.

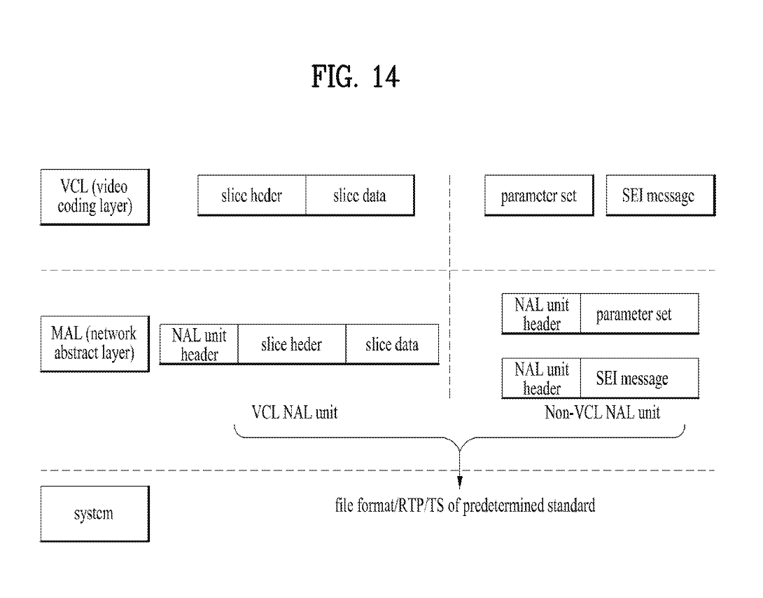

FIG. 14 illustrates a hierarchical structure of coded data.

Referring to FIG. 14, coded data may be categorized into a video coding layer (VCL) which processes and handles coding of video/image and a network abstraction layer (NAL) existing between lower systems which store and transmit data of the coded video/image.

An NAL unit which is a basic unit of the NAL serves to map the coded image into bitstreams of the lower system such as a file format according to a predetermined standard, a Real-time Transport Protocol (RTP), and Transport Stream (TS).

In a coding process of video/image and a parameter set (picture parameter set, sequence parameter set, video parameter set, etc.) corresponding to a header of a sequence and a picture, a Supplemental enhancement information (SEI) message additionally required for a procedure related to a display is separated from information (slice data) on video/image in the VCL. The VCL which includes the information on video/image includes slice data and a slice header.

As shown, the NAL unit includes two parts of an NAL unit header and a Raw Byte Sequence Payload (RBSP) generated from the VCL. The NAL unit header includes information on a type of the corresponding NAL unit.

The NAL unit is categorized into a VCL NAL unit and a non-VCL NAL unit in accordance with the RBSP generated from the VCL. The VCL NAL unit means an NAL unit which includes information on video/image, and the non-VCL NAL unit indicates an NAL unit which includes information (parameter set or SEI message) required for coding of video/image. The VCL NAL unit may be categorized into several types in accordance with features and types of the picture included in the corresponding NAL unit.

The present invention may be related to a 360-degree video transmission method and a 360-degree video reception method. The 360-degree video transmission/reception method may be performed by a 360-degree video transmission/reception apparatus or embodiments of the apparatus.

The embodiment of each of the 360-degree video transmission/reception apparatus and the 360-degree video transmission/reception method according to the present invention may be combined with embodiments of inner/outer elements thereof. For example, embodiments of the projection processor may be combined with embodiments of the data encoder, whereby embodiments of the 360-degree video transmission apparatus may be obtained as much as the number of corresponding cases. The embodiments combined as above are included in the scope of the present invention.

According to the present invention, region based independent processing may be supported for user view point dependent efficient processing. To this end, a specific region of image may be extracted and/or processed to configure an independent bitstream, and a file format for extracting and/or processing the specific region may be configured. In this case, original coordinate information of the extracted region may be signaled to support efficient image region decoding and rendering in the receiver. Hereinafter, a region where independent processing of an input image may be called a subpicture. The input image may be split into subpicture sequences prior to encoding, and each subpicture sequence may cover a subset of a spatial region of 360-degree video contents. Each subpicture sequence may be encoded independently and output as a single-layer bitstream. Each subpicture bitstream may be encapsulated in a file based on an individual track, or may be subjected to streaming In this case, the reception apparatus may decode or render tracks which cover a full region, or may select a track related to a specific subpicture based on metadata related to orientation and viewport and decode and render the selected track.

FIG. 15 illustrates a motion constraint tile set (MCTS) extraction and delivery process which is an example of region based independent processing.

Referring to FIG. 15, the transmission apparatus encodes an input image. In this case, the input image may correspond to the projected picture or the packed picture.

For example, the transmission apparatus may encode the input image in accordance with a general HEVC encoding procedure (1-1). In this case, the input image may be encoded and output as one HEVC bitstream (HEVC bs) (1-1-a).

For another example, region based independent encoding (HEVC MCTS encoding) may be performed for the input image (1-2). As a result, MCTS streams for a plurality of regions may be output (1-2-b). Alternatively, a partial region may be extracted from the MCTS streams and output as one HEVC bitstream (1-2-a). In this case, intact information for decoding and reconstruction of the partial region is included in the bitstream. Therefore, the receiver may fully reconstruct the partial region based on one bitstream for the partial region.

The transmission apparatus may encapsulate encoded HEVC bitstream according to (1-1-a) or (1-2-a) in one track inside a file for storage and transmission (2-1), and may deliver the bitstream to the reception apparatus (2-1-a). In this case, the corresponding track may be indicated as an identifier such as hvcX and hevX.

On the other hand, the transmission apparatus may encapsulate encoded MCTS stream according to (1-2-b) in a file for storage and transmission (2-2). For example, the transmission apparatus may encapsulate MCTSs for independent processing in an individual track and deliver the encapsulated MCTSs (2-2-b). At this time, a base track for processing of entire MCTS streams or some MCTS regions may be extracted, whereby information such as an extractor track for processing may be included in the file. In this case, the individual track may be indicated as an identifier such as hvcX and hevX. For another example, the transmission apparatus may encapsulate a file which includes a track for one MCTS region by using the extractor track and deliver the encapsulated file (2-2-a). That is, the transmission apparatus may extract only a track corresponding to one MCTS and deliver the extracted track. In this case, the corresponding track may be indicated as an identifier such as hvt1.

The reception apparatus may perform a decapsulation procedure for the file according to (2-1-a) or (2-2-a) by receiving the corresponding file (4-1), and may devise HEVC bitstream (4-1-a). In this case, the reception apparatus may devise one bitstream by decapsulating one track within the received file.

On the other hand, the reception apparatus may perform a decapsulation procedure for the file according to (2-2-b) by receiving the corresponding file (4-2), and may devise MCTS stream or one HEVC bitstream. For example, if tracks of MCTSs corresponding to all regions and a base track are included in the file, the reception apparatus may extract full MCTS streams (4-2-b). For another example, if the extractor track is included in the file, the reception apparatus may generate one (HEVC) bitstream by extracting and decapsulating the corresponding MCTS track (4-2-a).

The reception apparatus may generate an output mage by decoding one bitstream according to (4-1-a) or (4-2-a) (5-1). In this case, if one bitstream according to (4-2-a) is decoded, the corresponding bitstream may be an output image for some MCTS regions of the output image. Alternatively, the reception apparatus may generate an output image by decoding the MCTS stream according to (4-2-b) (5-2).

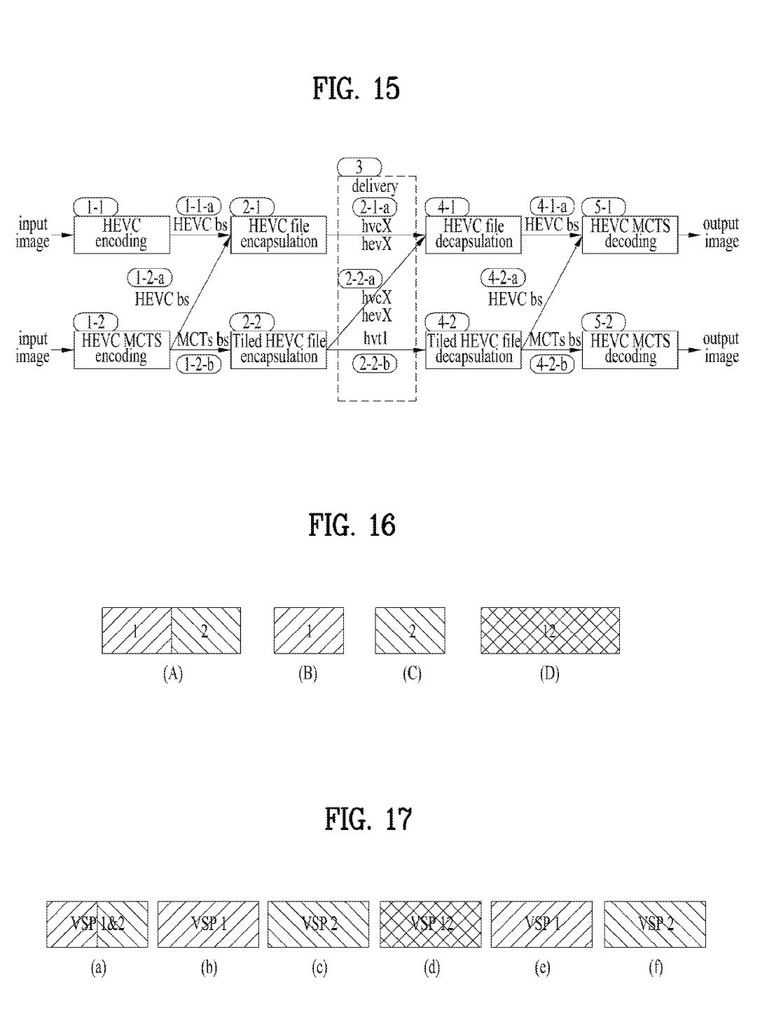

FIG. 16 illustrates an example of an image frame for supporting region based independent processing. As described above, the region for supporting independent processing may be called a subpicture.

Referring to FIG. 16, one input image may include two left and right MCTS regions. A shape of an image frame encoded/decoded through the procedures 1-2 to 5-2 described with reference to FIG. 15 may be the same as (A) to (D) of FIG. 16, or may correspond to a part of (A) to (D) of FIG. 16.

In FIG. 16, (A) indicates an image frame having regions 1 and 2, for which individual region independent/parallel processing can be performed. (B) indicates an independent image frame, in which only a region 1 exist, having half horizontal resolution. (C) indicates an independent image frame, in which only a region 2 exists, having half horizontal resolution. (D) indicates an image frame in which regions 1 and 2 exist and for which processing can be performed without support of individual region independent/parallel processing.

The bitstreams of 1-2-b and 4-2-b for devising the image frame as above may be configured as follows, or may correspond to a portion of the followings.

FIG. 17 illustrates an example of a bitstream configuration for supporting region based independent processing.

Referring to FIG. 17, VSP indicates VPS, SPS, and PPS, VSP1 indicates VSP for the region 1, VSP2 indicates VSP for the region 2, and VSP12 indicates VSP for the regions 1 and 2. Also, VCL1 indicates VCL for the region 1, and VCL2 indicates VCL for the region 2.

In FIG. 17, (a) indicates Non-VCL NAL units (for example, VPS NAL unit, SPS NAL unit, PPS NAL unit, etc.) for image frames for which independent/parallel processing of the regions 1 and 2 can be performed. (b) indicates Non-VCL NAL units (for example, VPS NAL unit, SPS NAL unit, PPS NAL unit, etc.) for image frames, in which only the region 1 exists, having half resolution. (c) indicates Non-VCL NAL units (for example, VPS NAL unit, SPS NAL unit, PPS NAL unit, etc.) for image frames, in which only the region 2 exist, having half resolution. (d) indicates Non-VCL NAL units (for example, VPS NAL unit, SPS NAL unit, PPS NAL unit, etc.) for image frames in which the regions 1 and 2 exist and for which processing can be performed without support of individual region independent/parallel processing. (e) indicates VCL NAL units of the region 1. (f) indicates VCL NAL units of the region 2.

For example, a bitstream which includes the NAL units of (a), (e) and (f) may be generated for generation of the image frame (A). A bitstream which includes the NAL units of (b) and (e) may be generated for generation of the image frame (B). A bitstream which includes the NAL units of (c) and (f) may be generated for generation of the image frame (C). A bitstream which includes the NAL units of (d), (e) and (f) may be generated for generation of the image frame (D). In this case, information (for example, mcts_sub_bitstream_region_in_original_picture_coordinate=mfo( ) etc. which will be described later) indicating a position of a specific region on a picture may be delivered by being included in the bitstream for the image frames such as (B), (C), and (D). In this case, the inforamtion may enable identification of position information in the original frame of the selected region.

If the selected region is not located at a left top end which is a reference of the original image frame in the same manner as the case that the region 2 is only selected (the bitstream includes the NAL units of (c) and (f), a process of correcting a slice segment address of the slice segment header in the procedure of extracting a bitstream may be accompanied.

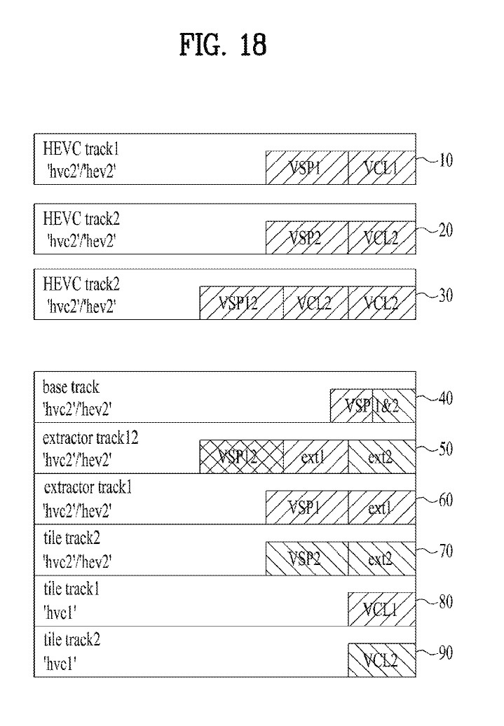

FIG. 18 illustrates a track configuration of a file according to the present invention. If a specific region is selectively encapsulated or coded as described in the aforementioned 2-2-a or 4-2-a in FIG. 15, a related file may be configured as follows or may include some of the following cases.

Referring to FIG. 18, if a specific region is selectively encapsulated or coded as described in the aforementioned 2-2-a or 4-2-a in FIG. 15, a related file may include the following cases, or may include some of the following cases:

(1) the case that one track 10 includes the NAL units of (b) and (e);

(2) the case that one track 20 includes the NAL units of (c) and (f); and

(3) the case that one track 30 includes the NAL units of (d), (e) and (f).

Also, the related file may include all of the following tracks, or may include combination of some tracks:

(4) a base track 40 which includes (a);

(5) an extractor track 50 which includes (d), having an extractor (ex. extl, ext2) for accessing (e) and (f);

(6) an extractor track 60 which includes (b), having an extractor for accessing (e);

(7) an extractor track 70 which includes (c), having an extractor for accessing (f);

(8) a tile track 80 which includes (e); and

(9) a tile track 90 which includes (f).

In this case, information indicating a position of a specific region on a picture may enable identification of position information in an original frame of a region selected by being included in the aforementioned tracks 10, 20, 30, 50, 60, 70 in the form of box RegionOriginalCoordninateBox which will be described later. In this case, the region may be called a subpicture as described above. A service provider may include all of the aforementioned tracks, and may deliver only some of the tracks in selective combination during transmission.

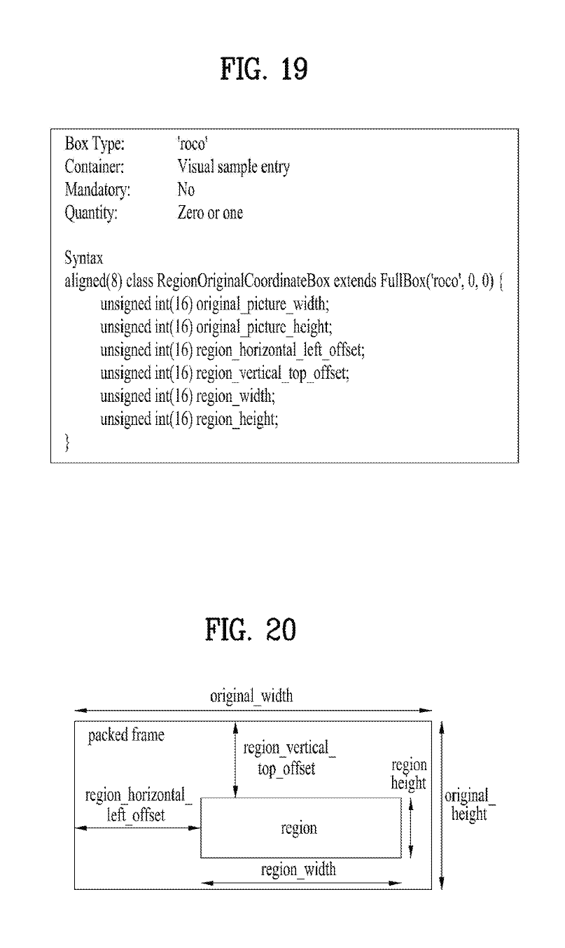

FIG. 19 illustrates RegionOriginalCoordninateBox according to one embodiment of the present invention. FIG. 20 exemplarily illustrates a region indicated by corresponding information within an original picture.

Referring to FIG. 19, RegionOriginalCoordninateBox is information indicating a size and/or position of a region (subpicture or MCTS) where region based independent processing according to the present invention can be performed. In detail, RegionOriginalCoordninateBox may be used to identify a coordinate position of all visual contents, on which a corresponding region exists, when one visual content is split into one or more regions and then stored/transmitted. For example, a packed frame (packed picture) or a projected frame (projected picture) for a full 360-degree video may be stored in/transmitted to several individual regions for user view point based efficient processing in the form of independent video stream, and one track may correspond to a rectangular region comprised of one or several tiles. The individual region may correspond to HEVC bitstreams extracted from HEVC MCTS bitstreams. RegionOriginalCoordninateBox may exist under a visual sample entry of a track, in/to which the individual region is stored/transmitted, to describe coordinate information of the corresponding region. RegionOriginalCoordninateBox may exist under another box such as a scheme information box in addition to the visual sample entry.

Syntax of RegionOriginalCoordninateBox may include an original_picture_width field, an original_picture_height field, a region_horizontal_left_offset field, a region_vertical_top_offset field, a region_width field, and a region_height field. Some of the fields may be omitted. For example, if a size of the original picture is previously defined or already acquired through information of another box, etc., the original_picture_width field, the original_picture_height field, etc. may be omitted.

The original_picture_width field indicates horizontal resolution (width) of the original picture (that is, packed frame or projected frame) to which the corresponding region (subpicture or tile) belongs. The original_picture_height field indicates vertical resolution (height) of the original picture (that is, packed frame or projected frame) to which the corresponding region (subpicture or tile) belongs. The region_horizontal_left_offset field indicates a horizontal coordinate of a left end of the corresponding region based on a coordinate of the original picture. For example, the above field may indicate a value of the horizontal coordinate of the corresponding region based on a coordinate of a left top end of the original picture. The region_vertical_top_offset field indicates a vertical coordinate of a left end of the corresponding region based on the coordinate of the original picture. For example, the above field may indicate a value of a vertical coordinate of an upper end of the corresponding region based on the coordinate of the left top end of the original picture. The region_width field indicates horizontal resolution (width) of the corresponding region. The region_height field indicates vertical resolution (height) of the corresponding region. The corresponding region may be devised from the original picture based on the aforementioned fields as shown in FIG. 20.

Meanwhile, according to one embodiment of the present invention, RegionToTrackBox may be used.

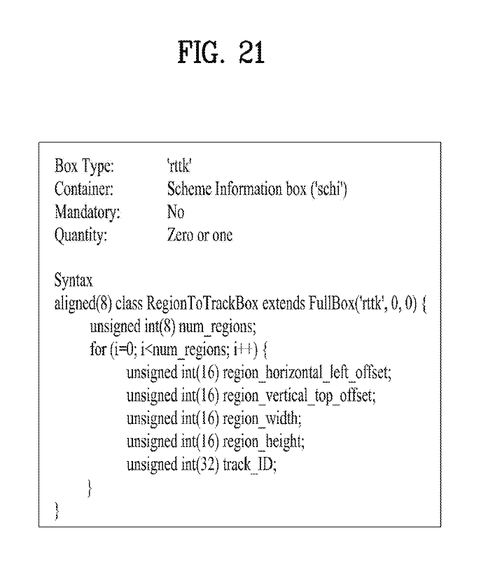

FIG. 21 illustrates RegionToTrackBox according to one embodiment of the present invention.

The RegionToTrackBox may enable identification of a track associated with the corresponding region. The box (box type information) may be transmitted from each track, or may be transmitted from a main track. The RegionToTrackBox may be stored under box ‘schi’ together with 360-degree video information such as projection information and packing information. In this case, horizontal resolution and vertical resolution of the original picture may be identified as a width value (of the original picture) existing in the track header box or the visual sample entry. Also, a reference relation between a track for carrying the above box and a track in/to which the individual region is stored/transmitted may be identified by a new reference type such as ‘ovrf’ (omnidirectional video reference) in a track reference box.

The above box may hierarchically exist under another box such as the visual sample entry in addition to the scheme information box.

Syntax of the RegionToTrackBox may include a num_regions field, and may include a region_horizontal_left_offset field, a region_vertical_top_offset field, a region_width field, a region_width field and a track_ID field with respect to each region. Some of the fields may be omitted as the case may be.

The num_region field indicates the number of regions within the original picture. The region_horizontal_left_offset field indicates a horizontal coordinate of a left end of the corresponding region based on the coordinate of the original picture. For example, the above field may indicate a value of a horizontal coordinate of a left end of the corresponding region based on the coordinate of the left top end of the original picture. The region_vertical_top_offset field indicates a vertical coordinate of the left end of the corresponding region based on the coordinate of the original picture. For example, the above field may indicate a value of a vertical coordinate of a top end of the corresponding region based on the coordinate of the left top end of the original picture. The region_width field indicates vertical resolution (width) of the corresponding region. The region_height field indicates vertical resolution (height) of the corresponding region. The Track_ID field indicates ID of a track in/to which data corresponding to the corresponding region are stored/transmitted.

According to one embodiment of the present invention, the following information may be included in the SEI message.

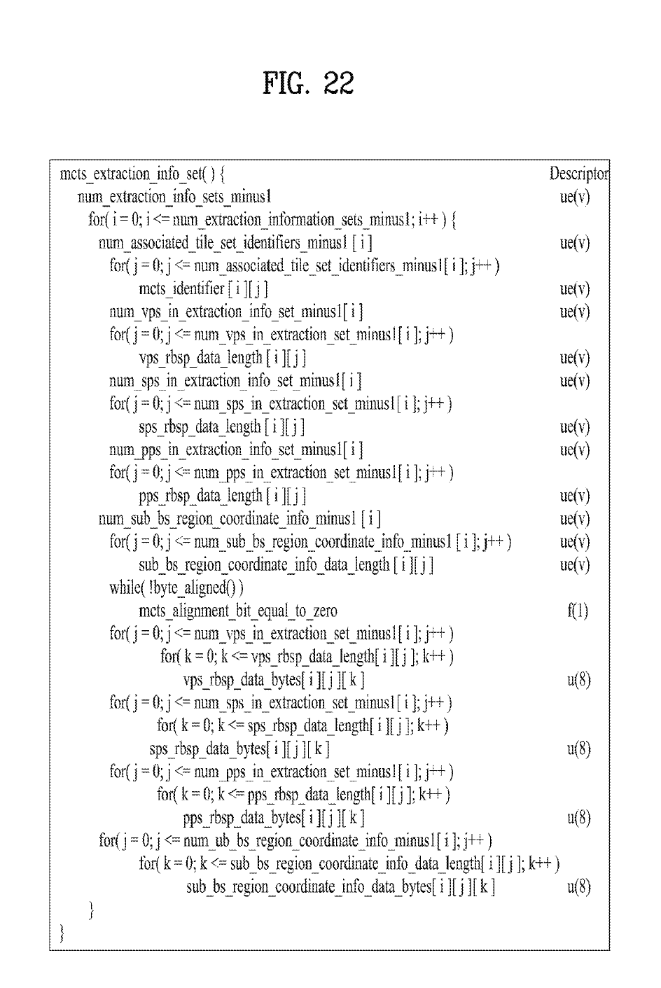

FIG. 22 illustrates SEI message according to one embodiment of the present invention.

Referring to FIG. 22, a num_sub_bs_region_coordinate_info_minus1[i] field indicates a value of the number of mcts_sub_bitstream_region_in_original_picture_coordinate_info corresponding to extraction information—1. A sub_bs_region_coordinate_info_data_length[i ][j] field indicates the number of bytes of individual mcts_sub_bitstream_region_in_original_picture_coordinate_info. The num_sub_bs_region_coordinate_info_minus1[i] field and the sub_bs_region_coordinate_info_data_length[i][j] field may be coded based on ue(v) indicating unsigned integer 0-th Exp-Golomb coding. In this case, (v) may indicate that bits used for coding of corresponding information are variable. A sub_bs_region_coordinate_info_data_bytes[i][j][k] field indicates bytes of individual mcts_sub_bitstream_region_in_original_picture_coordinate_info. The sub_bs_region_coordinate_info_data_bytes[i][j][k] field may be coded based on u(8) indicating unsigned integer 0-th Exp-Golomb coding which uses 8 bits.

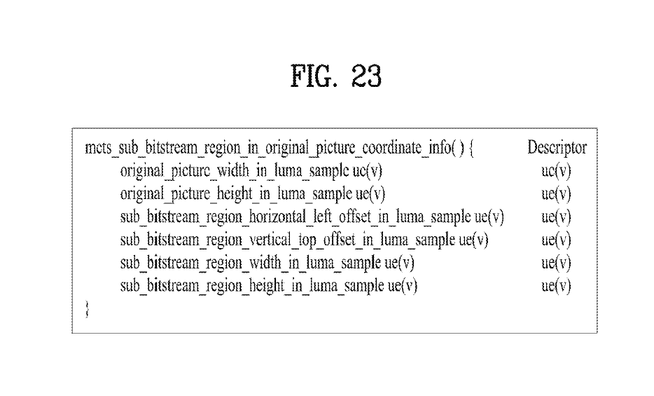

FIG. 23 illustrates mcts_sub_bitstream_region_in_original_picture_coordinate_info according to one embodiment of the present invention. The mcts_sub_bitstream_region_in_original_picture_coordinate_info may hierarchically be included in the SEI message.

Referring to FIG. 23, an original_picture_width_in_luma_sample field indicates horizontal resolution of the original picture (that is, packed frame or projected frame) prior to extraction of an extracted MCTS sub-bitstream region. An original_picture_height_in_luma_sample field indicates vertical resolution of the original picture (that is, packed frame or projected frame) prior to extraction of an extracted MCTS sub-bitstream region. A sub_bitstream_region_horizontal_left_offset_in_luma_sample field indicates a horizontal coordinate at a left end of the corresponding region based on the coordinate of the original picture. A sub_bitstream_region_vertical_top_offset_in_luma_sample field indicates a vertical coordinate of a top end of the corresponding region based on the coordinate of the original picture. A sub_bitstream_region_width_in_luma_sample field indicates horizontal resolution of the corresponding region. A sub_bitstream_region_height_in_luma_sample field indicates vertical resolution of the corresponding region.

Meanwhile, when all MCTS bitstreams exist in one file, the following information may be used for data extraction for a specific MCTS region.

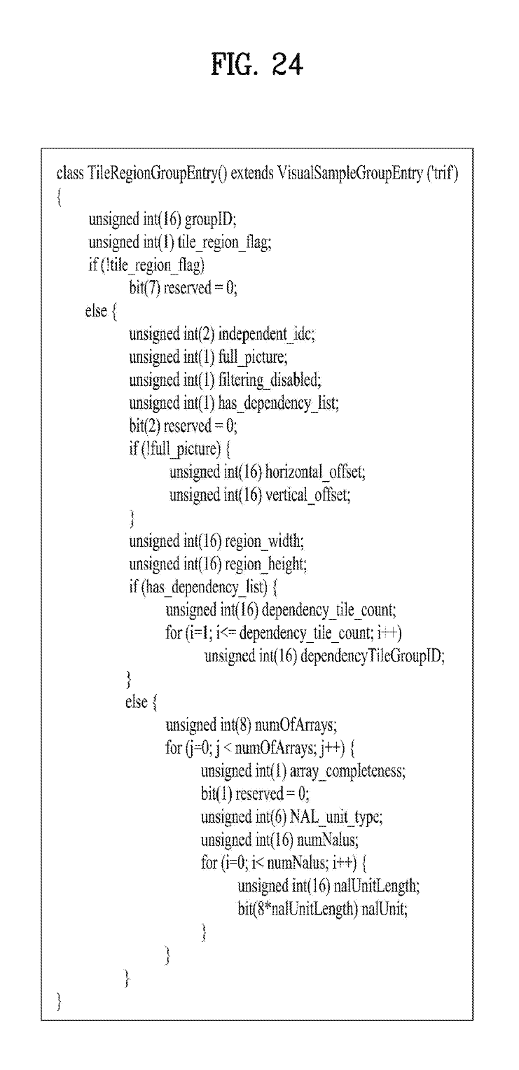

FIG. 24 illustrates MCTS region related information within a file which includes a plurality of MCTS bitstreams according to one embodiment of the present invention.

Referring to FIG. 24, extracted MCTS bitstreams may be defined as one group through sample grouping, and VPS, SPS, PPS, etc., which are associated with the corresponding MCTS described as above, may be included in a nalUnit field of FIG. 24. The NAL_unit_type field may indicate one of the VPS, the SPS, and the PPS as a type of the corresponding NAL unit, and the NAL unit(s) of the indicated type may be included in the nalUnit field.

In the present invention, the region where the aforementioned independent processing is supported, the MCTS region, etc. may be used to refer to the same thing, and may be called the subpicture as described above. 360-degree video in a full direction may be stored and delivered through a file which includes subpicture tracks, and may be used for user view point or viewport dependent processing. The subpictures may generally be stored in a separate track.

Viewport dependent processing may be performed based on the following flow.

FIG. 25 illustrates viewport dependent processing according to one embodiment of the present invention.

Referring to FIG. 25, the reception apparatus performs head and/or eye tracking (S2010). The reception apparatus devises viewport information through head and/or eye tracking.

The reception apparatus performs file/segment decapsulation for a file which is delivered (S2020). In this case the reception apparatus may identify regions (viewport regions) corresponding to a current viewport through coordinate conversion (S2021), and may select and extract tracks containing subpictures which cover the viewport regions (S2022).

The reception apparatus decodes (sub)bitstream(s) for the selected track(s) (S2030). The reception apparatus may decode/reconstruct subpictures through the decoding. In this case, unlike the existing decoding procedure of performing decoding in a unit of the original picture, the reception apparatus may decode only the subpictures not the entire original picture.

The reception apparatus maps the decoded subpicture(s) into a rendering space through coordinate conversion (S2040). Since decoding is performed for subpicture(s) not the entire picture, the reception apparatus may map the subpicture(s) into the rendering space based on information indicating a position of the original picture to which the corresponding subpicture corresponds, and may perform viewport dependent processing. The reception apparatus may generate image (viewport image) associated with the corresponding viewport and display the generated image for a user (S2050).

The coordinate conversion procedure for the subpictures may be required for a rendering procedure as described above. This is a procedure which is not required for the related art 360-degree video processing procedure. According to the present invention, since decoding is performed for the subpicture(s) not the entire picture, the reception apparatus may map the corresponding subpicture into the rendering space based on information indicating a position of the original picture to which the corresponding subpicture corresponds, and may perform viewport dependent processing.

That is, after subpicture unit decoding, alignment of the decoded picture may be required for proper rendering. The packed frame may be realigned to the projected frame (if it is applied to the region-wise packing procedure), the projected frame may be aligned in accordance with a projection structure. Therefore, if 2D coordinate on the packed frame/projected frame is displayed from signaling of coverage information of the tracks for carrying the subpictures, the decoded subpicture may be aligned into the packed frame/projected frame prior to rendering. In this case, coverage information may include information indicating a position (position and size) of the region according to the present invention.

According to the present invention, even one subpicture may be configured such that regions are spatially spaced apart from each other on the packed frame/projected frame. In this case, the regions spaced apart from each other on the 2D space within one subpicture may be called subpicture regions. For example, if an Equirectangular Projection (ERP) format is used as a projection format, a left end and a right end of the packed frame/projected frame may adjoin each other on a spherical surface which is actually rendered. To cover this, the subpicture regions spatially spaced apart from each other on the packed frame/projected frame may be configured as one subpicture, and the subpicture may be configured as follows.

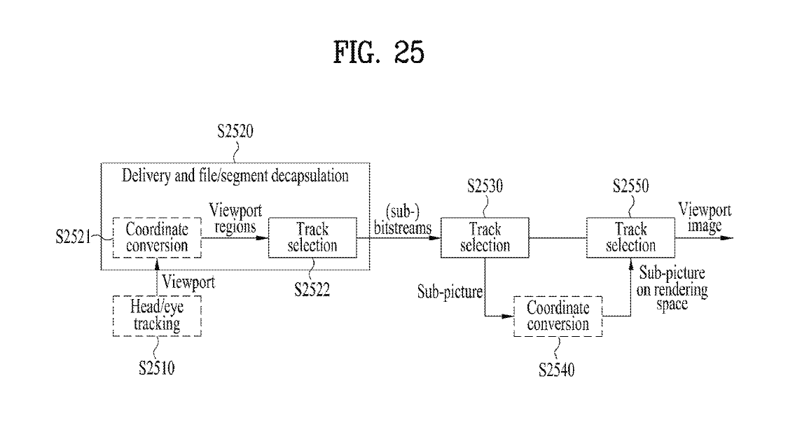

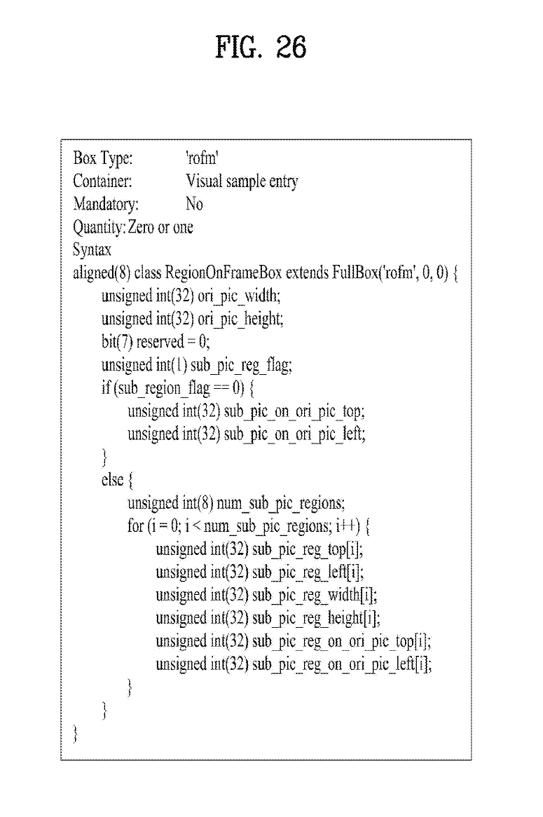

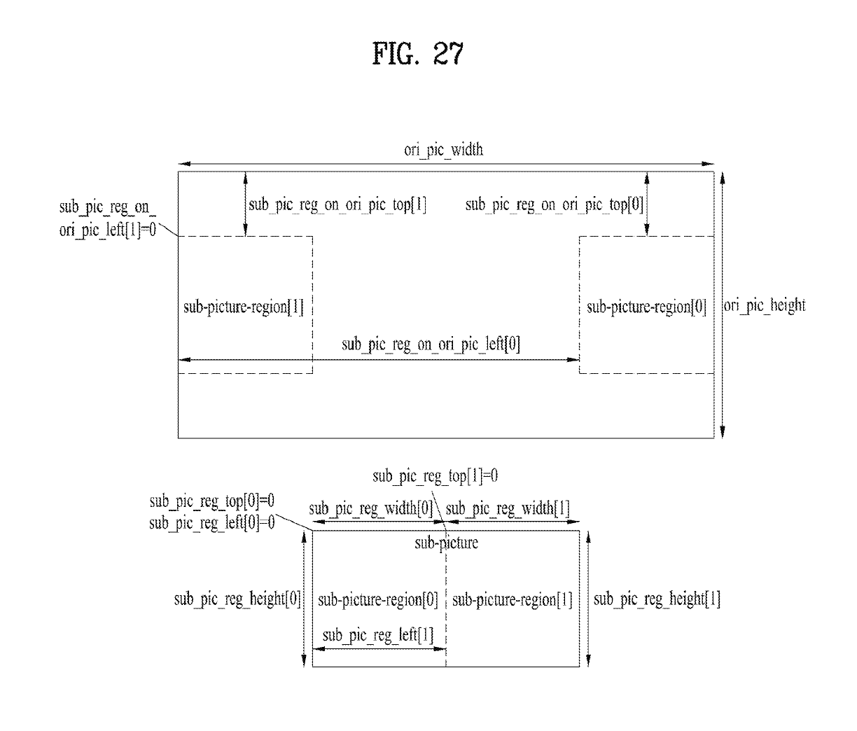

FIG. 26 illustrates coverage information according to one embodiment of the present invention. FIG. 27 illustrates subpicture composition according to one embodiment of the present invention. The subpicture composition of FIG. 27 may be devised based on the coverage information shown in FIG. 26.

Referring to FIG. 26, an ori_pic_width field and an ori_pic_height field respectively indicate a width and a height of the entire original picture constituting subpictures. The width and the height of the subpicture may be represented by a width and a height within the visual sample entry. A sub_pic_reg_flag field indicates the presence of subpicture regions. If a value of the sub_pic_reg_flag field is 0, it indicates that the subpictures are wholly aligned on the original picture. If the value of the sub_pic_reg_flag field is 1, the subpicture is split into subpicture regions, each of which is aligned on frame (original picture). As shown in FIG. 26, the subpicture regions may be aligned across a frame boundary. A sub_pic_on_ori_pic_top field and a sub_pic_on_ori_pic_left field respectively indicate a top sample row and a left-most sample column of the subpicture on the original picture. A range of values of the sub_pic_on_ori_pic_top field and the sub_pic_on_ori_pic_left field may be from 0 (inclusive) indicating a top-left corner of the original picture to the values (exclusive) of the ori_pic_height field and the ori_pic_width field. A num_sub_pic_regions field indicates the number of subpicture regions constituting subpictures. A sub_pic_reg_top[i] field and a sub_pic_reg_left[i] field respectively indicate a top sample row and the left-most sample column. A correlation (position order and arrangement) between a plurality of subpicture regions in one subpicture may be devised through these fields. A range of values of the sub_pic_reg_top[i] field and the sub_pic_reg_left[i] field may be from 0 (inclusive) indicating a top-left corner of the original picture to the width and the height (exclusive) of the subpicture. The width and the height of the subpicture may be devised from the visual sample entry. A sub_pic_reg_width[i] field and a sub_pic_reg_height[i] field respectively indicate a width and a height of a corresponding (ith) subpicture region. A sum (i is from 0 to −1 which is a value of the num_sub_pic_regions field) of the values of the sub_pic_reg_width[i] field may be equal to the width of the subpicture. Alternatively, a sum (i is from 0 to −1 which is a value of the num_sub_pic_regions field) of values of the sub_pic_reg_height[i] field may be equal to the height of the subpicture. The sub_pic_reg_on_ori_pic_top[i] field and the sub_pic_reg_on_ori_pic_left[i] field respectively indicate a top sample row and a left-most sample column of the corresponding subpicture region on the original picture. A range of values of the sub_pic_reg_on_ori_pic_top[i] field and the sub_pic_reg_on_ori_pic_left[i] field may be from 0 (inclusive) to indicating a top-left corner of the projected frame to values (exclusive) of the ori_pic_height field and the ori_pic_width field.

The case that one subpicture includes a plurality of subpicture regions has been described in the aforementioned example, and according to the present invention, the subpictures may be configured by being overlapped with each other. If it is assumed that each subpicture bitstream is exclusively decoded by one video decoder, the overlapped subpictures may be used to limit the number of video decoders.

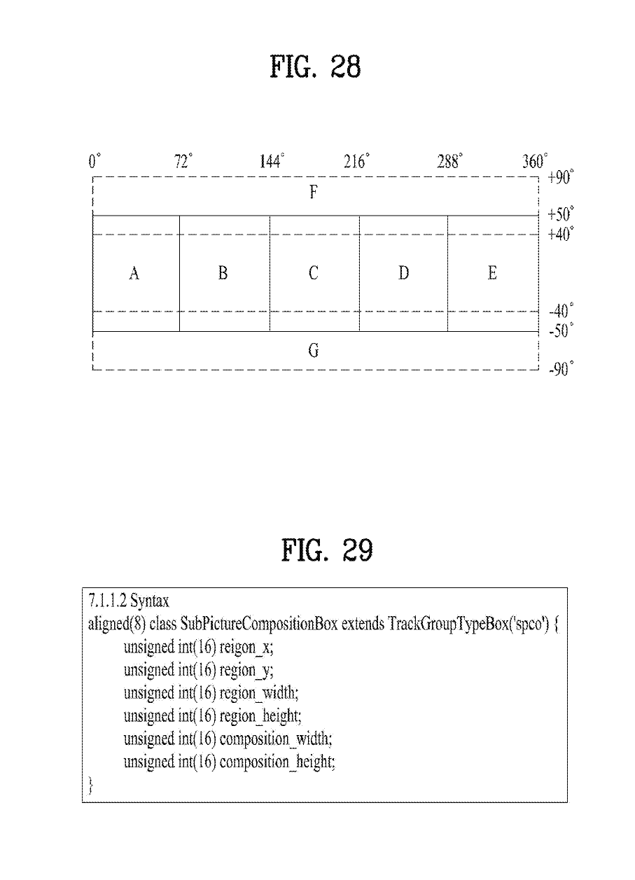

FIG. 28 illustrates overlapped subpictures according to one embodiment of the present invention. In FIG. 28, a source content (for example, original picture) is split into 7 rectangular regions, and these regions are grouped into 7 subpictures.

Referring to FIG. 28, the subpicture 1 includes regions (subpicture regions) A and B, the subpicture 2 includes regions B and C, the subpicture 3 includes regions C and D, the subpicture 4 includes regions D and E, the subpicture 5 includes regions E and A, and the subpicture 6 includes region F, and the subpicture 7 includes region G.

Through the above configuration, the number of video decoders required for decoding of subpicture bitstreams for a current viewport may be reduced, and subpictures may be extracted and decoded efficiently when a viewport is located at a side of a picture of an ERP format.

To support subpicture composition which includes multiple rectangular regions within the aforementioned track, for example, the following conditions may be considered. One SubpictureCompositionBox may describe one rectangular region. TrackGroupBox may have multiple SubpictureCompositionBoxes. The order of the multiple SubpictureCompositionBoxes may indicate a position of the rectangular regions within the subpicture. In this case, the order may be a raster scan order.

TrackGroupTypeBox of which track_group_type is ‘spco’ may indicate that the corresponding track belongs to a composition of tracks, which can spatially be aligned to acquire pictures suitable for presentation. Visual tracks (that is, visual tracks having the same track_group_id value within the TrackGroupTypeBox of which track_group_type is ‘spco’) mapped into corresponding grouping may collectively indicate visual contents which can be presented. Each individual visual track mapped into corresponding grouping may be sufficient for presentation or not. If a track carries a subpicture sequence mapped into multiple rectangular regions on the composed picture, multiple TrackGroupTypeBoxes of which track_group_type is ‘spco’, having the same track_group_id may exist. The above boxes may be represented in accordance with the raster scan order of the rectangular regions on the subpicture within the TrackGroupBox. In this case, CompositionRestrictionBox may be used to indicate that a visual track is not alone sufficient for presentation. The picture suitable for presentation may be configured by spatially aligning time-parallel samples of all tracks of the same subpicture composition track group as indicated by syntax elements of a track group.

FIG. 29 illustrates a syntax of SubpictureCompositionBox.

Referring to FIG. 29, a region_x field indicates a horizontal position of a top-left corner of a rectangular region of samples of a corresponding track on a composed picture in luma sample units. A range of a value of the region_x field may be from 0 to a value of a composition_width field −1(minus 1). A region_y field indicates a vertical position of a top-left corner of a rectangular region of samples of a corresponding track on a composed picture in luma sample units. A range of a value of the region_y field may be from 0 to a value of a composition_height field −1. A region_width field indicates a width of the rectangular region of the samples of the corresponding track on the composed picture in luma sample units. A range of a value of the region_width field may be from 1 to a value of the composition_width field -(minus) the value of the region_x field. The region_height field indicates a height of the rectangular region of the samples of the corresponding track on the composed picture in luma sample units. A range of a value of the region_height field may be from 1 to a value of the composition_height field−(minus) the value of the region_y field. The composition_width field indicates a width of the composed picture in luma sample units. The value of the composition_width field may be greater than or equal to a value of the region_x field +(plus) the value of the region_width field. The composition_height field indicates the height of the composed picture in luma sample units. The value of the composition_height field may be greater than or equal to the value of the region_y field+(plus) the value of the region_height field. The composed picture may correspond to the aforementioned original picture, packed picture, or projected picture.

Meanwhile, for identification of the subpicture track which includes multiple rectangular regions mapped into the composed picture, the following methods may be used.

For example, information for identifying the rectangular regions may be signaled through information on a guard band.

If 360-degree video data subsequent in a 3D space are mapped into a region of a 2D image, the 360-degree video data may be coded per region of the 2D image and then delivered to the reception side. Therefore, if the 360-degree video data mapped into the 2D image are again rendered in the 3D space, a problem may occur in that a boundary between regions occurs in the 3D space due to a difference in coding processing between the respective regions. The problem that the boundary between the regions occurs in the 3D space may be called a boundary error. The boundary error may deteriorate an immersion level for a virtual reality of a user, and a guard band may be used to solve this problem. Although the guard band is not rendered directly, the guard band may indicate a region used to improve a rendered portion of an associated region or avoid or mitigate a visual artifact such as seam. The guard band may be used if a region-wise packing process is applied.

In this example, the multiple rectangular regions may be identified using RegionWisePackingBox.

FIG. 30 illustrates a hierarchical structure of RegionWisePackingBox.

Referring to FIG. 30, a guard_band_flag[i] field having a value of 0 indicates that the i-th region does not have a guard band. A guard_band_flag[i] field having a value of 1 indicates that the i-th region has a guard band. A packing_type[i] field indicates a type of region-wise packing. A packing_type[i] field having a value of 0 indicates packing per rectangular region. The other values may be reserved. A left_gb_width[i] field indicates a width of a guard band at a left side of the i-th region. A left_gb_width[i] field may indicate the width of the guard band in units of two luma samples. A right_gb_width[i] field indicates a width of a guard band at a right side of the i-th region. The right_gb_width[i] field may indicate the width of the guard band in units of two luma samples. A top_gb_width[i] field indicates a width of a guard band at an upper side of the i-th region. The top_gb_width[i] field may indicate the width of the guard band in units of two luma samples. A bottom_gb_width[i] field indicates a width of a guard band at a lower side of the i-th region. The bottom_gb_width[i] field may indicate the width of the guard band in units of two luma samples. If the value of the guard_band_flag[i] is 1, the value of the left_gb_width[i] field, the right_gb_width[i] field, the top_gb_width[i] field or the bottom_gb_width[i] field is greater than 0. The i-th region, including its guard bands, if any, shall not overlap with any other region, including its guard bands.

A gb_not_used_for_pred_flag[i] field having a value of 0 indicates that guard bands are available for inter-prediction. That is, if the value of the gb_not_used_for_pred_flag[i] field is 0, the guard bands may be used for inter-prediction or not. A gb_not_used_for_pred_flag[i] having a value of 1 indicates that sample values of the guard bands are not used for an inter-prediction procedure. If the value of the gb_not_used_for_pred_flag[i] field is 1, even though decoded pictures (decoded packed pictures) have been used as references for inter-prediction of subsequent pictures to be decoded, the sample values within the guard bands on the decoded pictures may be rewritten or corrected. For example, contents of a region may seamlessly be enlarged to its guard band by using decoded and re-projected samples of another region.

A gb_type[i] field may indicate types of the guard bands of the i-th region as follows. A gb_type[i] field having a value of 0 indicates that contents of corresponding guard band are unspecified in a relation with contents of corresponding region(s). If a value of the gb_not_used_for_pred_flag field is 0, the value of the gb_type field cannot be 0. A gb_type[i] field having a value of 1 indicates that contents of the guard bands are sufficient for interpolation of sub-pixel values within a region (and one pixel outside region boundary). The gb_type[i] field having a value of 1 may be used when boundary samples of a region are copied in the guard band horizontally or vertically. The gb_type[i] field having a value of 2 indicates that contents of the guard bands indicate actual image contents based on quality which is gradually changed, wherein the quality is gradually changed from picture quality of a corresponding region to picture quality of a region adjacent to the corresponding region on a spherical surface. The gb_type[i] field having a value of 3 indicates that contents of the guard bands indicate actual image contents based on picture quality of a corresponding region.

If one track includes rectangular regions mapped into a plurality of rectangular regions within the composed picture, some regions may be identified as region-wise packing regions, which are identified as RectRegionPacking(i), and the other regions may be identified as guard band regions identified based on some or all of the guard_band_flag[i] field, the left_gb_width[i] field, the right_gb_width[i] field, the top_gb_height[i] field, the bottom_gb_height[o] field, the gb_not_used_for_pred_flag[i] field, and the gb_type[i] field.

For example, in case of subpicture 7 described in FIG. 27 and its description, region E may be identified as a region-wise packing region, and region A may be identified as a guard band region located at a right side of the region E. In this case, a width of the guard band region may be identified based on the right_gb_width[i] field. On the contrary, the region A may be identified as a region-wise packing region, and the region E may be identified as a guard band region located at a left side. In this case, a width of the guard band region may be identified based on the left_gb_width[i] field. A type of this guard band region may be indicated through the gb_type[i] field, and the rectangular region may be identified as a region having the same quality as that of a neighboring region through the aforementioned value of ‘3’. Alternatively, if quality of the region-wise packing region is different from that of the guard band region, the rectangular region may be identified through the aforementioned value of ‘2’.

Also, the rectangular region may be identified through values of ‘4’ to ‘7’ of the gb_type[i] field as follows. The gb_type[i] field having a value of 4 may indicate that contents of the rectangular region are actual image contents existing to adjoin the corresponding region on a spherical surface and quality is gradually changed from the region-wise packing region associated thereto. The gb_type[i] field having a value of 5 may indicate that the contents are actual image contents existing to adjoin the corresponding region on the spherical surface and quality is equal to quality of the region-wise packing region associated thereto. The gb_type[i] field having a value of 6 may indicate that contents of the rectangular region are actual image contents existing to adjoin the corresponding region on a projection picture and quality is gradually changed from the region-wise packing region. The gb_type[i] field having a value of 7 may indicate that contents of the rectangular region are actual image contents existing to adjoin the corresponding region on the projected picture and quality is equal to quality of the region-wise packing region associated thereto.

For another example, information for identifying the rectangular region may be signaled using SubPicturecompositionBox.

In the present invention, the multiple rectangular regions may be categorized into a region existing within the composed picture and a region existing outside the composed picture, based on a coordinate value. The region existing outside the composed picture may be located at a counter corner by clipping to indicate the multiple rectangular regions.

For example, if x which is a horizontal coordinate of a rectangular region within the composed picture region is equal to or greater than a value of a composition_width field, a value obtained by subtracting the value of the composition_width field from x may be used, and if y which is a vertical coordinate of the rectangular region is equal to or greater than a value of a composition_height field, a value obtained by subtracting the value of the composition_height field from y may be used.

To this end, ranges of the track_width field, the track_height field, the composition_width field, and the composition_height field of the SubPictureCompositionBox may be corrected as follows.

The range of the region_width field may be from 1 to the value of the composition_width field. The range of the region_height field may be from 1 to the value of the composition_height field. The value of the composition_width field may be greater than or equal to the value of the region_x field+1(plus 1). The value of the composition_height field may be greater than or equal to the value of the region_y field+1(plus 1).

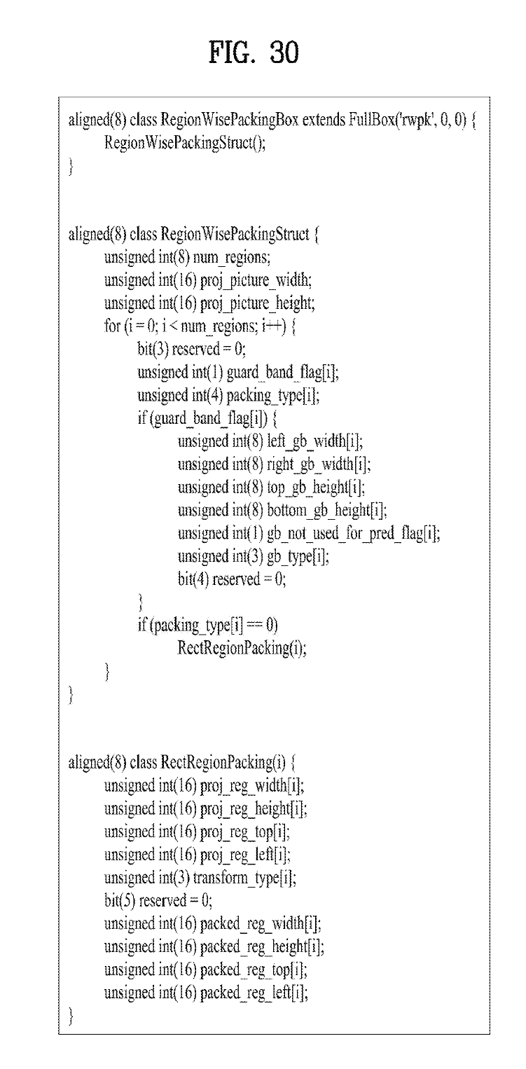

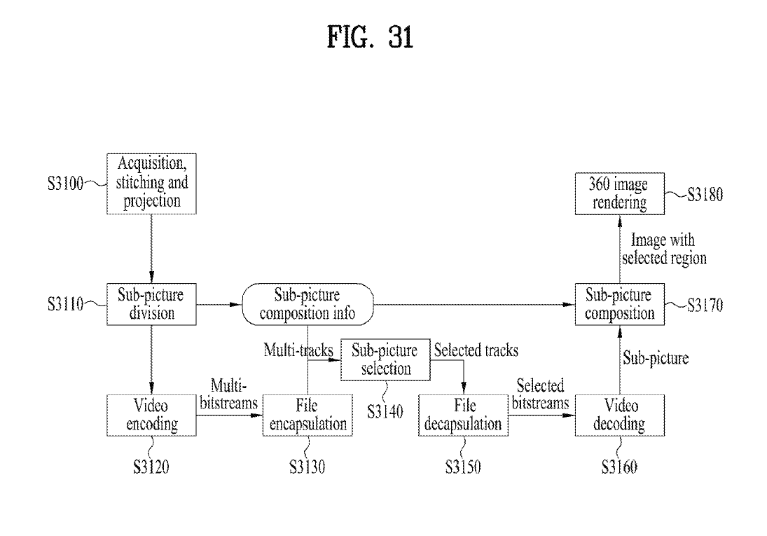

FIG. 31 briefly illustrates a procedure of transmitting or receiving 360-degree video using subpicture composition according to the present invention.

Referring to FIG. 31, the transmission apparatus acquires 360-degree video and maps the acquired video into one 2D picture through stitching and projection (S2600). A region-wise packing region process may optionally be included in this case. The 360-degree video may be a video taken using at least one 360-degree camera, or may be a video generated or synthesized through an image processing device such as a computer. Also, the 2D picture may include the aforementioned original picture, projected picture/packed picture, and composed picture.

The transmission apparatus splits the 2D picture into a plurality of subpictures (S2610). In this case, the transmission apparatus may generate and/or use subpicture composition information.

The transmission apparatus may encode at least one of the plurality of subpictures (S2520). The transmission apparatus may select and encode some of the plurality of subpictures, or may encode all of the plurality of subpictures. Each of the plurality of subpictures may be coded independently.

The transmission apparatus configures a file by using the encoded subpicture streams (S2630). The subpicture streams may be stored in the form of individual track. The subpicture composition information may be included in the corresponding subpicture track through at least one of the aforementioned methods according to the present invention.

The transmission apparatus or the reception apparatus may select a subpicture (S2640). The transmission apparatus may select the subpicture and deliver a related track by using viewport information and interaction related feedback information of the user. Alternatively, the transmission apparatus may deliver a plurality of subpicture tracks, and the reception apparatus may select at least one subpicture (subpicture track) by using viewport information and interaction related feedback information of the user.

The reception apparatus acquires subpicture bitstream and subpicture composition information by interpreting the file (S2650), and decodes the subpicture bitstream (S2660). The reception apparatus maps the decoded subpicture into the composed picture (original picture) region based on the subpicture composition information (S2670). The reception apparatus renders the mapped composed picture (S2680). In this case, the reception apparatus may perform a rectilinear projection process of mapping a partial region of a spherical surface corresponding to a viewport of the user into a viewport plane.

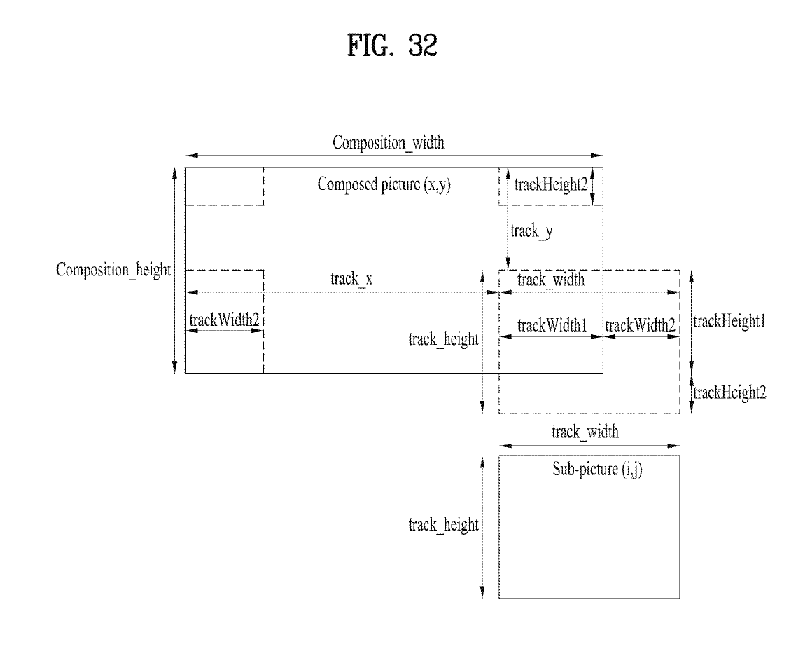

According to the present invention, as shown in FIG. 32, the subpicture may include regions which are not spatially adjacent to each other on a 2D composed picture in a subpicture region. In the aforementioned process S2610, regions corresponding to positions (track_x and track_y) and sizes (width and height) given by subpicture composition information may be devised with respect to pixels (x, y) constituting a composed picture. In this case, a position (i,j) of a pixel within a subpicture may be devised as listed in Table 1 below.

TABLE 1

```
if (track_x+track_width > composition_width) {
      trackWidth1 = composition_width − track_x;
      trackWidth2 = track_width − trackWidth1
} else {
      trackWidth1 = track_width
      trackWidth2 = 0
}
if (track_y+track_height > composition_height) {
      trackHeight1 = composition_height − track_y;
      trackHeight2 = track_height − trackHeight1
} else {
      trackHeight1 = track_height
      trackHeight2 = 0
}
for (y=track_y; y<trackHeight1; y++) {
      for (x=track_x; x<trackWidth1; x++) {
            i = x − track_x
            j = y − track_y
      }
      for (x=0; x<trackWidth2; x++) {
            i = x
            j = y − track_y
      }
}
for (y=0; y<trackHeight2; y++) {
      for (x=track_x; x<trackWidth1; x++) {
            i = x − track_x
            j = y
      }
      for (x=0; x<trackWidth2; x++) {
            i = x
            j = y
      }
}
```

Also, in the aforementioned process S2680, a position (x,y) of a pixel within the composed picture mapped into a position (i,j) of a pixel constituting a subpicture may be devised as listed in Table 2 below.

TABLE 2

```
for (j=0; j<track_height; j++) {
      for (i=0; i<track_width; i++) {
            x = track_x + i
            y = track_y + j
            if ( x >= composition_width)
                  x −= composition_width
            if (y >= composition_height)
                  y −= composition_height
      }
}
```

The position (i,j) of the pixel within the subpicture may be mapped into the position (x, y) of the pixel constituting the composed picture. When (x, y) departs from a boundary of the composed picture in a right direction as shown in FIG. 32, (x, y) may be connected to a left side of the composed picture. When (x, y) departs from the boundary of the composed picture in a downward direction, (x, y) may be connected to an upper side of the composed picture.

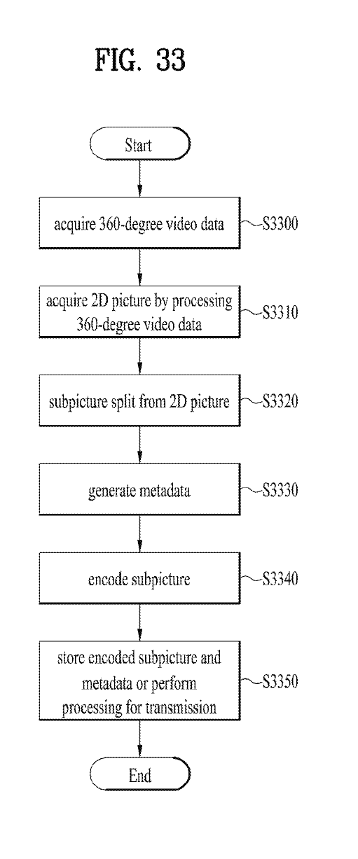

FIG. 33 briefly illustrates a method for processing 360-degree video by a 360-degree video transmission apparatus according to the present invention. The method disclosed in FIG. 33 may be performed by the 360-degree video transmission apparatus.

The 360-degree video transmission apparatus acquires 360-degree video data (S2800). In this case, the 360-degree video may be a video taken using at least one 360-degree camera, or may be a video generated or synthesized through an image processing device such as a computer.

Also, the 360-degree video transmission apparatus acquires 2D picture by processing the 360-dgree video data (S2810). The acquired image may be mapped into one 2D picture through stitching and projection. In this case, the aforementioned region-wise packing region process may optionally be performed. In this case, the 2D picture may include the aforementioned original picture, projected picture/packed picture, and composed picture.

The 360-degree video transmission apparatus splits the 2D picture to devise subpictures (S2820). The subpictures may be processed independently. The 360-degree video transmission apparatus may generate and/or use subpicture composition information. The subpicture composition information may be included in metadata.

The subpicture may include a plurality of subpicture regions which may not spatially adjoin each other on the 2D picture. The subpicture regions may spatially adjoin each other on the 2D picture, or may spatially adjoin each other on a 3D space (spherical surface) which will be presented or rendered.

The 360-degree video transmission apparatus generates metadata on the 360-degree video data (S2830). The metadata may include various kinds of information proposed in the present invention.

For example, the metadata may include position information of the subpicture on the 2D picture. If the 2D picture is a packed picture devised through a region-wise packing region process, the position information of the subpicture may include information indicating a horizontal coordinate at a left end of the subpicture, information indicating a vertical coordinate at a top end of the subpicture, information indicating a width of the subpicture and information indicating a height of the subpicture, based on a coordinate of the packed picture. For example, the position information of the subpicture may be included in RegionOriginalCoordinateBox in the metadata.

At least one subpicture track may be generated through the process 52850 which will be described later. The metadata may include position information of the subpicture and track ID information associated with the subpicture. For example, the position information of the subpicture and the track ID information associated with the subpicture may be included in RegionToTrackBox included in the metadata. Also, a file which includes a plurality of subpicture tracks may be generated through the step of performing processing for the storage or transmission, and the metadata may include VPS(video parameter set), SPS(sequence parameter set) or PPS(picture parameter set) associated with the subpicture as shown in FIG. 24.

For another example, the position information of the subpicture may be included in SEI message, which may include information indicating a horizontal coordinate at a left end of the subpicture, information indicating a vertical coordinate at a top end of the subpicture, information indicating a width of the subpicture and information indicating a height of the subpicture, based on a coordinate of the 2D picture in luma sample units. The SEI message may further include information indicating the number of bytes of the position information of the subpicture as shown in FIG. 22.

The subpicture may include a plurality of subpicture regions. In this case, the metadata may include subpicture region information which includes position information of the subpicture regions and correlation information between the subpicture regions. The subpicture regions may be indexed in a raster scan order. As shown in FIG. 26, the correlation information may include at least one of information indicating a top row of each subpicture region on the subpicture and information indicating and a left-most column of each subpicture region on the subpicture.

The position information of the subpicture may include information indicating a horizontal coordinate at a left end of the subpicture, information indicating a vertical coordinate at a top end of the subpicture, information indicating a width of the subpicture and information indicating a height of the subpicture, based on a coordinate of the 2D picture. A value range of the information indicating the width of the subpicture may be from 1 to the width of the 2D picture, and a value range of the information indicating the height of the subpicture may be from 1 to the height of the 2D picture. If the horizontal coordinate of the left end of the subpicture+(plus) the width of the subpicture is greater than the width of the 2D picture, the subpicture may include the plurality of subpicture regions. If the vertical coordinate of the top end of the subpicture+(plus) the height of the subpicture is greater than the height of the 2D picture, the subpicture may include the plurality of subpicture regions.

The 360-degree video transmission apparatus encodes at least one of the subpictures (S2840). The 360-degree video transmission apparatus may select and encode some of the plurality of subpictures, or may encode all of the plurality of subpictures. Each of the plurality of subpictures may be coded independently.

The 360-degree video transmission apparatus performs processing for storage or transmission for the metadata and at least one of the encoded subpictures (S2850). The 360-degree video transmission apparatus may encapsulate at least one encoded subpicture and/or the metadata in the form of file. The 360-degree video transmission apparatus may encapsulate at least one encoded subpicture and/or the metadata in a file format of ISOBMFF, CFF, etc. to store or transmit the subpicture and/or the metadata, or may process the subpicture and/or the metadata in the form of other DASH segment, etc. The 360-degree video transmission apparatus may include the metadata in the file format. For example, the metadata may be included in a box of various levels on an ISOBMFF file format, or may be included in data within a separate track within the file. The 360-degree video transmission apparatus may apply processing for transmission to an encapsulated file in accordance with the file format. The 360-degree video transmission apparatus may process the file in accordance with a random transmission protocol. Processing for transmission may include processing for delivery through a broadcast network or processing delivery through a communication network such as a broadband. Also, the 360-degree video transmission apparatus may transmit the 360-degree video data subjected to transmission and the metadata through a broadcast network and/or broadband.

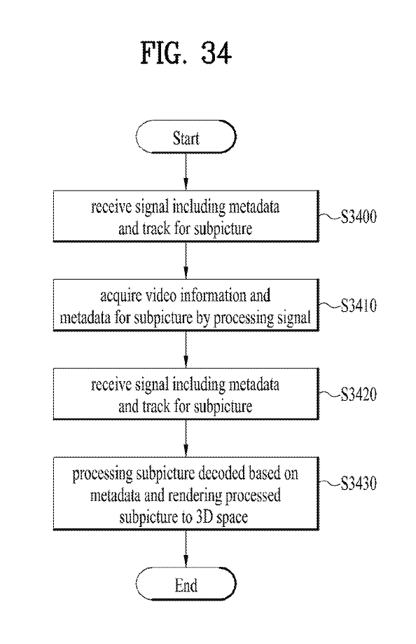

FIG. 34 briefly illustrates a method for processing 360-degree video by a 360-degree video reception apparatus according to the present invention. The method disclosed in FIG. 34 may be performed by the 360-degree video reception apparatus.

The 360-degree video reception apparatus receives a signal which includes metadata and a track for a subpicture (S2900). The 360-degree video reception apparatus may receive image information on the subpicture and the metadata signaled from the 360-degree video transmission apparatus through the broadcast network. The 360-degree video reception apparatus may receive the image information on the subpicture and the metadata through a communication network such as a broadband or a storage medium. In this case, the subpicture may be located on the packed picture or projected picture.

The 360-degree video reception apparatus acquires image information on the subpicture and metadata by processing the signal (S2910). The 360-degree video reception apparatus may perform processing according to a transmission protocol for image information on the received subpicture and the metadata. Also, the 360-degree video reception apparatus may perform a reverse process of processing for transmission of the 360-degree video transmission apparatus.

The received signal may include a track for at least one subpicture. If the received signal includes a track for a plurality of subpictures, the 360-degree video reception apparatus may select some (including one) of the tracks for the plurality of subpictures. In this case, viewport information, etc. may be used.

The subpicture may include a plurality of subpicture regions which may not spatially adjoin each other on the 2D picture. The subpicture regions may spatially adjoin each other on the 2D picture, or may spatially adjoin each other on a 3D space (spherical surface) which will be presented or rendered.

The metadata may include various kinds of information proposed in the present invention.

For example, the metadata may include position information of the subpicture on the 2D picture. If the 2D picture is a packed picture devised through a region-wise packing process, the position information of the subpicture may include information indicating a horizontal coordinate at a left end of the subpicture, information indicating a vertical coordinate at a top end of the subpicture, information indicating a width of the subpicture and information indicating a height of the subpicture, based on a coordinate of the packed picture. For example, the position information of the subpicture may be included in RegionOriginalCoordinateBox in the metadata.

The metadata may include the position information of the subpicture and track ID information associated with the subpicture. For example, the position information of the subpicture and the track ID information associated with the subpicture may be included in RegionToTrackBox included in the metadata. Also, a file which includes a plurality of subpicture tracks may be generated through the step of performing processing for the storage or transmission, and the metadata may include VPS(video parameter set), SPS(sequence parameter set) or PPS(picture parameter set) associated with the subpicture as shown in FIG. 24.

For another example, the position information of the subpicture may be included in SEI message, which may include information indicating a horizontal coordinate at a left end of the subpicture, information indicating a vertical coordinate at a top end of the subpicture, information indicating a width of the subpicture and information indicating a height of the subpicture, based on a coordinate of the 2D picture in luma sample units. The SEI message may further include information indicating the number of bytes of the position information of the subpicture as shown in FIG. 22.

The subpicture may include a plurality of subpicture regions. In this case, the metadata may include subpicture region information which includes position information of the subpicture regions and correlation information between the subpicture regions. The subpicture regions may be indexed in a raster scan order. As shown in FIG. 26, the correlation information may include at least one of information indicating a top row of each subpicture region on the subpicture and information indicating and a left-most column of each subpicture region on the subpicture.

The position information of the subpicture may include information indicating a horizontal coordinate at a left end of the subpicture, information indicating a vertical coordinate at a top end of the subpicture, information indicating a width of the subpicture and information indicating a height of the subpicture, based on the coordinate of the 2D picture. A value range of the information indicating the width of the subpicture may be from 1 to the width of the 2D picture, and a value range of the information indicating the height of the subpicture may be from 1 to the height of the 2D picture. If the horizontal coordinate of the left end of the subpicture+(plus) the width of the subpicture is greater than the width of the 2D picture, the subpicture may include the plurality of subpicture regions. If the vertical coordinate of the top end of the subpicture+(plus) the height of the subpicture is greater than the height of the 2D picture, the subpicture may include the plurality of subpicture regions.

The 360-degree video reception apparatus encodes the subpictures based on image information for the subpictures (S2920). The 360-degree video reception apparatus may independently decode the subpictures based on the information on the subpictures. Also, even in the case that the image information on the plurality of subpictures is input, the 360-degree video reception apparatus may decode only a specific subpicture based on the acquired viewport related metadata.

The 360-degree video reception apparatus processes the decoded subpictures and renders the processed subpictures to the 3D space (S2930). The 360-degree video reception apparatus may map the decoded subpictures into the 3D space based on the metadata. In this case, the 360-degree video reception apparatus may map and render the decoded subpictures into the 3D space by performing coordinate conversion based on the position information of the subpicture and/or the subpicture region according to the present invention.

The aforementioned steps may be omitted in accordance with the embodiment, or may be replaced with another steps for performing similar/same operations.

The 360-degree video transmission apparatus according to one embodiment of the present invention may include a data input unit, a stitcher, a signaling processor, a projection processor, a data encoder, a transmission processor, and/or a transmission unit. Internal components of these elements are equal to those described as above. The 360-degree video transmission apparatus and its internal components according to one embodiment of the present invention may perform the embodiments of the aforementioned 360-degree video transmission method according to the present invention.

The 360-degree video reception apparatus according to one embodiment of the present invention may include a reception unit, a reception processor, a data decoder, a signaling parser, a re-projection processor, and/or a renderer. Internal components of these elements are equal to those described as above. The 360-degree video reception apparatus and its internal components according to one embodiment of the present invention may perform the embodiments of the aforementioned 360-degree video reception method according to the present invention.

The internal components of the aforementioned apparatus may be either processors for executing subsequent procedures stored in the memory or hardware components configured by other hardware. These components may be located inside/outside the apparatus.

The aforementioned modules may be omitted in accordance with the embodiments, or may be replaced with other modules for performing similar/same operations.

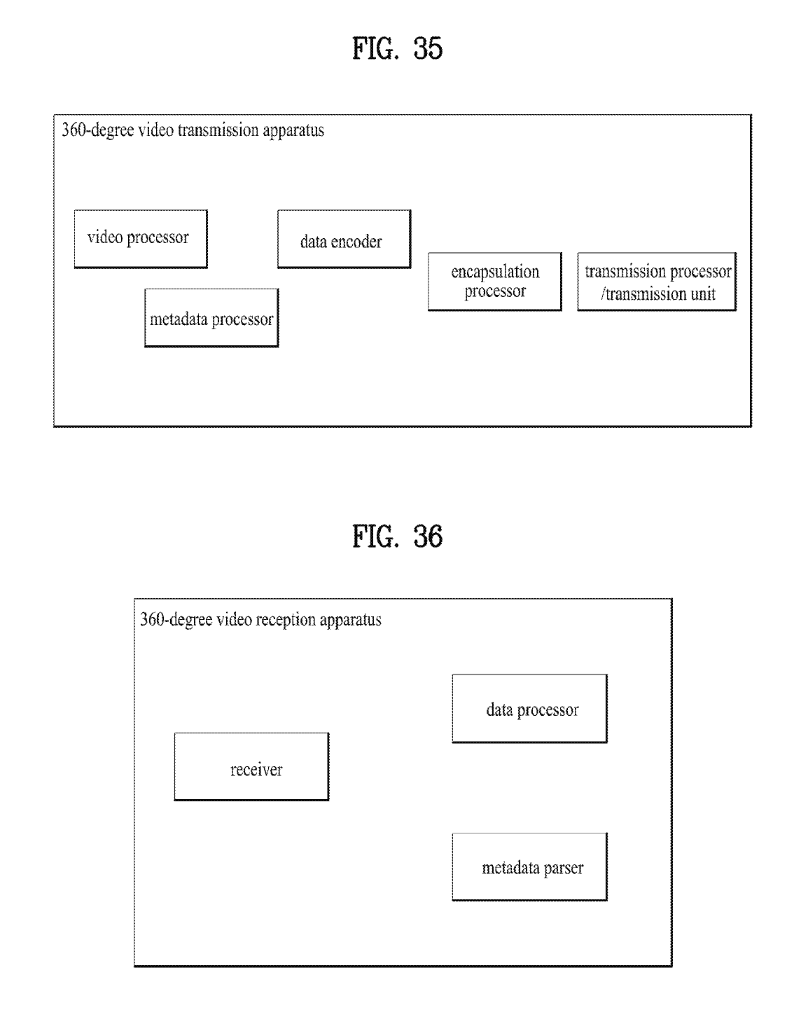

FIG. 35 is a view showing a 360-degree video transmission apparatus according to one aspect of the present invention.

According to one aspect, the present invention may be related to the 360-degree video transmission apparatus. The 360-degree video transmission apparatus may process 360-degree video data, and may generate signaling information on the 360-degree video data and transmit the generated signaling information to the reception side.

In detail, the 360-degree video transmission apparatus may stitch 360-degree video, projection-process the 360-degree video in a picture, encode the picture, generate signaling information on the 360-degree video data, and transmit the 360-degree video data and/or signaling information in various forms and various methods.

The 360-degree video transmission apparatus according to the present invention may include a video processor, a data encoder, a metadata processor, an encapsulation processor, and/or a transmission unit as internal/external components.

The video processor may process 360-degree video data captured by at least one or more cameras. The video processor may stitch the 360-degree video data and project the stitched 360-degree video data on the 2D image, that is, picture. In accordance with the embodiment, the video processor may further perform region-wise packing. In this case, stitching, projection and region wise packing may correspond to the aforementioned same processes. Region-wise packing may be called packing per region in accordance with the embodiment. The video processor may be a hardware processor for performing the roles corresponding to the stitcher, the projection processor and/or the region-wise packing processor.

The data encoder may encode the picture in which the 360-degree video data are projected. If region wise packing is performed in accordance with the embodiment, the data encoder may encode the packed picture. The data encoder may correspond to the aforementioned data encoder.

The metadata processor may generate signaling information on the 360-degree video data. The metadata processor correspond to the aforementioned metadata processor.

The encapsulation processor may encapsulate the encoded picture and the signaling information in the file. The encapsulation processor may correspond to the aforementioned encapsulation processor.

The transmission unit may transmit the 360-degree video data and the signaling information. If the corresponding information is encapsulated in the file, the transmission unit may transmit the files. The transmission unit may be a component corresponding to the aforementioned transmission processor and/or the transmission unit. The transmission unit may transmit the corresponding information through a broadcast network or broadband.

In one embodiment of the 360-degree video transmission apparatus according to the present invention, the signaling information may include coverage information. The coverage information may indicate a region reserved by the subpictures of the aforementioned picture on the 3D space. In accordance with the embodiment, the coverage information may indicate a region reserved by one region of the picture on the 3D space even in case of no subpictures.

In another embodiment of the 360-degree video transmission apparatus according to the present invention, the data encoder may process a partial region of all 360-degree video data in an independent video stream, for user view point dependent processing. The data encoder may respectively process partial regions in the projected picture or region-wise packed picture in the form of independent video stream. These video streams may be stored and transmitted individually. In this case, each region may be the aforementioned tile.

If the corresponding video streams are encapsulated in the file, one track may include a rectangular region. This rectangular region may correspond to one or more tiles. In accordance with the embodiment, if corresponding video streams are delivered by DASH, one Adaptation Set, Representation or Sub Representation may include a rectangular region. This rectangular region may correspond to one or more tiles. In accordance with the embodiment, each region may be HEVC bitstreams extracted from HEVC MCTS bitstreams. In accordance with the embodiment, this process may be performed by the aforementioned tiling system or transmission processor not the data encoder.

In still another embodiment of the 360-degree video transmission apparatus according to the present invention, the coverage information may include information for specifying a corresponding region. To specify the corresponding region, the coverage information may include information for specifying center, width and/or height of the corresponding region. The coverage information may include information indicating a yaw value and/or pitch value of a center point of the corresponding region. This information may be represented by an azimuth value or elevation value when the 3D space is a spherical surface. Also, the coverage information may include a width value and/or height value of the corresponding region. The width value and the height value may indicate coverage of the full corresponding region by specifying a width and a height of the corresponding region based on a specified center point.

In further still another embodiment of the 360-degree video transmission apparatus according to the present invention, the coverage information may include information for specifying a shape of the corresponding region. In accordance with the embodiment, the corresponding region may be a shape specified by 4 great circles or a shape specified by 2 yaw circles and 2 pitch circles. The coverage information may have information indicating the shape of the corresponding region.

In further still another embodiment of the 360-degree video transmission apparatus according to the present invention, the coverage information may include information indicating whether 360-degree video of the corresponding region is 3D video and/or left/right image. The coverage information may indicate whether the corresponding 360-degree video is 2D video or 3D video, and corresponds to a left image or a right image if the corresponding 360-degree video is the 3D video. In accordance with the embodiment, this information may indicate whether the corresponding 360-degree video includes both the left image and the right image. In accordance with the embodiment, this information may be defined as one field, whereby the aforementioned matters may be signaled in accordance with a value of this field.

In further still another embodiment of the 360-degree video transmission apparatus according to the present invention, the coverage information may be generated in the form of DASH (Dynamic Adaptive Streaming over HTTP) descriptor. The coverage information may be configured as a DASH descriptor by varying only a format. In this case, the DASH descriptor may be included in MPD (Media Presentation Description) and transmitted through a separate path different from that of the 360-degree video data. In this case, the coverage information may not be encapsulated in the file together with the 360-degree video data. That is, the coverage information may be delivered to the reception side through a separate signaling channel in the form of MPD. In accordance with the embodiment, the coverage information may simultaneously be included in the file and separate signaling information such as MPD.

In further still another embodiment of the 360-degree video transmission apparatus according to the present invention, the 360-degree video transmission apparatus may further include a feedback processor (transmitting side). The feedback processor (transmitting side) may correspond to the aforementioned feedback processor (transmitting side). The feedback processor (transmitting side) may receive feedback information indicating a viewport of a current user from the reception side. This feedback information may include information for specifying a viewport which is currently viewed by the current through a VR device. As described above, tiling may be performed using this feedback information. At this time, one region of a subpicture or picture transmitted by the 360-degree video transmission apparatus may be one region of a subpicture or picture which corresponds to the viewport indicated by this feedback information. At this time, the coverage information may indicate coverage for a subpicture or picture corresponding to the viewport indicated by the feedback information.

In further still another embodiment of the 360-degree video transmission apparatus according to the present invention, the 3D space may be a sphere. In accordance with the embodiment, the 3D space may be cube.

In further still another embodiment of the 360-degree video transmission apparatus according to the present invention, signaling information on 360-degree video data may be inserted into the file in the form of ISOBMFF (ISO Base Media File Format) box. In accordance with the embodiment, the file may be ISOBMFF file or CFF (Common File Format) file.

In further still another embodiment of the 360-degree video transmission apparatus according to the present invention, the 360-degree video transmission apparatus may further include a data input unit which is not shown. The data input unit may correspond to an internal component of the aforementioned data input unit.

In further still another embodiment of the 360-degree video transmission apparatus according to the present invention, when 360-degree video contents are provided, a method for efficiently providing 360-degree video service by defining and delivering metadata of attributes of the 360-degree video is proposed.

In the 360-degree video transmission apparatus according to the embodiments of the present invention, the reception side may effectively select a region corresponding to a viewport by adding a shape_type field or parameter to the coverage information.

The 360-degree video transmission apparatus according to the embodiments of the present invention may receive and process only a video region corresponding to the viewport which is currently viewed by the user through tiling and provide the processed video region to the user. As a result, efficient data delivery and processing may be performed.

The 360-degree video transmission apparatus according to the embodiments of the present invention may effectively acquire and process corresponding 3D 360-degree video by signaling the presence of a left/right image or the presence of 2D/3D of the corresponding region to the coverage information.

The embodiments of the aforementioned 360-degree video transmission apparatus according to the present invention may be configured in combination. Also, internal/external components of the aforementioned 360-degree video transmission apparatus according to the present invention may be added, modified, replaced or deleted in accordance with the embodiment. Also, the internal/external components of the aforementioned 360-degree video transmission apparatus according to the present invention may be implemented as hardware components.

FIG. 36 is a view showing a 360-degree video reception apparatus according to another aspect of the present invention.

According to another aspect, the present invention may be related to the 360-degree video reception apparatus. The 360-degree video reception apparatus may receive and process 360-degree video data and/or signaling information on the 360-degree video data, and may render the 360-degree video to a user. The 360-degree video reception apparatus may be an apparatus at a reception side corresponding to the aforementioned 360-degree video transmission apparatus.

In detail, the 360-degree video reception apparatus may receive 360-degree video data and/or signaling information on the 360-degree video data, acquire signaling information, process the 360-degree video data based on the signaling information and render the 360-degree video.

The 360-degree video reception apparatus according to the present invention may include a reception unit, a data processor, and/or a metadata parser as internal/external components.

The reception unit may receive 360-degree video data and/or signaling information on the 360-degree video data. In accordance with the embodiment, the reception unit may receive this information in the form of file. In accordance with the embodiment, the reception unit may receive corresponding information through a broadcast network or broadband. The reception unit may be a component corresponding to the aforementioned reception unit.

The data processor may acquire 360-degree video data and/or signaling information on the 360-degree video data from the received file. The data processor may perform processing according to a transmission protocol for the received information, decapsulate the file, or perform decoding for the 360-degree video data. Also, the data processor may perform re-projection for the 360-degree video data and thus perform rendering. The data processor may be a hardware processor which performs the roles corresponding to the aforementioned reception processor, the decapsulation processor, the data decoder, the re-projection processor and/or the renderer.

The metadata parser may parse the acquired signaling information. The metadata parser may correspond to the aforementioned metadata parser.

The 360-degree video reception apparatus according to the present invention may have the embodiments corresponding to the aforementioned 360-degree video transmission apparatus according to the present invention. The aforementioned 360-degree video reception apparatus according to the present invention and its internal/external components may perform the embodiments corresponding to the embodiments of the aforementioned 360-degree video transmission apparatus according to the present invention.

The aforementioned 360-degree video reception apparatus according to the present invention may be configured in combination. Also, the aforementioned 360-degree video reception apparatus according to the present invention may be added, modified, replaced or deleted in accordance with the embodiment. Also, the internal/external components of the aforementioned 360-degree video reception apparatus according to the present invention may be implemented as hardware components.

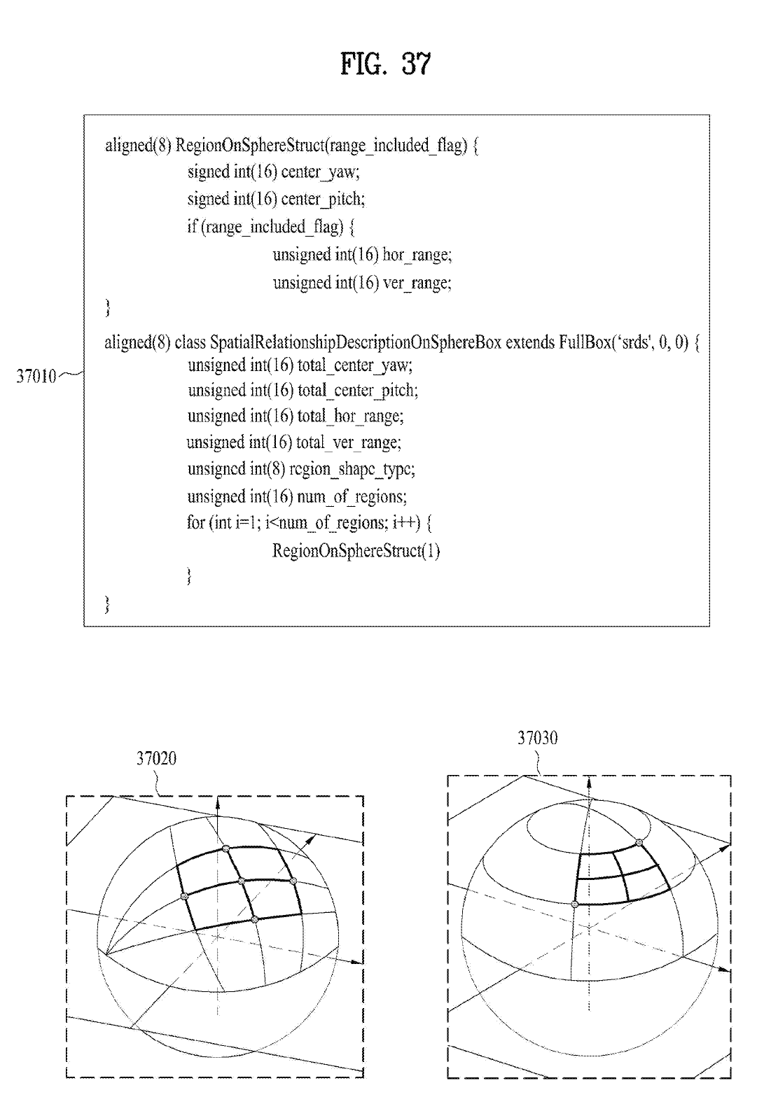

FIG. 37 is a view showing an embodiment of coverage information according to the present invention.

The coverage information according to the present invention may indicate a region reserved by the subpictures of the aforementioned picture on the 3D space as described above. In accordance with the embodiment, the coverage information may indicate a region reserved by one region of the picture on the 3D space even in case of no subpictures.

As described above, the coverage information may include information for specifying a shape of the corresponding region and/or information indicating whether 360-degree video of the corresponding region is 3D video and/or left/right image.

In one embodiment (37010) of the shown coverage information, the coverage information may be defined as SpatialRelationshipDescriptionOnSphereBox. The SpatialRelationshipDescriptionOnSphereBox may be defined as a box that may be expressed as srds. This box may be included in an ISOBMFF file. In accordance with the embodiment, this box may exist under a visual sample entry of a track in/to which each region is stored/transmitted. In accordance with the embodiment, this box may exist under another box such as Scheme Information box.

In detail, SpatialRelationshipDescriptionOnSphereBox may include a total_center_yaw field, a total_center_pitch field, a total_hor_range field, a total_ver_range field, a region_shape_type field and/or a num_of_region field.

The total_center_yaw field may indicate a yaw (longitude) value of a center point of a full 3D space region (3D geometry surface) to which the corresponding region (tile in accordance with the embodiment) belongs.

The total_center_pitch field may indicate a pitch (latitude) value of the center point of the 3D space to which the corresponding region belongs.

The total_hor_range field may a yaw value range of the full 3D space region to which the corresponding region belongs.

The total_ver_range field may indicate a pitch value range of the full 3D space region to which the corresponding region belongs.

The region_shape_type field may indicate a shape of the corresponding regions. The shape of the regions may be one of a shape specified by 4 great circles and a shape specified by 2 yaw circles and 2 pitch circles. If this field value is 0, the corresponding regions may have a shape of a region surrounded by 4 great circles (37020). In this case, one region may indicate one cube face such as front, back, and back. If this field value is 1, the corresponding regions may have a shape of a region surrounded by 2 yaw circles and 2 pitches (37030).

The num_of_region field may indicate the number of corresponding regions to be indicated by SpatialRelationshipDescriptionOnSphereBox. In accordance with this field value, SpatialRelationshipDescriptionOnSphereBox may include RegionOnSphereStruct( )for each region.

RegionOnSphereStruct( )may indicate information for the corresponding region. RegionOnSphereStruct( )may incude a center_yaw field, a center_pitch field, a hor_range field and/or a ver_range field.

The center_yaw field and the center_pitch field may indicate a yaw value and a pitch value of a center point of the corresponding region. The range_included_flag field may indicate whether RegionOnSphereStruct( )includes the hor_range field and the ver_range field. In accordance with the range_included_flag field, RegionOnSphereStruct( )may include the hor_range field and the ver_range field.

The hor_range field and the ver_range field may indicate a width value and a height value of the corresponding region. This width and height may be based on a center point of a specified corresponding region. Coverage reserved by the corresponding region on the 3D space may be specified through the position and the width and height values of the center point.

In accordance with the embodiment, RegionOnSphereStruct( )may further include a center_roll field. The center_yaw field, the center_pitch field, and the center_roll field may indicate yaw, pitch and roll values of a center point of the corresponding region in a unit of 2⁻¹⁶-degree based on a specified coordinate system in ProjectionOrientationBox. In accordance with the embodiment, RegionOnSphereStruct( )may further include an interpolate field. The interpolate field may have a value of 0.

In accordance with the embodiment, the center_yaw field may have a range from 180*2¹⁶ to 180*2¹⁶¹. The center_pitch field may have a range from 90*2¹⁶ to 90*2¹⁶¹. The center_roll field may have a range from 180*2¹⁶ to 180*2¹⁶¹.

In accordance with the embodiment, the hor_range field and the ver_range field may indicate a width value and a height value of the corresponding region in a unit of 2⁻¹⁶. In accordance with the embodiment, the hor_range field may have a range from 1 to 720*2¹⁶. The ver_range field may have a range from 1 to 180*2¹⁶.

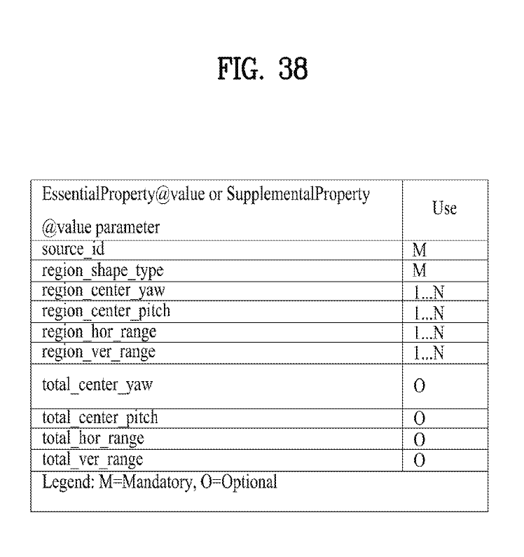

FIG. 38 is a view showing another embodiment of coverage information according to the present invention.

In another embodiment of the shown coverage information, the coverage information may have a shape of a DASH descriptor. As described above, when the 360-degree video data are transmitted by being split per region, the 360-degree video data may be transmitted through DASH. At this time, the coverage information may be delivered in the form of Essential Property or Supplemental Property descriptor of DASH MPD.

The descriptor which includes coverage information may be identified by new schemIdURI such as “urn:mpeg:dash:mpd:vr-srd:201x”. Also, this descriptor may exist under adaptation set, representation or sub representation in/to which each region is stored/transmitted.

In detail, the shown descriptor may include a source_id parameter, a region_shape_type parameter, a region_center_yaw parameter, a region_center_pitch parameter, a region_hor_range parameter, a region_ver_range parameter, a total_center_yaw parameter, a total_center_pitch parameter, a total_hor_range parameter and/or a total_ver_range parameter.

The source_id parameter may indicate an identifier for identifying source 360-degree video contents of corresponding regions. The regions from the same 360-degree video contents may have the same source_id parameter values.

The region_shape_type parameter may be the same as the aforementioned region_shape_type field.

The region_center_yaw and region_center_pitch parameters may include a plurality of sets and respectively indicate a yaw(longitude) value and a pitch (latitude) value of a center point of an Nth region.

The region_hor_range and region_ver_range parameters may include a plurality of sets and respectively indicate a yaw value range and a pitch value range of the center point of the Nth region.

The total_center_yaw, total_center_pitch, total_hor_range and total_ver_range parameters may be the same as the aforementioned total_center_yaw, total_center_pitch, total_hor_range, and total_ver_range fields.

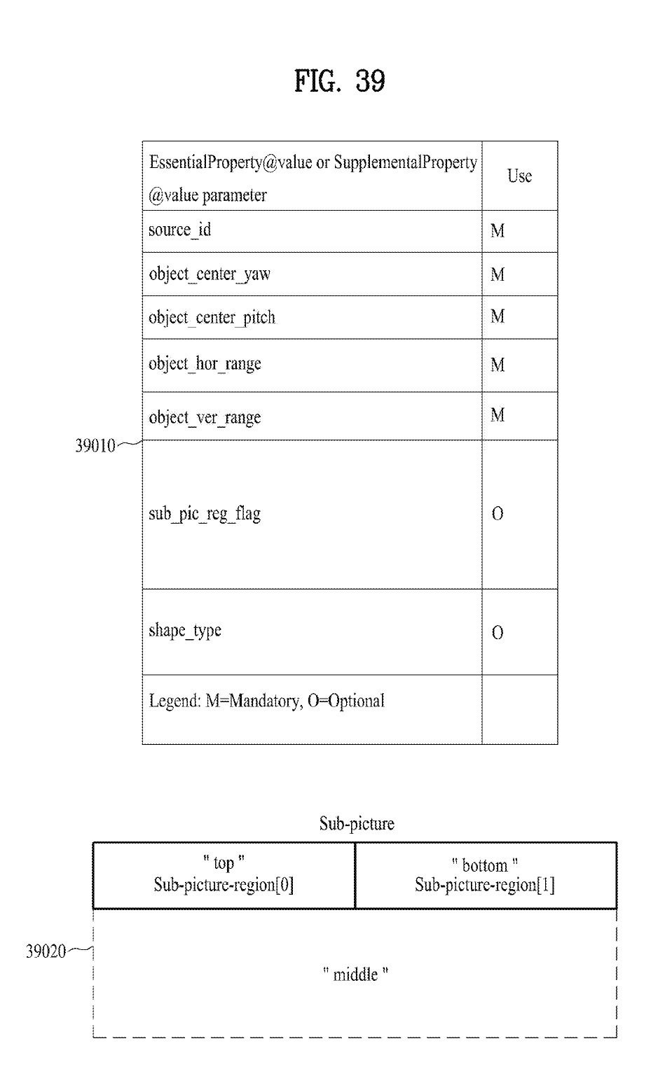

FIG. 39 is a view showing still another embodiment of coverage information according to the present invention.

In another embodiment (39010) of the shown coverage information, the coverage information may have a shape of a DASH descriptor. This DASH descriptor may provide information indicating a spatial relation between regions in the same manner as the aforementioned coverage information. This descriptor may be identified by schemIdURI such as “urn:mpeg:dash:spherical-region:201X”.

As described above, the coverage information may be delivered in the form of Essential Property or Supplemental Property descriptor of DASH MPD. Also, this descriptor may exist under adaptation set, representation or sub representation in/to which each region is stored/transmitted. In accordance with the embodiment, the DASH descriptor of the shown embodiment may exist only under adaptation set or sub representation.

In detail, the shown descriptor (39010) may include a source_id parameter, an object_center_yaw parameter, an object_center_pitch parameter, an object_hor_range parameter, an object_ver_range parameter, a sub_pic_reg_flag parameter and/or a shape_type parameter.

The source_id parameter may be an identifier for identifying a source of a corresponding VR content. This parameter may be the same as the aforementioned parameter of the same name In accordance with the embodiment, this parameter may have an integer value not negative number.

The object_center_yaw parameter and the object_center_pitch parameter may respectively indicate yaw and pitch values of a center point of a corresponding region. In this case, in accordance with the embodiment, the corresponding region may mean a region where a corresponding object (video region) is projected on a spherical surface.

The object_hor_range parameter and the object_ver_range parameter may respectively indicate a range of a width and a range of a height of the corresponding region. These parameters may respectively indicate a range of the yaw value and a range of the pitch value as degree values.

The sub_pic_reg_flag parameter may indicate whether the corresponding region corresponds to full subpictures arranged on a spherical surface. If this parameter value is 0, the corresponding region may correspond to one full subpicture. If this parameter value is 1, the corresponding region may correspond to a subpicture region within one subpicture. The subpicture, that is, tile may be split into a plurality of subpicture regions (39020). One subpicture may include a ‘top’ subpicture region and a ‘bottom’ subpicture region. At this time, the descriptor (39010) may describe the subpicture region, that is, the corresponding region. In this case, adaptation set or sub representation may include a plurality of descriptors (39010) to describe each subpicture region. The subpicture region may be concept different from the region in the aforementioned region-wide packing.

The shape_type parameter may be the same as the aforementioned region_shape_type field.

FIG. 40 is a view showing further still another embodiment of coverage information according to the present invention.

As described above, the 360-degree video may be provided in 3D. This 360-degree video may be called 3D 360-degree video or stereoscopic omnidirectional video.

If the 3D 360-degree video is delivered through a plurality of subpicture tracks, each track may deliver a left image or a right image of video regions. Alternatively, each track may simultaneously deliver a left image and a right image of one region. If the left image and the right image are transmitted by being split into subpictures different from each other, a receiver which supports 2D only may play corresponding 360-degree video data in 2D by using any one image only.

In accordance with the embodiment, if one subpicture track delivers both a left image and a right image of a region, the number of video decoders required for decoding of subpicture bitstreams corresponding to a current viewport of the 3D 360-degree video may be limited, wherein the region has the same coverage as that of the subpicture track.

In another embodiment of the shown coverage information, to select subpicture bitstreams of 3D 360-degree video corresponding to a viewport, the coverage information may provide coverage information on a region on a spherical surface related to each track.

In detail, for composition and coverage signaling of subpictures of the 3D 360-degree video, the coverage information of the shown embodiment may further include view_idc information. The view_idc information may additionally be included in all other embodiments of the aforementioned coverage information. In accordance with the embodiment, the view_idc information may be included in CoveragelnformationBox and/or content converage(CC) descriptor.

The coverage information of the shown embodiment may be indicated in the form of CoveragelnformationBox. CoveragelnformationBox may additionally include the view_idc field in the existing RegionOnSphereStruct( )

The view_idc field may indicate whether the 360-degree video of the corresponding region is 3D video and/or left/right image. If this field value is 0, the 360-degree video of the corresponding region may be 2D video. If this field value is 1, the 360-degree video of the corresponding region may be a left image of 3D video. If this field value is 2, the 360-degree video of the corresponding region may be a right image of 3D video. If this field value is 3, the 360-degree video of the corresponding region may be a left image and a right image of 3D video.

RegionOnSphereStruct( )may be as described above.

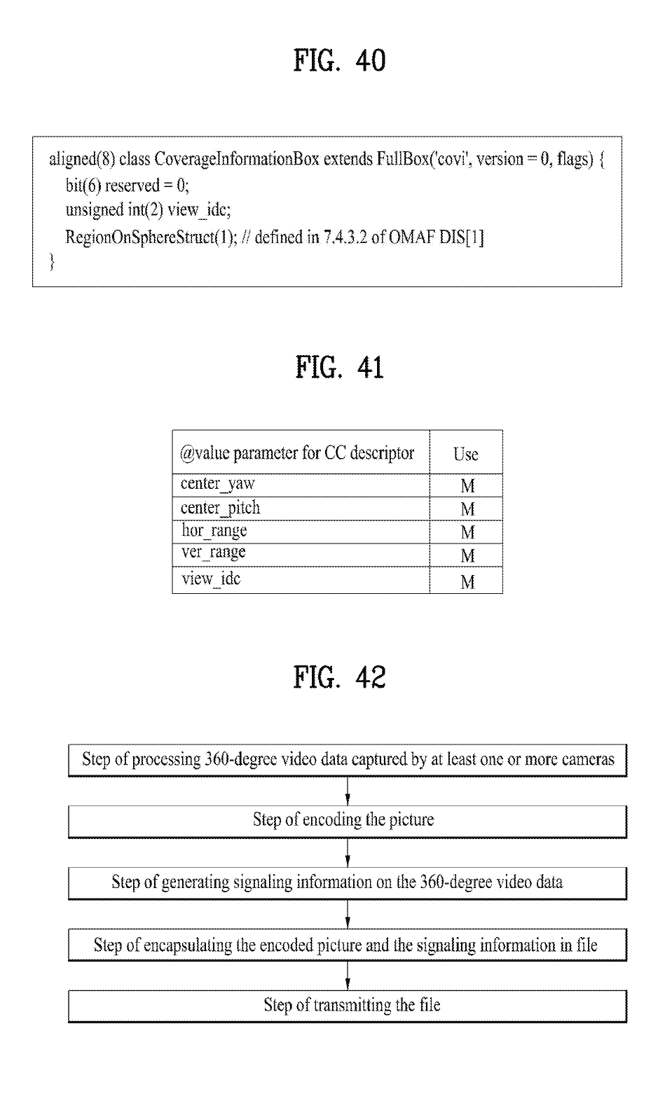

FIG. 41 is a view showing further still another embodiment of coverage information according to the present invention.

In further still another embodiment of the shown coverage information, view_idc information may be added to coverage information configured by a DASH descriptor in the form of parameter.

In detail, the DASH descriptor of the shown embodiment may include a center_yaw parameter, a center_pitch parameter, a hor_range parameter, a ver_range parameter and/or a view_idc parameter. The center_yaw parameter, the center_pitch parameter, the hor_range parameter, and the ver_range parameter may be equal to the aforementioned center_yaw, center_pitch, hor_range field and ver_range fields.

The view_idc parameter may indicate whether the 360-degree video of the corresponding region is 3D video and/or left/right image in the same manner as the aforementioned view_idc field. Values allocated to this parameter may be the same as those of the aforementioned view_idc field.

The embodiments of the coverage information according to the present invention may be configured in combination. In the embodiments of the 360-degree video transmission apparatus and the 360-degree video reception apparatus according to the present invention, the coverage information may be the coverage information according to the aforementioned embodiments.

FIG. 42 is a view illustrating one embodiment of a 360-degree video transmission method, which can be performed by a 360-degree video transmission apparatus according to the present invention.

One embodiment of the 360-degree video transmission method may include the steps of processing 360-degree video data captured by at least one camera, encoding the picture, generating signaling information on the 360-degree video data, encapsulating the encoded picture and the signaling information in a file and/or transmitting the file.

The video processor of the 360-degree video transmission apparatus may process the 360-degree video data captured by at least one camera. In this process, the video processor may stitch the 360-degree video data and project the stitched 360-degree video data on the picture. In accordance with the embodiment, the video processor may perform region wise packing for mapping the projected picture into a packed picture.

The data encoder of the 360-degree video transmission apparatus may encode the picture. The metadata processor of the 360-degree video transmission apparatus may generate signaling information on the 360-degree video data. In this case, the signaling information may include coverage information indicating a region reserved by a subpicture of the picture on the 3D space. The encapsulation processor of the 360-degree video transmission apparatus may encapsulate the encoded picture and the signaling information in the file. The transmission unit of the 360-degree video transmission apparatus may transmit the file.

In another embodiment of the 360-degree video transmission method, the coverage information may include information indicating a yaw value and a pitch value of a center point of a corresponding region on the 3D space. Also, the coverage information may include information indicating a width value and a height value of the corresponding region on the 3D space.

In still another embodiment of the 360-degree video transmission method, the coverage information may further include information indicating whether the corresponding region is a shape specified by 4 great circles on 4 spherical surfaces in the 3D space or a shape specified by 2 yaw circles and 2 pitch circles.

In further still another embodiment of the 360-degree video transmission method, the coverage information may further include information indicating whether the 360-degree video corresponding to the corresponding region is 2D video, a left image of 3D video, a right image of 3D video or includes both a left image and a right image of the 3D video.

In further still another embodiment of the 360-degree video transmission method, the coverage information may be generated in the form of DASH (Dynamic Adaptive Streaming over HTTP) descriptor and included in MPD (Media Presentation Description), whereby the coverage information may be transmitted through a separate path different from that of a file having the 360-degree video data.

In further still another embodiment of the 360-degree video transmission method, the 360-degree video transmission apparatus may further include a feedback processor (transmitting side). The feedback processor (transmitting side) may receive feedback information indicating a viewport of a current user from the reception side.

In further still another embodiment of the 360-degree video transmission method, the subpicture may be the subpicture corresponding to the viewport of the current user indicated by the received feedback information, and the coverage information may be the coverage information on the subpicture corresponding to the viewport indicated by the feedback information.

The aforementioned 360-degree video reception apparatus according to the present invention may perform the 360-degree video reception method. The 360-degree video reception method may have the embodiments corresponding to the aforementioned 360-degree video transmission method according to the present invention. The 360-degree video reception method and its embodiments may be performed by the aforementioned 360-degree video reception apparatus according to the present invention and its internal/external components.

In this specification, region (meaning in region-wise packing) may mean a region where the 360-degree video data projected in the 2D image are located within the packed frame through region-wise packing. The region may mean a region used in the region-wise packing in accordance with a context. As described above, the regions may be identified by equally splitting 2D image, or may be identified by being randomly split in accordance with a projection scheme, etc.

In this specification, region (general meaning) may be used as a dictionary definition unlike region in the region-wise packing. The region may mean ‘area’, ‘zone’ , ‘portion’ , etc. which are dictionary definitions. For example, when the region means one region of a face which will be described later, the expression such as ‘one region of a corresponding face’ may be used. In this case, the region means a region discriminated from the region in the aforementioned region-wise packing, and both regions may indicate different regions having no relation with each other.

In this specification, the picture may mean a full 2D image in which 360-degree video data are projected. In accordance with the embodiment, a projected frame or packed frame may be the picture.

In this specification, the subpicture may mean a portion of the aforementioned picture. For example, the picture may be split into several subpictures to perform tiling, etc. At this time, each subpicture may be a tile.

In this specification, the tile is a concept lower than the subpicture, and the subpicture may be used as a tile for tiling. That is, in tiling, the subpicture may be same concept as the tile.

In this specification, the spherical region or sphere region may mean one region on a spherical surface when the 360-degree video data are rendered on the 3D space (for example, spherical surface) in the reception side. The spherical region has no relation with the region in the region-wise packing. That is, the spherical region does not need to mean the same region as that defined in the region-wise packing. The spherical region is a terminology used to mean a portion on a spherical surface which is rendered, wherein the region may mean ‘area’ as a dictionary definition. In accordance with the context, the spherical region may simply be called ‘region’.

In this specification, face may be a terminology which refers to each surface in accordance with the projection scheme. For example, if a cube map projection is used, a front face, a back face, both lateral faces, an upper face, a lower face, etc. may be referred to as ‘face’.

The above-described parts, modules, or units may be processors or hardware parts that execute consecutive processes stored in a memory (or a storage unit). The steps described in the above-described embodiments can be performed by processors or hardware parts. The modules/blocks/units described in the above-described embodiments can operate as hardware/processors. In addition, the methods proposed by the present invention can be executed as code. Such code can be written on a processor-readable storage medium and thus can be read by a processor provided by an apparatus.

While the present invention has been described with reference to separate drawings for the convenience of description, new embodiments may be implemented by combining embodiments illustrated in the respective drawings. As needed by those skilled in the art, designing a computer-readable recording medium, in which a program for implementing the above-described embodiments is recorded, falls within the scope of the present invention.

The apparatus and method according to the present invention is not limitedly applied to the constructions and methods of the embodiments as previously described; rather, all or some of the embodiments may be selectively combined to achieve various modifications.

Meanwhile, the method according to the present specification may be implemented as code that can be written on a processor-readable recording medium and thus read by a processor provided in a network device. The processor-readable recording medium may be any type of recording device in which data are stored in a processor-readable manner The processor-readable recording medium may include, for example, read only memory (ROM), random access memory (RAM), compact disc read only memory (CD-ROM), magnetic tape, a floppy disk, and an optical data storage device, and may be implemented in the form of a carrier wave transmitted over the Internet. In addition, the processor-readable recording medium may be distributed over a plurality of computer systems connected to a network such that processor-readable code is written thereto and executed therefrom in a decentralized manner.

In addition, it will be apparent that, although the preferred embodiments have been shown and described above, the present specification is not limited to the above-described specific embodiments, and various modifications and variations can be made by those skilled in the art to which the present invention pertains without departing from the gist of the appended claims. Thus, it is intended that the modifications and variations should not be understood independently of the technical spirit or prospect of the present specification.

Those skilled in the art will appreciate that the present invention may be carried out in other specific ways than those set forth herein without departing from the spirit and essential characteristics of the present invention. Therefore, the scope of the invention should be determined by the appended claims and their legal equivalents, rather than by the above description, and all changes that fall within the meaning and equivalency range of the appended claims are intended to be embraced therein.

In addition, the present specification describes both a product invention and a method invention, and descriptions of the two inventions may be complementarily applied as needed.

### MODE FOR INVENTION

Various embodiments have been described in the best mode for carrying out the invention.

### INDUSTRIAL APPLICABILITY

The present invention is used in a series of VR-related fields.

Those skilled in the art will appreciate that the present invention may be carried out in other specific ways than those set forth herein without departing from the spirit and essential characteristics of the present invention. Therefore, the scope of the invention should be determined by the appended claims and their legal equivalents, rather than by the above description, and all changes that fall within the meaning and equivalency range of the appended claims are intended to be embraced therein.

1. A method for transmitting 360 video data, the method comprising:
processing 360 video data captured by at least one camera, the processing including:
stitching the 360 video data and
projecting the stitched 360 video data on a picture;
encoding the picture;
generating signaling information for the 360 video data, the signaling information including coverage information representing a region of the picture,
wherein the coverage information includes shape type information representing a shape type of the region, and information representing a number of regions;
encapsulating the encoded picture and the signaling information into a file; and
transmitting the file.

2. The method of claim 1,
wherein the coverage information includes yaw information and pitch information of a point that is a center of a 3D space, and
wherein the coverage information includes width information and height information for the region of the 3D space.

3. The method of claim 1, wherein:
when the shape type information has a first value, the region is represented by 4 great circles, and
when the shape type information has a second value, the region is represented by 2 azimuth circles and 2 elevation circles.

4. The method of claim 3,
wherein the coverage information includes information representing whether the 360 video data corresponding to the region is 2D video data, left data of the 3D video data right data of the 3D video data, or the 360 video data includes the left data of the 3D video data and the right data of the 3D video data.

5. The method of claim 1,
wherein the coverage information is generated by a descriptor of DASH (Dynamic Adaptive Streaming over HTTP), included in a MPD (Media Presentation Description), and transmitted via a path that is different from the file.

6. The method of claim 1, the method comprising
receiving feedback information representing a view_port of a current user from a receiver.

7. The method of claim 6, wherein a sub-picture for the picture is a sub-picture corresponding to the view port represented by the feedback information, and
wherein the coverage information is coverage information for a sub-picture corresponding to the view_port represented by the feedback information.

8. An apparatus for transmitting 360 video data, the apparatus comprising:
a video processor to process 360 video data captured by at least one camera, wherein the video processor is configured to stitch the 360 video data and project the stitched 360 video data on a picture;
a data encoder to encode the picture;
a metadata processor to generate signaling information for the 360 video data, the signaling information including coverage information representing a region of the picture,
wherein the coverage information includes shape type information representing a shape type of the region, and information representing a number of regions;
an encapsulator to encapsulate the encoded picture and the signaling information into a file; and
a transmitter to transmit the file.

9. The apparatus of claim 8,
wherein the coverage information includes yaw information and pitch information of a point that is a center of a 3D space, and
wherein the coverage information includes width information and height information for the region of the 3D space.

10. The apparatus of claim 8, wherein:
when the shape type information has a first value, the region is represented by 4 great circles, and
when the shape type information has a second value, the region is represented by 2 azimuth circles and 2 elevation circles.

11. The apparatus of claim 10,
wherein the coverage information includes information representing whether 360 video data corresponding to the region is 2D video data, left data of the 3D video data, right data of the 3D video data, or the 360 video data includes the left data of the 3D video data and the right data of the 3D video data.

12. The 360 degree video transmission apparatus of claim 8,
wherein the coverage information is generated by a descriptor of DASH (Dynamic Adaptive Streaming over HTTP), included in a MPD (Media Presentation Description), and transmitted via a path that is different from the file.

13. The apparatus of claim 8, further comprising
a feedback processor to receive feedback information representing a view_port of a current user from receiver.

14. The apparatus of claim 13,
wherein a sub-picture for the picture is a sub-picture corresponding to the view port represented by the feedback information, and
wherein the coverage information is coverage information for a sub-picture corresponding to the view_port represented by the feedback information.
